(19) United States
(12) Patent Application Publication
(10) Pub. No.: US 2010/0300163 A1
(43) Pub. Date: Dec. 2, 2010

(54) A Combination Lock Having Wheels with A Plurality Of Cams

(75) Inventors: John Loughlin, Lebanon, NJ (US); Robert Loughlin, Stanton, NJ (US)

Correspondence Address: DIEHL SERVILLA LLC, 33 WOOD AVE SOUTH, SECOND FLOOR, SUITE 210, ISELIN, NJ, 08830, US

(73) Assignee: Stanton Concepts Inc., Stanton, NJ (US)

(21) Appl. No.: 12/474,787

(22) Filed: May 29, 2009

(51) Int. Cl. E05B 37/02; E05B 15/16; E05B 17/22

(52) U.S. Cl. 70/301; 70/333 R; 70/446

(57) ABSTRACT

Disclosed is a combination lock having a wheel pack and a plurality of wheels in the wheel pack. At least one of the wheels has a plurality of cams on one side of the wheel which increases the difficulty in opening the lock without the proper combination. Each of the wheels can include a plurality of cams.

### BACKGROUND OF THE INVENTION

The present invention relates in general to rotatable shaft combination lock mechanisms suitable for use in, for example, doors, safes, or portable padlocks. Typically, such rotatable shaft combination lock mechanisms include a plurality of gated tumbler wheels, but may also include other mechanisms which are actuated by rotation.

Conventional locks utilizing lock mechanisms of the general class known as combination locks typically include three or more tumbler wheels which are loosely journaled in coaxial longitudinally spaced relation for rotation on a spindle or drive shaft within the lock housing, where the drive shaft is accessed through the wall of the housing. Most typically, an indexed and finger manipulable wheel mechanism, or dial, is positioned on the outer surface of the housing. The wheel mechanism may be utilized to provide the required rotations of the drive shaft and tumbler wheels to unlatch the lock.

The external dial typically provides the operator with means to manually manipulate the internal drive shaft and tumbler wheels in accordance with a known code, or combination. The proper manipulation of the dial results in the unlatching and unlocking of the lock. In the three-tumbler-wheel system commonly used in the art, the operator generally rotates the external dial in a clockwise direction through angular positions to a first desired point, commonly referenced by a numeral, then rotates the external dial in a counterclockwise direction to a second desired point, commonly referenced by a numeral, and finally rotates the external dial again in a clockwise direction to a third desired point, again commonly referenced by a numeral. Following this typical procedure, the lock mechanism is unlatched and the lock may be opened.

Existing combination lock mechanisms are designed to be human friendly by including the discussed externally readable and finger manipulable dial. Notwithstanding the external indexing, the tolerances required for unlatching conventional locks are left quite loose, to further ease use by average persons. In a typical combination lock operable by a finger manipulable dial, the locking mechanism clearances are such that a slight over or under rotation of the dial will not be fatal to operation of the lock. Rather, clearances are designed to account for slight errors in precision.

For example, if a conventional combination lock has the combination 10-22-17, the lock is typically designed to be opened when a user rotates the dial clockwise three turns to the indexed numeral 10, counterclockwise two turns to the indexed numeral 22, and again clockwise one turn to the indexed numeral 17. However, it is conventional that tolerances are built in the lock mechanism such that rotations may be permitted to be off several digits, and the lock will still open. As an example, using the combination lock with the combination of 10-22-17, rotational input of 10-21-17 will likely open the lock. In fact, each of the rotations may be ceased or stopped at a digit which is “off” by more than only one digit, for example an input of 8-20-19 will likely still open the lock, even though each of the stopping points is “off” by two indexed positions.

There are several reasons for this built in sloppiness. These reasons most often have to do with human limitations regarding to dexterity, memory, and patience, which are all interrelated in some ways.

Regarding dexterity, even the most dexterous of humans are only capable of a certain level of positioning accuracy. In a typical peripherally gated combination lock, the lock manufacturers place a single gate at a location on the periphery of each wheel. This gate is sized to accept a side bar when the correct combination is entered. However, to account for the relative lack of dexterity exhibited by human manipulation, the gate is often much larger than the width of the side bar. If the gates were sized to include only a slight tolerance with the side bar, the rotational accuracy for opening a lock would be too tight for typical human manipulation. Of course, some humans may still be able to manipulate the lock for at least one indexed number accurately, but it would likely take a tremendous amount of time, effort, and concentration. That time, effort, and concentration weighs against the patience of the person. Thus, locks have heretofore been manufactured with gates which allow for a large tolerance with the side bar.

Also, the person's memory may fade over the time required to enter the rotational inputs required to unlatch the lock. For example, again using the combination above, if a person had to enter exactly 10-22-17, and no inaccuracies were tolerated, the person would have to spin the dial clockwise three times and stop precisely on the 10 position. The person would then have to rotate the dial counterclockwise two times and stop precisely on the 22 position. The concentration required to stop precisely on the second position may cause the person to forget the third digit of the combination, or forget the number or direction of rotations required for the final number of the combination. Other memory based complications may also interfere, such as external distinctions. Lock manufacturers thus build in a level of sloppiness that permits quick manipulation of the combination lock, for example by permitting the lock to unlatch even if a user is “off” by several digits.

Regarding memory, most conventional combination locks include three wheels, requiring the user to memorize a three-number combination. An example is the 10-22-17 combination discussed. If, however, the number of tumbler wheels were increased, the number of digits in the combination would be increased proportionally. Although this would permit more secure locks, the limits of human memory have contributed in discouraging the use of large numbers of disks.

Presently, among the most complicated of conventional locks are those used on bank vaults. Such locks may include four tumbler wheels, requiring a user to remember a four-number combination. Manipulation of such a lock taxes the abilities of users. The additional tumbler wheel not only requires the user to remember an additional number, but also increases the number of rotations required to open the lock. In the four-disk example, a user would have to first rotate the external dial four times in a clockwise direction, three times in a counter clockwise direction, two times in a clockwise direction, and finally one time in a counterclockwise direction, for a total of ten rotations. This is a lot of turns for a person to count while still remembering the combination and blocking outside interferences. Only in the most secure locations, bank vaults, is this tolerated. Most conventional locks are of the three-disk variety.

It is estimated that present commercial locks of the three-disk variety comprise 85% of the market while four-disk locks make up the remaining 15%. The greatest number of disks known to have been attempted in a commercial product is five, by Joseph L. Hall of Cincinnati, Ohio, in the mid-1800s. It is believed that this lock was only used for a short period of time due to the problems associated with manipulating five disks. No locks are presently known to embody five or more disks. Heretofore, the beneficial increase in security offered by a lock with greater than four disks has been severely outweighed by the difficulties associated with manipulating such a lock.

In addition to the added security provided by heretofore unheard of disk numbers, combination locks of the present invention also feature numerous other improvements, as will be discussed. One such improvement is the provision of much tighter tolerances within each tumbler wheel. Whereas conventional locks allow for a loose fit between the peripheral gate and the side bar, locks constructed in accordance with the present invention permit much tighter tolerances. Other of these improvements include the provision of a propriety (or non-propriety) female interface within the body of the cylinder lock which may only be engaged by a tool and is not finger manipulable. Accordingly, there may be no external dial. There may also be no visible demarcations on the lock housing associated with the combination.

The tool operated lock of the present invention therefore solves the inherent problems associated with limited human dexterity, memory, and patience by providing for a combination lock mechanism which may be manipulated and opened by a tool, or by a human in conjunction with particular tools. The functional arrangement of, and interrelationship between, the lock and the tool provides for security features, flexibility, and control not previously available from conventional locks. The tool operated combination lock of the present invention generally operates under the principles known in the combination lock art, with the additions of tighter clearances, greater numbers of disks (or tumbler wheels), and other improvements that could not have been realized in a practical sense until the novel mating of the combination lock with the speed and precision of the motorized tool. Tools for use with such locks are also disclosed herein.

Underwriters Laboratories, UL, categorizes safe and vault locks into two groups based on the level of security the locks provide. Essentially UL Group 2 are required to withstand two hours of expert manipulation, UL Group 1 locks are required to withstand 20 hours of expert manipulation. Group 1 locks are considerably more expensive and are generally used to secure highly valuable items or classified information.

A typical group 1 and 2 lock may have: a 3″ diameter dial with 100 graduations. A large dial is required for the graduations to be legible and resolvable for the human eye; a wheel 1.7″ diameter; a gate 0.25″ wide; a fence 0.125″ wide.

A very large increase of permutations of opening combinations may greatly improve the security of a lock but may have diminishing benefits for locks that are intended to be manipulated by hand. A human operator may not have the ability to stop at an exact position or process the opening sequence or remember the large amount of possible numbers. So, combination locks having substantially more than 50 discrete positions may be more secure, but may practically not be opened manually by a human operator.

Accordingly, novel and improved combination locks and locking systems that provide increased security and that can be opened with an automated key are required.

### SUMMARY OF THE INVENTION

In accordance with one aspect of the invention, a combination lock may comprise a housing, a wheel pack inside the housing that has a plurality of wheels and a plurality of cams on one side of at least one of the plurality of wheels.

The plurality of cams can be provided on each of the plurality of wheels.

Further, the plurality of cams can be screwed into threaded holes on each of the plurality of wheels.

In accordance with various aspects of the present invention, greater variability is introduced into the procedure for opening the combination lock.

### BRIEF DESCRIPTION OF THE FIGURES

The subject matter regarded as the invention is particularly pointed out and distinctly claimed in the concluding portion of the specification. The invention, however, both as to organization and method of operation, together with features, objects, and advantages thereof will be or become apparent to one with skill in the art upon reference to the following detailed description when read with the accompanying drawings. It is intended that any additional organizations, methods of operation, features, objects or advantages ascertained by one skilled in the art be included within this description, be within the scope of the present invention, and be protected by the accompanying claims.

In regard to the drawings, FIG. 1 is an exploded perspective view of a combination lock in accordance with one embodiment of the present invention;

FIG. 2 is a blown-up view of a portion of the combination lock of FIG. 1 generally depicting a drive cylinder;

FIG. 3 is a blown-up view of a portion of the combination lock of FIG. 1 generally depicting a drive assembly;

FIG. 4 is a blown-up view of a portion of the combination lock of FIG. 1 generally depicting a casing;

FIG. 5 is a blown-up view of a portion of the combination lock of FIG. 1 generally depicting a plurality of disks;

FIG. 6 is a partially assembled perspective view of the combination lock of FIG. 1;

FIG. 7 is a blown-up view of a portion of the combination lock of FIG. 1 generally depicting a drive assembly with optional components;

FIG. 8 is a perspective view of a tool in accordance with one embodiment of the present invention in a first relation with a combination lock of the type shown in FIG. 1;

FIG. 9 is a perspective view of the tool and combination lock of FIG. 8 in a second relation;

FIG. 10 is a functional diagram of a tool in accordance with one embodiment of the present invention;

FIG. 11 is a perspective view of a multi-part tool in accordance with another embodiment of the present invention;

FIG. 12 is a perspective view of a tool in accordance with a further embodiment of the present invention;

FIG. 13 is an overview of the typical operation of a tool in accordance with certain aspects of the present invention;

FIG. 14a is a logic diagram of a tool in accordance with certain aspects of the present invention;

FIG. 14b is a logic diagram of a tool in accordance with further aspects of the present invention;

FIG. 15 is an diagrammatic flow chart depicting an example of a subroutine for aligning the disks of a combination lock having six disks, the subroutine being utilized in FIGS. 16 through 22.

FIG. 16 is a logic diagram depicting the operation of a dumb tool in accordance with one aspect of the present invention;

FIG. 17 is a logic diagram depicting the operation of a dumb tool in accordance with another aspect of the present invention;

FIG. 18 is a logic diagram depicting the operation of a not-so-dumb tool in accordance with a further aspect of the present invention

FIG. 19 is a logic diagram depicting the operation of a not-so-dumb tool in accordance with an additional aspect of the present invention;

FIG. 20 is a logic diagram of a smart tool in accordance with certain aspects of the present invention;

FIG. 21 is a logic diagram of a smart tool in accordance with further aspects of the present invention;

FIG. 22 is a logic diagram of a smart tool in accordance with additional aspects of the present invention;

FIGS. 23a through 23g depict steps in a method in accordance with one aspect of the present invention for determining the combination of an assembled lock core;

FIG. 24 depicts a front view of a combination wheel and a cross section of a fence;

FIG. 25 depicts a front view of a conventional combination wheel with the dimensions of the wheel diameter, gate width and fence width dimensioned;

FIG. 26 depicts the dimension of the angular clearance between the gate and the fence in degrees of FIG. 25;

FIG. 27 depicts an isometric view of one possible configuration of a RKS wheel assembly;

FIG. 28 depicts sides A and B of a RKS wheel with 2 cams installed on side A and one cam installed on side B;

FIG. 29A depicts an isometric view of a RKS wheel pack with the gates in alignment;

FIG. 29B depicts the wheel pack in FIG. 29A with the addition of a second cam on the drive wheel assembly;

FIG. 30 shows an in isometric view of a manual dialer;

FIG. 31 depicts an exploded view of an RKS cylinder;

FIG. 31B depicts an isometric view of a side-bar;

FIG. 32 depicts an array showing possible cam locations for a wheel with 8 tapped holes;

FIG. 33 is a graphical representation of possible cam locations for a wheel with 8 tapped holes;

FIG. 34 depicts a wheel with bendable tabs for the cam elements;

FIG. 35 depicts a wheel assembly with a circular slot to accept the cams;

FIG. 36 depicts cylinder shell with ratchet feature;

FIG. 37 depicts a side-bar with ratchet feature;

FIG. 38A depicts an inclined bottom view of a side-bar with non-linear fence segments;

FIG. 38B depicts a an isometric partially exploded view of a cylinder assembly with a side-bar with non-linear fence segments and a shell;

FIG. 39A depicts an inclined top view of a variable side-bar with tapped holes for fence segments;

FIG. 39B depicts an inclined bottom view of a variable side-bar with fence segments installed;

FIG. 40 depicts a sectioned front isometric view of a cylinder assembly with two side-bars having segmented fence sections;

FIG. 41 is a functional block diagram of a self contained Robotic Dialer;

FIG. 42A depicts an inclined front view of a Robotic Dialer with a cover removed;

FIG. 42B depicts an inclined back view of a Robotic Dialer with a cover removed;

FIG. 43 depicts an inclined view of a Robotic Dialer with a cover on and a RKS cylinder;

FIG. 44 is a functional block diagram of a Robotic Dialer with a separable hand held computer device;

FIG. 45 depicts a Robotic Dialer with a cradle to accept a hand held computer device;

FIG. 46 depicts a hand held computer device;

FIG. 47 depicts a Robotic Dialer with a hand held computer docked;

FIG. 48 is a diagram of a Robotic Dialer controlled by a mobile computing device;

FIG. 49 is a graph of cost versus security that illustrates the economic benefit of the RKS;

FIG. 50 is a diagram of a security system in accordance with an aspect of the present invention;

FIGS. 51-53 are flow diagrams in accordance with one or more aspects of the present invention; and

FIGS. 54-55 are diagrams of a mobile computing device in accordance with one or more aspects of the present invention.

### DETAILED DESCRIPTION

In describing the preferred embodiments of the subject matter illustrated and to be described with respect to the drawings, specific terminology will be resorted to for the sake of clarity. However, the invention is not intended to be limited to the specific terms so selected and it is to be understood that each specific term includes all technical equivalents which operate in a similar manner to accomplish a similar purpose

Aspects of the present invention provide means to manipulate the internal tumbler wheels or disks of a combination lock in accordance with the appropriate combination, which may be known or unknown to the operator, by means of a motor driven tool. In this regard, aspects of the present invention include the provision of novel manipulation means of the internal disks, preferably by means of a motor driven tool. The combination necessary to drive the tool in the directions and positions appropriate for the disks of a given lock may be provided by means of a signal; electronic, electromagnetic, optical, or otherwise, from a preferably secure identification source. The signal may be obtained from a radio frequency reference device (RFID), a “mote” (a new class of interactive microelectronic devices also commonly referred to as smart dust or wireless sensing networks), a contact memory button (CMB) (a non-powered read/write memory device capable of transferring data by contact), an optical bar code, a magnetic strip, or similar medium. In other embodiments, the lock may be provided with an alphanumeric designator corresponding to the lock's opening sequence. The tool may be provided with an optional character recognition system which may then read the alphanumeric characters to associate the tool with the lock. This source may provide the necessary combination, unique identification, and/or history of activity for the lock, in addition to other information. Additionally, the signal itself may be encrypted.

One feature of locks of the type disclosed herein is that the locks may not possess any specific opening information, such as the combination, for that lock or that class of locks. Rather, such information may be provided elsewhere, for example in a lookup table associated with the tool used to open the lock or a remote authority in communication with the tool. As such, even if the lock is disassembled and analyzed, it would only potentially reveal the disk configuration for that particular lock, and not others of the same type. In addition, such acts would be destructive and would leave evidence of tampering

The tool may function as instructed by the revealed combination or by means of a unique identification linked to a higher authority, which provides the combination for the particular lock. The communication link, or the tool, may provide the necessary combination, authorizations, audit trail, and systems management as determined by the requirements of the application

While incorporating the above features, the tools utilized as part of this invention may be of several levels of sophistication. In an initial level, a “dumb” tool may provide simple, specific and perhaps proprietary, mechanical actions to release latches or cause the lock to function. In general, a “dumb” tool requires the thought process of a person to operate the tool to unlatch a lock.

Typically, a “dumb” tool requires the operator to enter the lock's combination, manually into a computerized motor device within the tool to cause the tool to drive the lock through the appropriate combination or the “dumb” tool may be driven completely manually. In regard to automatic operation, the operator may enter the required combination, such as the 10-22-17 example discussed above into a keypad associated with the tool. The tool may then manipulate the cylinder lock through the 10-22-17 sequence to open the lock. Preferably, there are no external markings on the lock housing to identify the numerical rotation stopping points. Rather, the tool itself incorporates means for calibration.

In the manual mode of operation, a user may associate an external drive wheel with a mating element of the lock. The external drive wheel may include gear reduction technology to ensure that large and imprecise movements by the operator are reduced to very fine and accurate inputs into the lock. Such devices are known in the industry. In the automatic operation mode, the tool may incorporate security features, such as having a different actual turning process than the process entered by a user. For example, a user may enter a certain combination into the tool, such as the 10-17-22 combination, but the tool may use that combination in accordance with a look-up table to determine the actual combination that will open the particular lock, which is preferably a combination completely different from the initial combination entered by the user. In a preferred embodiment, a user enters a lock identification number rather than a combination into the tool. The tool then looks up the lock's combination in accordance with a programmed look-up chart, internal to the tool and completely unknown to the user.

A “dumb” tool may also include proprietary interfaces with the lock, such as male/female mechanical interfaces. Typically, the interface will be hidden within the body of the lock cylinder and will be incorporated into the proximal end of the drive shaft. Such features include drive shaft ends with non-geometric constructions, or unique or rare geometries such as stars, torx, or the like. Preferably, the interface is proprietary.

“Dumb” tools may also incorporate additional security features such as electromagnetic pulse (EMP) protection, due to its pure mechanical make-up, or the use of exotic and high strength materials designed to withstand foreseeable attacks.

In addition, the tool may incorporate a time clock allowing for only time-certain use. For example, a particular tool may only be operable at certain times. Such a tool may be programmed to operate only during a person's shift, for example between the hours of 8:00 a.m. and 5:00 p.m. Alternatively, a tool may operate for a particular time period following entry of an access code or other authorization provision. This time period may be programmed to any length, such as 15 minutes or one day. The time clock may not be a conventional clock with hours and minutes displayed, but may be a simple countdown timer activated by the entry of an access code or other authorization. Any such time-certain operation may be identified as a temporal consideration.

In a second level of sophistication, a “not-so-dumb” tool may be provided. In addition to meeting the description of a “dumb” tool above, the “not-so-dumb” tool may incorporate means to identify the particular lock intended to be opened, without any input from the operator. In essence, therefore, the operator merely mates the tool with the lock and the tool determines the correct combination to open the lock based on identifying characteristics read or otherwise obtained from the lock itself. The means of identifying the lock may be a signal from the lock, such as electronic, electromagnetic, optical, or otherwise. As previously discussed, the signal may be obtained from an RFID, mote, CMB, optical bar code, magnetic strip or similar medium.

A “not-so-dumb” tool may also include added security features such as radio frequency (RF) tagging, optics, global positioning systems (GPS), cellular triangulation, or similar tracking means. For example, if the tool were moved outside of a designated area, the tool may be automatically disabled and/or flagged for later identification of the activity by system management.

Moreover, the tool may have a database incorporated within the tool to determine the combination of a lock based on the precise geographic position of the tool, the position obtained by GPS, RF tagging, cellular triangulation, or other means. For example, a particular user may have five locks located at different locations. The tool may have features built in, such as through GPS, cellular triangulation, RFID, or the like, by which the tool “knows” its precise geographic location. If the tool is activated at any one of the five locations, a look-up table within the tool may identify the correct combination for that particular lock, and may thus proceed to open the lock based on such data.

A “not-so-dumb tool” may also include a “lock out” mechanism to protect against unauthorized use. This “lock out” mechanism may be a simple mechanical key cylinder or an electro mechanical device that enables the tool to operate only after the satisfaction of requirements such as entry of specific personal identification numbers (pin), passwords, passcards, biometrics, human embedded identification devices, voice sampling, or other criteria. In this regard, the operator may be required to provide such validation means for the tool to operate. The tool may then operate indefinitely, or for a predetermined period of time. Other means of validation or authorization may be provided, such as proximity means. In this regard, a container may include a specific identifying feature with the container itself, such as an RF tag. The tool may be able to read this tag and identify the container. A lock external to the container may then have an opening sequence known by the tool in accordance with a look-up chart, preferably one capable of being modified depending on which particular lock is placed on which container. The tool may then open the lock. In essence, this embodiment of the invention is similar to one in which the tool identifies the lock, but replaces that identification for an identification of the container itself, not the lock. In this regard, one container may be provided from time to time with different locks, thus bolstering the security of the container.

In other aspects of the invention, the tool may not indicate that the required authorizations have been provided, and may be captured by the lock upon attempted use without user validation or may include features to make the tool inseparable from the lock.

In yet a higher level of sophistication, a “smart tool” may build on the description of the “not-so-dumb tool” by at least including provisions to communicate with a remote station to provide some or all of the functions identified with a “not-so-dumb tool.” In this regard, the central station may then monitor use of the tool and/or locks in real time, and may provide immediate security functions not available in the “not-so-dumb” tool, such as immediate shutdown of all tool functioning upon a breach of security. In the “smart tool,” the audit trail may be captured at the remote station, rather than, or in addition to, a memory module within the tool itself.

Because of the unique capabilities permitted by use of a remote station, the “smart tool” may include features which go beyond those comprehended by the “not-so-dumb tool.” One such feature is video authorization. Video authorization may produce an image of the individual attempting to use the tool, the video image being produced at a remote station. A supervisor at the station may authorize the tool's use upon confirmation of the individuals security clearance based at least partially on the video observation. This video observation may also be utilized to ensure that the operator is not acting under threat or duress. Of course, audio or other means of validation may be layered with the video. Once validated, the tool may receive an authorization signal to allow its use to unlock the passive lock.

Whether “dumb,” “not-so-dumb,” or “smart,” the tool may interface to the lock drive shaft with a mating drive. The drive interface may be a standard element like hex, torx, or Phillips drives, or alternatively may comprise a unique pattern like McGard®, a traditional key blank (keyed in a particular manner), or other types of proprietary interfaces (McGard is a registered trademark of McGard Inc., 848 Kensington Avenue, Buffalo, N.Y. 14215). The tool is preferably able to quickly rotate the drive shaft in small angular increments or steps precisely and repeatably in both clockwise and counterclockwise directions. These features provide greatly enhanced performance from the traditional multiple tumbler wheel combination mechanisms requiring manual manipulation of external drive elements. These features also include significant improvement in the potential security provided. For example, because the tool's motor function is computer driven, and may incorporate more precise movement than capable by a human in a manual lock, the lock itself may include tighter clearances between the “side bar” or fence and the mechanisms on the tumbler wheels with which they operate, including gates, bumps, notches, holes, etc., as known in the art. Thus, the security against attempted opening via guessed codes (combinations) by humans is increased as is that against surreptitious attack. Because there is no need to facilitate direct human operation, it is envisioned that a lock mechanism cylinder of the present invention may be reduced to well below ¾″ diameter or smaller, using presently available materials and known technologies. Locks may also be larger than ¾″ diameter if so desired.

Each lock may include a unique identification number that can be read either manually and entered manually into the tool, as in a “dumb” tool, or read automatically by the tool via RF tagging, magnetic interfaces, optical scanning, motes, CMBs or the like, as in a “not-so-dumb” or “smart” tool. In the case of identification by the tool, such as bar codes or optical interfaces, the identification may be internal to the lock to prevent reading of the bar code data or optical interface by the tool operator. The tool may then communicate the information to the operator for his subsequent operation of the tool's motor driven lock opening mechanism. In a “not-so-dumb,” the tool may include an “in-tool” database that communicates with the identification, recognizes the unique identification, and provides the tool's drive mechanism with the required combination sequence to open the lock. In a “smart” tool, the database may be external to the tool, in a location with which the tool may communicate, such as a central operating station

The “smart tool” may have provisions such that the tool may be enabled only after the operator has been identified and qualified by the security system. This identification and qualification procedure may be conducted through a pin number, a password, a passkey, biometrics, human embedded identification devices or other devices. Videos images may also be utilized. Once enabled, the “smart tool” may obtain the unique identification number of the lock and request the code sequence (combination) required to open the lock from the remote database. The link from the tool to the remote database may use existing wired or wireless technology such as cellular, radio, satellite, wired landlines, or other means (the wired lines preferably including provisions within the tool for connection with standard telephone lines, cable lines, local area network lines, or the like for remote communication). At the remote database a complete audit trail could be maintained including location by GPS, cellular triangulation, RF tagging, manual input based on video capture, or the like. Discovery of theft or fraudulent use could result in a disabling lockout of the tool, capture of the tool, or another response as appropriate. All communications between the tool and the remote database may be encrypted for security purposes.

In other aspects of the invention, the lock itself may be hard-wired to a communication system for communicating with the remote station. For example, a lock contained in a door of a typical office may include provisions for communicating operation times to a remote database via telephone line hard-wired directly into the lock. Operation events of the lock may then be monitored.

Combination lock mechanisms of the present invention may also incorporate an internal blocking element such as a miniature solenoid that is activated by the tool. In preferred embodiments, the combination lock mechanism is preferably in a blocked state at default, such that at least one of the internal disks cannot rotate. The tool may therefore include a communication capability such that the tool and the lock, also provided with a communication capability, may go through an electronic “hand shake”. Once the lock recognizes the tool as being proper, the solenoid may be energized and moved to allow full rotation of the lock. Power for this energizing may come from a battery within the lock, a hard-wired electrical circuit within the lock, or from the tool itself.

This technology, where a lock may go through a “hand shake” routine with a tool, is similar to technology incorporated into existing locks, such as those incorporated in Mul-T-Lock®.'s Interactive®. CLIQ® lock, Abloy's® SmartDisc lock, Medeco's® NEXGEN® locks, and Videx's® CiberLock lock. Mul-T-Lock® and Interactive® are registered trademarks of Mul-T-Lock Limited Corp. Israel, Mul-T-Lock Park, Haazmant Boulevard, Yavine, Israel. CLIQ® is a registered trademark of ASSA ABLOY AB Corporation Sweden, P. O. Box 70340 S-10723, Stockholm, Sweden. ABLOY® is a registered trademark of ABLOY SECURITY LTD OY Corporation, Finland, Rajasampaaranta 2, SF-00560, Helsinki, Finland. Medeco® and NEXGEN® are registered trademarks of Medeco Security Locks, Inc. Corporation Virginia, P. O. Box 3075, Salem, Va. 24153. Videx® is a registered trademark of Videx, Inc. Corporation Oreg., 1105 N.E. Circle Blvd., Corvallis, Oreg. 97330-4285.

These products generally incorporate a processor and a blocking element in the lock cylinder that can be unlocked only after a successful digital handshake with a tool or key.

It will therefore be appreciated that in accordance with certain aspects of the invention, well-known, reliable, cost effective multiple disk combination locking mechanism may be utilized to provide a secure lock for various applications. This basic mechanism has been in common use for more than one hundred years, relying on manual manipulation of an external dial interface. This known concept requires the operator to know the appropriate sequence of manipulations or combination to cause the lock to open. However, the general concept has several major flaws that reveal themselves as the level of desired security increases.

One such flaw is a security flaw, which is the dependence on the maintenance of the secrecy of the combination. It will be appreciated that in a conventional lock, once an individual is aware of the combination, that individual may compromise the security of the lock, either intentionally or unintentionally, by permitting others to become aware of the combination. Another flaw is any one operational flaw, namely, the requirement that the operator know the secret combination. Obviously, if the operator does not know the combination, the operator may not be able to unlock the lock. Other important flaws involve the requirements for reasonable environmental operating conditions, such as sufficient lighting and time to perform the required functions. The operator's dexterity and mental capacity may also come into play, as conventional locks may be difficult to open for those with impaired physical abilities or limited mental capacity.

In the preferred embodiment of the present invention, the combination mechanism is simple, the interface with the tool is simple, the encrypted identity of the lock is readily available to the tool, and the tool provides the appropriate manipulation instructions to the motor driven interface which causes the disks to be arranged in the unlocked position to open the lock. The operator may not, and preferably should not, know the lock combination. In this preferred embodiment, the only function of the operator is to provide the means to authorize the tool's functioning (if incorporated) and to align and hold the tool in proper relationship with the lock for the functioning to occur.

Embodiments of locks suited for the present invention may include locks applied to doors of all sorts, security cabinets and containers, trucking/railway containers, safes or vaults, and similar fixed structures. The same teachings may also be applied to portable locking devices (padlocks) of various configurations such as U-shackle style, straight shackle style, hidden shackle style, or any other portable locking devices. These various embodiments may be used wherever the popular key function or externally manipulated combination mechanisms have been the lock of choice, such as in perimeter securement, vending machines, trucking/railway/intermodal containers, luggage, lockers, etc. In addition, the inventive locks have inherent advantages that facilitate use in hostile environments, or in situations of infrequent use. For example, the lock mechanism itself is preferably not exposed to the elements as are externally exposed keyed cylinders. In addition, o-rings or other protective barriers may be employed to limit debris from entering the lock mechanism.

In accordance with other aspects of the invention, “dumb locks” may include purely passive locks with no means of communication with a tool or no means for independent power. Such “dumb locks” may, conversely, include means to communicate with the operator of a tool, such as a branded serial number or other identification number. These “dumb locks” may therefore be used with “dumb tools.” A “smart lock” may include provisions to communicate with a tool, such that the tool may identify the lock, for example in the case of a “smart tool” or “no so smart tool.” The “smart lock” may also include means to store data within the lock, such as with CMBs. The CMBs may store data communicated from the tool, such as the identity of the operator operating the tool or the geographic location of the lock at the time of opening. The CMBs may also store data directly obtained from the lock itself, such as the time the lock was opened and closed or the identification of the tool with which it was opened.

In practice, the tool operated combination lock generally operates under the principles known in the combination lock art, with the additions of tighter clearances, greater numbers of disks, and other improvements that could not have been realized in a practical sense until the novel mating of the combination lock with the speed and precision of the motorized tool disclosed herein.

It is contemplated that the tool operated combination lock of the present invention may be compatible with existing and commonly used lock hardware, including changeable, removable core, and keyed cylinders, such as the locks produced by Medeco Security Locks, Inc, 3625 Alleghany Drive, Salem, Va. Such existing hardware is widely used in access control, transit, utility, vending, pay telephone, parking, alarm, safe and perimeter control applications. In order to be adaptable for use most effectively with existing hardware, the preferred tool operated combination lock is packaged within a standard diameter cylinder package, such that existing ¾″ diameter cylinder locks may be replaced with the tool operated combination lock unit. Of course, it will be appreciated that the tool operated combination lock unit may be smaller or larger depending on the desired application. Whether larger or smaller, the tool operated combination lock is preferably a simple, low part count, low cost, robust, environmentally hardened, and highly pick resistant mechanism.

As shown in FIG. 1, in accordance with one aspect of the present invention, a combination lock 100 may comprise a casing 102 adapted to house a series of disks, such as six disks as in the embodiment shown in FIG. 1. These disks include a drive disk 104 and five standard disks 106a, 106b, 106c, 106d, and 106e. The combination lock 100 may also comprise other primary components including a drive cylinder 108, latch 110, drive shaft 112, side bar 114, and end cap 116. As with conventional locks of the combination disk type, the components are arranged such that rotation of the drive shaft 112 in alternating clockwise and counterclockwise directions, in accordance with a specific pattern or combination, permits the side bar 114 to drop into aligned gates 118 formed in each of the disks 104, 106a, 106b, 106c, 106d, 106e, and out of a notch 120 provided in the casing, such that the latch 110 may rotate to unlock the combination lock 100. In this simplistic regard, the combination lock 100 operates much like conventional combination locks. Other components are also utilized in the combination lock 100, and will be discussed in turn.

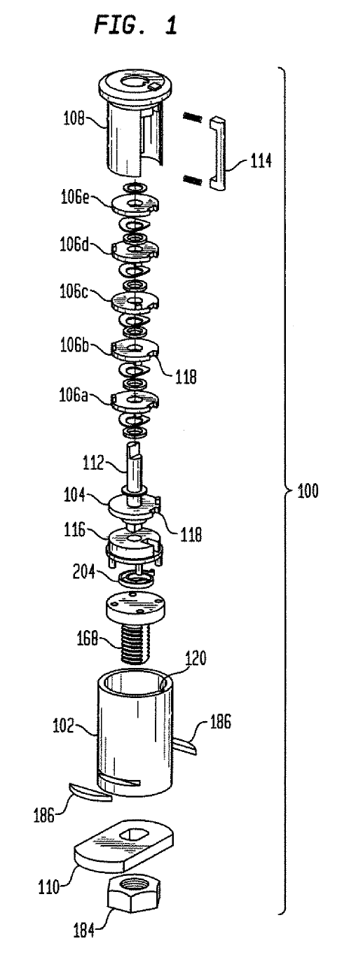

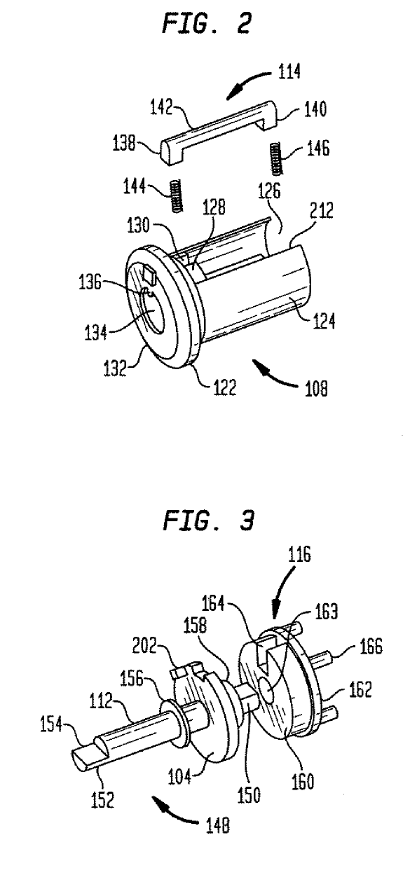

As shown in FIG. 2, a blown-up view of portions of FIG. 1, the drive cylinder 108 comprises a flange 122 and an extension area 124, the flange generally being formed to a greater diameter than the extension area. The extension area 124 is formed to fit within the inside diameter of the casing 102 when the combination lock 100 is assembled, and is typically ¾-round construction with an open top area 126.

Located at the intersection of the flange 122 and the extension area 124 in an internal portion of the drive cylinder, is a front cap 128. The front cap 128 comprises a front cap gate 130 in which portions of the side bar 114 may fit when the combination lock 100 is assembled

On the opposite side of the flange 122 from the front cap 128, an external side, is a front face 132. It will be appreciated that the front face 132 is the portion of the combination lock 100 which is visible to the user upon installation of the cylinder lock in the final device, such as the door or padlock. The front face 132 includes an aperture 134 through which the drive shaft 112 may be accessed when the combination lock 100 is assembled, as will be discussed.

The aperture 134 is preferably circular, but may also include geometric or non-geometric features that limit entry into the aperture to tools which are shaped properly or incorporate features corresponding to the apertures' features. For example, in FIG. 1, the aperture 134 is shown as a circular aperture with a tab 136 extending into the face thereof. Accordingly, a tool with a corresponding notch will be capable of entering the aperture. In other embodiments, the tool and lock may include a separate lock and tab serving to orient and register relative positions of the lock mechanism.

The lock may further comprise a communication mechanism 135, such as those discussed herein, to communicate with a tool.

As further shown in FIG. 2, the side bar 114 may comprise legs 138, 140 extending from ends of a relatively lengthy main portion 142. The side bar 114, particularly the legs 138, 140, may be associated with springs 144, 146, as will be discussed.

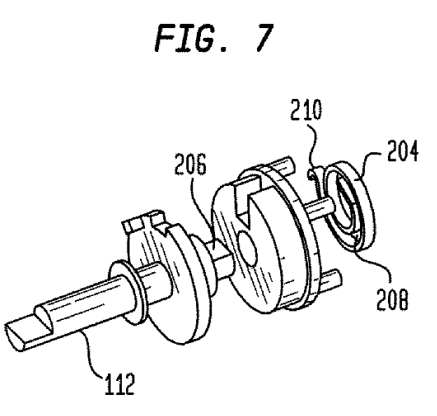

FIG. 3 depicts another blown-up view of portions of FIG. 1, this time corresponding to the drive assembly 148 and end cap 116 without the optional scrambler spring 204, which will be discussed in relation to FIG. 7. The drive assembly 148 is comprised of the drive disk 104 and drive shaft 112, which may be formed as a single component, and may be cast as such or assembled from separate parts. The drive disk 104 is typically mounted on the drive shaft 112 toward a distal portion 150 of the drive shaft. This arrangement leaves room on the proximal portion 152 of the drive shaft 112 for disks 106, the number of disks varying depending on the desired security level of the combination lock 100.

The extreme proximal portion 152 of the drive shaft 112 includes an alignment notch 154. The proximal portion 152 of the drive shaft 112 with the alignment notch 154 is accessible through the aperture 134 of the drive cylinder 108 when the combination lock 100 is assembled. The alignment notch 154 therefore serves at least two purposes; namely, the alignment notch provides an engaging surface with which a tool may engage to open the combination lock 100 and also provides the tool with registration information so the tool may go through the required series of rotations with a calibrated reference point relative to tab 136.

A pair of drive assembly spacers in the form of a proximal drive assembly spacer 156 and a distal drive assembly spacer 158 are mounted on the drive shaft 112 on opposite sides of the drive disk 104. The drive assembly spacers 156, 158 are offset a certain distance from the drive disk 104 to ensure that the drive disk remains that same certain distance from the endcap 116 on its distal side and the first disk 106a on its proximate side, when the combination lock 100 is assembled. The spacers 156, 158 also provide mechanical isolation between discs to prevent inadvertent rotation of discs.

In its assembled form, the drive assembly 148 is secured within the extension area 124 of the drive cylinder 108. In this regard, it will be appreciated that portions of the drive disk 104 will be concealed by the ¾ round extension area 124 while other portions are left exposed by the open top area 126. The drive assembly 148 is followed within the extension area 124 of the drive cylinder 108 by the end cap 116 when the cylinder lock is assembled. End cap 1116 may be fixed to extension area 124 by adhesives, solder, brazing, welding, mechanical fasteners, or the like.

The end cap 116 includes a cylindrical portion 160 ending in a flange 162 at its distal end. The cylindrical portion 160 includes an aperture 163 within which the drive shaft 112, and particularly the overtorque control portion 150 between the distal end of the drive shaft and distal drive assembly spacer 158, may be placed when the combination lock 100 is assembled. The cylindrical portion 160 also includes a side bar gate 164 within which a leg 140 of the side bar 114 may lay, as will be discussed.

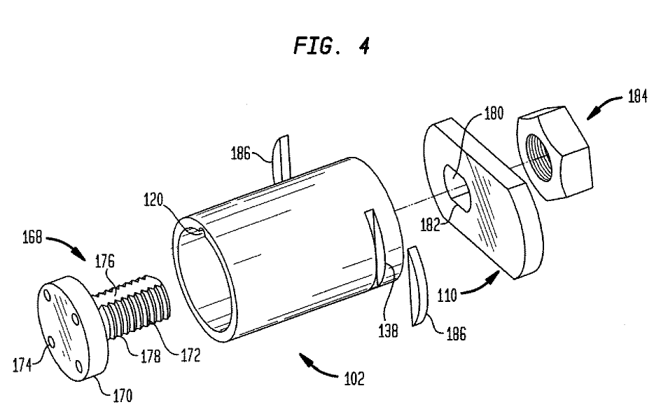

Extending distally from the flange portion 162 of the end cap 116 is at least one connecting post 166. Preferably, four such posts are provided in equally spaced relation. The connecting posts 166 are adapted to connect the end cap 116 to an end plug (FIG. 4) when the combination lock 100 is assembled. The connecting posts 166 are therefore operative to force rotation of the end plug (FIG. 4) upon rotation of the end cap 116.

As shown in FIG. 4, a blow-up of still further portions of FIG. 1, the end plug 168 comprises a disk-shaped head portion 170 and a generally cylindrical threaded portion 172, the threaded portion being of a smaller diameter than the head portion. The head portion 170 includes at least one recess 174 sized and shaped in registration with the at least one connecting post 166 extending from the end cap 116, such that the connecting post may enter the recess upon assembly of the combination lock 100. In preferred embodiments, there are four such recesses 174 to mate with four corresponding connecting posts 166.

The threaded portion 172 of the end plug 168 extends distally from the head portion 170 and is preferably concentric therewith. The generally cylindrical threaded portion 172 includes a pair of opposed flat sections 176 separating threads 178, such that the end plug 168 has the general appearance of a bolt, a commonly used configuration for cam cylinders. Of course there are many other suitable configurations.

The combination of the threads 178 and flat sections 176 are adapted to be inserted into an aperture 180 provided in the latch 110 upon assembly of the combination lock 100. The latch aperture 180 is shaped such that it includes flat sections 182 corresponding to the flat sections 176 of the end plug 168. In this regard, once the threaded portions 178 of the end plug 168 are inserted through the aperture 180 of the latch 110, the latch will rotate together in corresponding rotation with rotation of the end plug 168. A nut 184 is provided to hold the latch 110 to the end plug 168, the nut being threaded onto the threads 178 provided on the threaded portion 172 of the end plug.

Also shown in FIG. 4 are cylinder retention clips 186. The cylinder retention clips 186 are operative to engage with recess 188 formed within the casing 102. The retention clips 186 assist with retaining the combination lock 100 within the mechanism of final assembly, such as a door. Retention clips 186 and combination locks generally utilizing retention chips are well-known in the art.

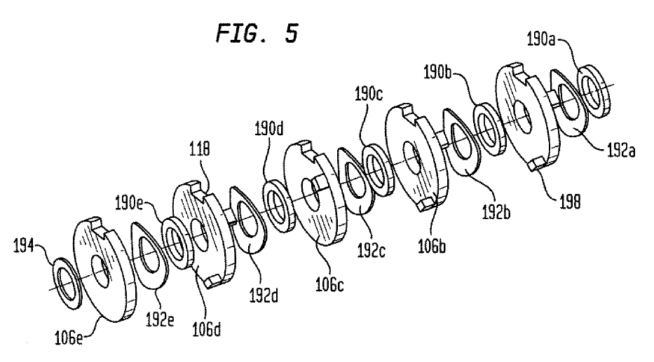

In a final blow-up of FIG. 1, FIG. 5 depicts the arrangement of standard disks, such as disks 106a, 106b, 106c, 106d, 106e, utilized in accordance with the particular and exemplary aspect of the invention shown in FIG. 1. It is noted herein that while the particular embodiment depicted in FIG. 1 incorporates five such disks, the invention is not so limited. In fact, it is anticipated that less or more disks may be utilized—as the combination lock is not constrained by the limits of human dexterity, memory or the like.

It is well-known that as the number of disks increases, there are less practical areas of gates available on any single disk. This is due to “nulls” created by the overlapping positions of adjacent disks. As a practical example, when two disks are used, it is estimated that 46 gate positions may be available for use on either of the disks in a conventionally sized ¾″ diameter combination lock. Yet, if five disks are used, the number of available gate positions may be reduced to approximately 40 positions per disk. These figures may be further reduced depending on gate and side bar dimensions and clearances, or the dimensions of the fly and pusher. In locks of the type described herein, the available gates per disk may further be reduced as a function of the tool's angular positioning resolution and tolerances.

The following table depicts the approximate number of combinations available for combination locks with various numbers of disks, as well as the time it would take for a malfeasant to cycle through all of the combination permutations, assuming each permutation could be cycled through in one second. This table assumes 7.5 degree increments for the gates (360/7.5=40) and that the fly and pusher occupy 15 degrees each. As is shown, the number of combinations, and thus the time it would take to cycle through the permutations, grows exponentially with the number of disks. The current practical limit of four disks theoretically allows for approximately four million permutations. A five disk cylinder lock, such as that created by Joseph L. Hall of Cincinnati, Ohio, in the mid-1800s, theoretically permits approximately 163 million combinations if constructed in accordance with today's state of the art designs and with today's state of the art materials. The five disk lock has proven to be too cumbersome for human use, and has never become accepted in commercial use. Notwithstanding, aspects of the present invention now make it practical to place combination locks with over five disks into the stream of commerce.

TABLE 1
Permutations and time to cycle all combinations assuming a theoretical
number of positions per disk.

| No. | No. | | Time | | |
|---|---|---|---|---|---|
| disks | Pos. | No. Permutations | Hours | Days | Years |
| 1 | 48 | 48 | 0.013 | | |
| 2 | 46 | 2,208 | 1 | | |
| 3 | 44 | 97,152 | 81 | 3 | |
| 4 | 42 | 4,080,384 | 4534 | 189 | 0.5 |
| 5 | 40 | 163,215,360 | 226688 | 9445 | 26 |
| 6 | 38 | 6,202,183,680 | 10336973 | 430707 | 1180 |
| 7 | 36 | 223,278,612,480 | 434152858 | 18089702 | 49561 |

Referring again to FIG. 5, it is shown that a combination lock 100 may include five standard disks, 106a, 106b, 106c, 106d, 106e. Again, cylinder locks manufactured in accordance with the present invention may include less or even more disks, notwithstanding the five disks shown. In addition to the disks 106a, 106b, 106c, 106d, 106e, FIG. 5 depicts spacers 190a, 190b, 190c, 190d, 109e, and spring washers 192a, 192b, 192c, 192d, 192e, associated with each disk. Each of the disks 106a, 106b, 106c, 106d, 106e, includes a spring washer 192a, 192b, 192c, 192d, 192e, and spacer 190a, 190b, 190c, 190d, 190e, in that order, moving from the proximal end toward the distal end of the combination lock 100. This arrangement is well-known in the industry and serves to properly space the disks 106a, 106b, 106c, 106d, 106e, while also providing compression on the disks by virtue of the spring washers 192a, 192b, 192c, 192d, 192e.

At the extreme proximal end of the disks shown in FIG. 5, there is shown a thrust washer 194. Referring back to FIG. 2, it will be appreciated that the thrust washer 194 is spaced against the front cap 128 when the combination lock 100 is fully assembled.

Using disk 106a as an example, it will be appreciated that each disk 106a, 106b, 106c, 106d, 106e, includes a fly nib 196 and a pusher nib 198, with the fly nib on the distal side and the pusher nib on the proximal side. As will be discussed, upon rotation of the disks 106a, 106b, 106c, 106d, 106e, the pusher nib 198 of a first disk will engage the fly nib 196 of a second disk, on the proximal side of the first disk, to rotate the second disk. For example, upon rotation of disk 106a, pusher nib 198 will engage fly nib 196 of disk 106b to rotate disk 106b. This arrangement is commonly known in the art, where spacers 190a, 190b, 190c, 190d, 190e, also provide mechanical isolation between discs to ensure that adjacent discs only move when fly and pusher nibs are in contact.

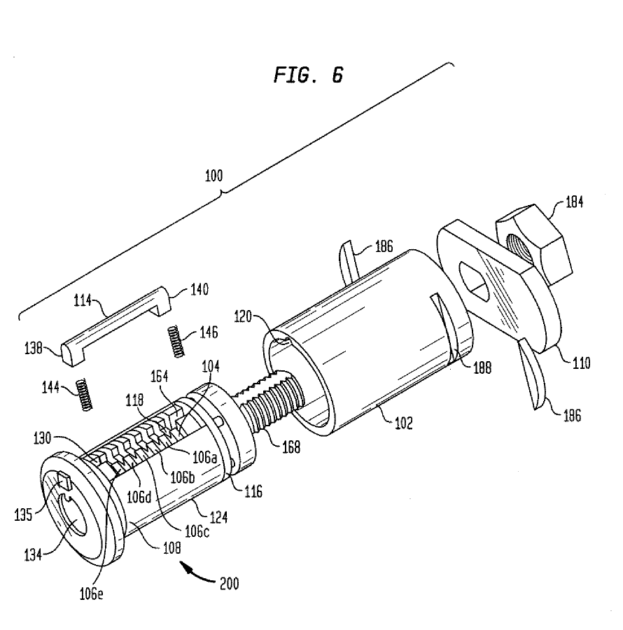

FIG. 6 depicts the combination lock 100 of FIG. 1 in a nearly assembled condition. As shown, the disks 106a, 106b, 106c, 106d, 106e, have been assembled into the extension portion 124 of the drive cylinder 108, with the drive assembly 148 and end plug 168 following. This complete arrangement is referred to as the disk core 200.

In a completely assembled condition, the legs 138, 140 of the side bar 114 would be installed into the front cap gate 130 and the side bar gate 164 respectively, with the springs 144, 146 there between. The casing 102 would then be slid over the extension portion 124 of the drive cylinder 108 such that the side bar 114 is lodged within the notch 120 provided in the casing. Once so positioned, the cylinder retention clips 186 may be positioned within the cylinder retention clip slots 188 of the casing 102, such that they are lodged between the end plug 168 and the end cap 116 to retain the disk core within the casing. Finally the latch 110 may be placed over the threaded portion 172 of the end plug 168 and secured with the nut 184.

The operation of the cylinder lock of the present invention, such as the combination lock 100 shown in FIG. 1, is very similar to conventional cylinder locks, with the exception that the present cylinder lock preferably requires great accuracy of input due to the increased tolerances afforded by the tool and more rotations of the drive shaft 112 due to the greater number of disks provided. Accordingly, in order to unlock the combination lock 100, a user would be required to insert the mating element of a tool having specific features which will be further described below, into the aperture 134 such that the mating element interfaces with the alignment notch 154 of the drive shaft 112. The mating element must then be rotated in accordance with the proper rotational pattern to unlock the lock.

The rotational pattern is typically clockwise, counterclockwise, clockwise, and so on. Because there are no external markings to indicate rotational degrees of the mating element and thus of the drive shaft 112, the tool must “know” how many of degrees of rotation through which it has traveled on each pass, and the correct combination for the lock. The tool may “know” this through various means, such as the means discussed above with respect to the “dumb,” “not-so-dumb,” and “smart” tools.

In any event, once the tool “knows” the correct combination, the engagement of the mating element with the drive shaft 112 permits the lock opening sequence to begin. Once begun, the mating element will rotate the drive shaft 112 through revolutions in a single direction at least equaling the number of disks in the lock to ensure that the disks are properly aligned in a beginning sequence. This rotation rotates the drive disk 104, for example in a clockwise direction. Each of the subsequent disks is “picked up” by the pusher nib of the preceding disk until the disks are aligned. Once the number of revolutions is reached, the drive disk 104 is then rotated in the counterclockwise direction one complete revolution such that the pusher nib 202 of the drive disk engages with the fly nib 196 of disk 106a. The rotation is then continued in the same direction until all of the pusher nibs 198 of the disks 106a, 106b, 106c are engaged with the fly nibs 196 of the adjacent disks. The rotation is ceased when the gate 118 of disk 106d is aligned directly below side bar 114, a location previously calibrated to a particular combination.

To calibrate the tool and the lock, the rotations may account for the offset of the alignment notch 154 of the drive shaft 112 and the tab 136 extending into the aperture 134 of the lock 100, as previously discussed. The tool may, therefore, include a mechanism to detect this offset. In order to permit the tool to mate with the alignment notch 154 of the drive shaft 112 no matter what orientation the alignment notch is in, the mating mechanism of the tool may be free to rotate and shaped such that it moves freely into position aligned with the alignment notch automatically as the mating of the lock and tool occurs. In order to move into such position, the opposing surfaces may be cammed or chamfered.

In this regard, it will be appreciated that the tolerance between the gate 118 and the side bar 114 of the present invention may be much tighter than those of conventional human operated cylinder locks because of the precise control exercised by the tool, which is vastly superior to average human dexterity. This serves several advantages. First, it permits a greater number of possible gates 118 per disk. It should be obvious that the greater number of gates 118 locations per disk, the greater number of possible combinations. Also, this enables the lock to be much more pick resistant, as the tighter tolerances make it much more difficult for a malfeasant to “feel” the gate as the disk is rotated in an attempt to pick the cylinder lock in the conventional manner known in the art.

Once the first disk 106e is properly aligned, the tool rotates the drive shaft 112 in the opposite direction such that the pusher nib 202 of the drive disk 104 engages the fly nib 196 of disk 106a in preparation for rotation of disk 106a in the opposite direction. The tool continues to rotate the drive shaft 112 until the rotations equal the number of disks minus one, such that disk 106d is not now “picked up” by the rotations. The proper number of rotations and more specifically, the proper degree of rotation will then leave the gate 118 of disk 106d aligned directly below the side bar 114. This procedure is then repeated until all of the gates 118 are aligned directly below the side bar 114.

Once the gates 118 are aligned, the entire drive cylinder 108 may be rotated within the casing 102. This causes the main portion 142 of the side bar 114 to drop down into the gates 118 and the legs 138, 140 of the side bar to drop into the front cap gate 130 and the end cap gate 164, respectively, as the notch 120 of the casing cams the side bar, compressing springs 144, 146. It will be appreciated that such rotation influences the end cap 116 and the end plug 168 to rotate, causing the latch 110 to similarly rotate opening the combination lock 100. If the gates 118 are not aligned, it is well-known in the art that the casing 102 may not rotate as the side bar 114 interferes with any attempted rotation.

As noted, the combination lock 100 opening sequence is similar to the opening sequences known in the art, but expands upon those by incorporating a greater number of revolutions owing to the use of greater numbers of disks. In addition, there are preferably no external indications of rotation degrees. Accordingly, the combination lock may not be operated without the precision of the tool.

In addition to the features of the combination lock 100 discussed above with respect to FIG. 1, certain other embodiments of cylinder locks may incorporate additional features. One such feature is the scrambler spring 204 which is also depicted in FIG. 1 as an optional accessory. The scrambler spring 204 may be included to provide a torsional force between the drive disk 104 and the drive cylinder 108.

As shown in FIG. 7, a blow-up of portions of FIG. 1 similar to the view shown in FIG. 3 but with the addition of the optional scrambler spring 204, on the extreme distal end of the drive shaft 112 beyond the distal drive assembly spacer 158, the drive shaft may comprise a flat surface, referred to herein as an overtorque control surface 206. The overtorque control surface 206 may cooperate with a flat first end 208 of the scrambler spring 204 to progressively rotate and add potential energy to the scrambler spring as the drive shaft 112 is rotated. The second end 210 of the scrambler spring 204 may be hook-shaped to latch onto the edge 212 (FIG. 2) of the extension area 124 of the drive cylinder 108 to hold the second end of the scrambler spring in place.

When the scrambler spring 204 is included, rotation of the drive shaft 112 will rotate portions of the scrambler spring such that the spring is energized. The standard tool utilized to achieve such rotation includes sufficient power to overcome the resistance of the spring 204. Once the lock has been opened, and the tool is removed, the now energized scrambler spring 204 serves to rotate the disks in a random pattern such that the disks are no longer aligned. This is done primarily as an added security feature, but also serves to reinforce the need for tool operation rather than human operation. If the lock includes a scrambler spring 204, human manipulation of the lock becomes more difficult as the spring may tend to turn the external dial (if so provided) through degrees of revolution not known by the user whenever the user loses a tight grasp of the external dial (if so provided). In lieu of a scrambling spring, the lock may be scrambled by the tool after the lock has been opened and before the tool is extracted. This scrambling algorithm may be programmed into the tool, and only needs to scramble one disk to ensure that the lock relocks. Of course the side bar would need to be in the recessed (unlocked) position before the algorithm is run. In this regard, the lock may incorporate a tool retention feature such that the tool may not be removed from the lock until the sidebar is returned to the recessed (unlocked) position.

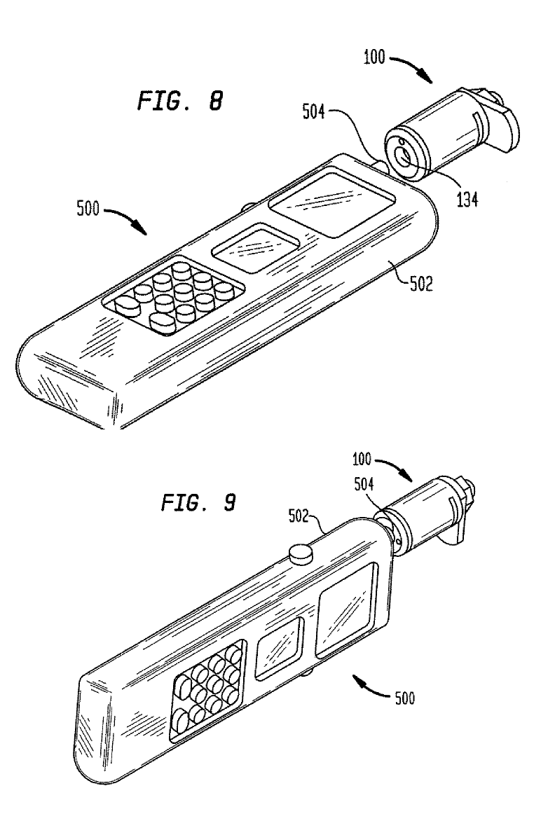

FIGS. 8 and 9 depict a tool 500 in accordance with certain aspects of the present invention alongside a combination lock 100. As shown, the tool 500 may include a body 502 and a cylinder lock interface 504. The cylinder lock interface 504 is adapted to fit within the aperture 134 and engage the drive shaft 112 generally, and particularly the alignment notch 154.

FIG. 8 generally depicts the tool 500 prior to engagement with the combination lock 100. As previously discussed, the lock interface 504 of the tool 500 may engage the combination lock 100. Once engaged, the lock interface 504 may go through its series of rotations to unlock the combination lock 100. The entire tool 500 may then be rotated to rotate the drive cylinder 108 and latch 110, to the position shown in FIG. 9 from that shown in FIG. 8, to unlock the lock.

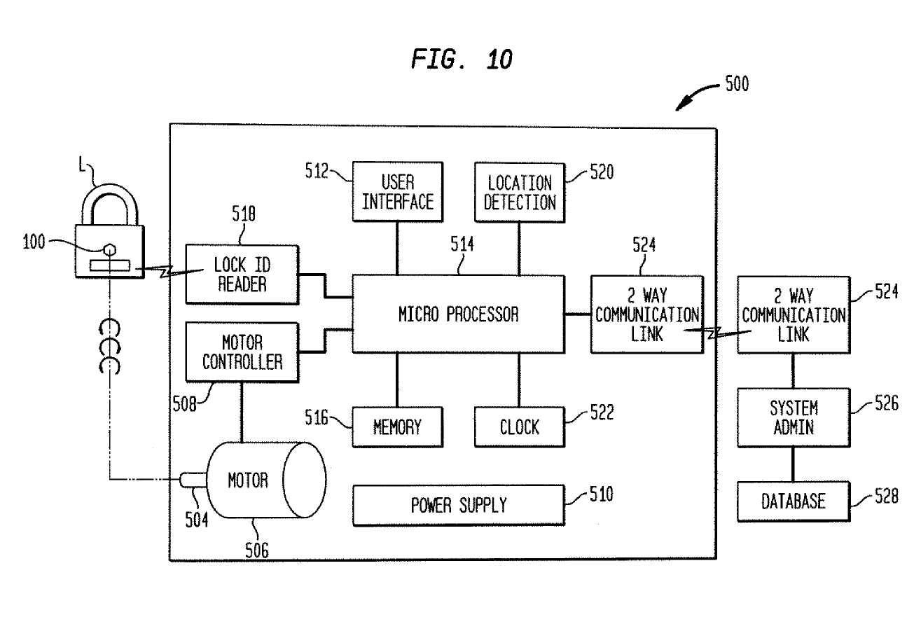

FIG. 10 depicts a functional diagram of a typical tool, such as tool 500 adjacent to lock L incorporating a combination lock 100. At a minimum, the tool 500 typically includes a motor 506, motor controller 508, power supply 510, and user interface 512 (in which case the user interface 512 may be directly associated with the motor controller 508). This arrangement of components may be considered a “dumb tool,” as previously discussed. The tool 500 may therefore function to open the cylinder lock, such as combination lock 100, when the user interface 512 is activated. When the user interface 512 is activated, the power supply 510 will provide power to the motor controller 508 which will activate the motor 506. Again, this represents to most basic of tools, such as the “dumb tool” previously described.

Typically, the power supply 510 will be a standard power supply, such as 6, 12. or 18 volt DC. More or less powerful units may also be utilized if desired, or based on engineering and design criteria. AC power, either exclusively or in combination with the DC circuitry, may also be provided if so desired.

The motors 506 preferred for tools of this type are fine stepper motors, although other types of motors such as servo motors with position encoders may also be utilized. Stepper motors capable of the fine accuracy and range of motion required for this application are well known in the art. Such motors offer the ability to “stop on a dime,” and may rotate both clockwise and counterclockwise while retaining a extremely fine level of accuracy.

In the most basic form, the user interface 512 may be a simple on/off button or switch. For example, a “dumb” tool may operate to open locks having only one combination. The tool 500 may therefore rotate the cylinder lock interface 504 through a single combination at the instant the on/off button is activated. Thus, the motor controller 508 serves as the only memory and processing unit required.

The basic tool may incorporate components which are equivalent or which may be derived from those taught in U.S. Pat. No. 5,017,851 issued to Heinzman, the disclosures of which are incorporated herein by reference. These components may include the microprocessor 514, motor controller 508, memory 516, motor 506, and user interface 512, among other possible components such as power supply components. An example of a microprocessor 514 which may be utilized in the present invention is the ubiquitous Zilog® Z80 8-bit microprocessor. Zilog® is a registered trademark of Zilog, Inc., 910 East Hamilton Avenue, Campbell, Calif. 95008.

In more sophisticated tools, such as “not-so-dumb tools,” the tool 500 may also include optional features such as more elaborate user interfaces 512, microprocessors 514, memory modules 516, and lock identification readers 518. The “not-so-dumb tool” may also incorporate location detection means 520, such as GPS, RFID, cellular technology, or the like. Finally, the “not-so-dumb tool” may also incorporate an internal clock 522, for recording the timing of particular events or other clock-related functions.

The functions of each of these elements have been previously discussed, and may be utilized in any combination to suit the purposes of the circumstance.

In the most sophisticated tools, such as “smart tools,” the tool 500 may also incorporate means for communicating to a remote station, such as a two way communication link 524, which may in turn be associated with a system administrator 526 and database 528.

Any of the aforementioned components may be split into separable components. For example, the power supply 510, motor 506 and motor controller 508 tend to be larger and bulkier than other components, particularly the memory 516, clock 522, and microprocessor 514. In addition, these components may be slower to evolve technically so may not require as frequent updating. As such, the power supply 510, motor 506 and motor controller 508 may be provided in a separate housing from the other elements. FIG. 11 depicts a tool 600 provided with separate housings for various components. In this particular example, the tool 600 comprises first housing 602 and a second housing 604. The first housing comprises the user interface 606 and cylinder lock interface 608 on its exterior. Although not shown, it will be appreciated that the interior portions of the housing may include at least the power supply, motor and motor controller. The second housing 604 is preferably sized to be relatively small, such as the approximate size a car's key-fob. In this regard, the second housing 604 may be designed to be carried on a key chain. The interior portions of the second housing 604, although not shown, may include at least the microprocessor and memory module. Without the second housing 604, the first housing 602 would not be able to open the lock, and vice versa. In addition to the components previously identified, the existence of the housings 602, 604 would also require mating elements (not shown) between the two. Such mating elements may include metallic contact strips, as commonly known in the electrical arts.

By utilizing separable components, an authority utilizing the separable tool to open combination locks may enjoy a much greater range of procedures and potentially higher levels of security than with a tool incorporating each of the features in a single housing. Additionally, cost savings may be realized. For example, the first housing 602 may be used generically between several operators, each having their own second housing 604. This sharing not only leads to cost savings realized through shared use, but also may permit better accounting of the whereabouts of the first housing 602, as it may always be with an on-shift user. For example, in a typical three shift day, if each of the three users possessed a tool incorporating all of the features required to open the combination lock, then three tools could potentially be stolen or misused at any one time. If, however, a shared first housing was utilized, only one theft or misuse component would be at risk. If a thief or malfeasant were to steal or misuse only the second housing, they still could not unlock a combination lock of the present invention without the first housing. Of course, even if one were to steal both housing, or a single tool incorporating all of the required features to open a lock, additional layered security may be included, such as biometrics, passwords, pin numbers, and the like associated with the user interface. Other security measures such as time and location recognition and authorization for use may also be incorporated.

In accordance with one particular aspect of the present invention, the use of RFID tagging may permit additional security levels not heretofore realized. In this regard, a tool, whether being self-contained or separable, may include an RFID sensing device. In order for the tool to operate, the sensing device may have to sense a particularly coded RFID tag in its vicinity. Such a tag may be carried by the user, for example in a credit-card sized device, key fob, wrist bracelet, neck pendant, or the like. Therefore, only an individual with an authorized RFID tag may be able to operate the tool, while all others will be electronically locked out.

Known technologies may be utilized for this purpose. Preferably, employment of an RFID tag sensing device within the tool and RFID tag carried by the user will not interfere with normal operation of the tool. By providing the RFID sensor with the capability of sensing within a conservative range, for example up to four or five feet, the user will not have to do anything other than have the RFID tag on his/her person, and the authorization process should not slow or otherwise impair operation of the tool.

Other similar authorization processes may also be employed. One such authorization process may be one where the tool includes a credit card-like magnetic strip swipe system. The user may swipe a magnetic coded pass card into the tool. The card may contain data required to authorize access. In another example, a user may be provided with a device that displays a pass code which changes at predetermined intervals, for example every 30 seconds. The tool may include a feature where the changing pass code must be entered into the tool for authorization prior to operation.

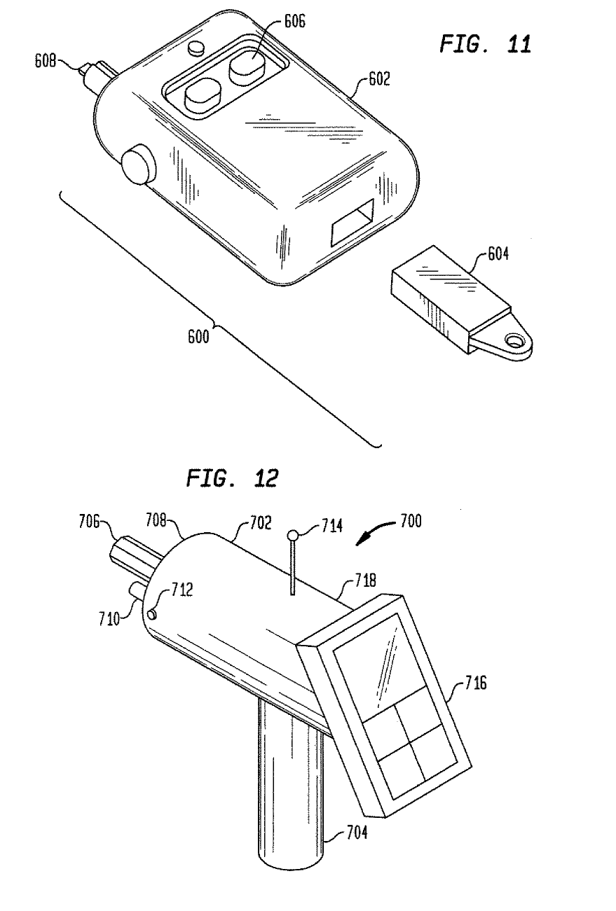

FIG. 12 depicts an exemplary tool 700 arranged in accordance with certain aspects of the present invention. As shown, the tool 700 may comprise an exterior housing 702 having a pistol-grip type handle 704. A drive element 706 may extend from a distal end of the exterior housing 702. As previously discussed, the drive element 706 is preferably adapted to mate with the drive shaft of a combination lock after entering the outer housing thereof, so as to rotate the drive shaft through the required combination. The drive element 706 may be formed to proprietary or non-proprietary shapes, to further enhance the security of the lock. Such shapes include polygonal, torx, splined, McGard®, or the like.

A registration element 710 may also be provided at the distal end 708 of the tool 700. The registration element may be a simple pin as shown, or may be more elaborate to further aid in the security of the device. The registration element 710 is adapted to mate with a corresponding element on the exterior portion of the combination lock (not shown), to align the tool in registration with the lock such that the required opening sequence may begin at a known reference point.

The distal end 708 of the tool 700 may also incorporate a sensor 712 adapted to identify the particular combination lock which is to be opened. As previously discussed, the sensor 712 may comprise an element adapted to read RF signals, optical signals, or magnetic signals, among others. The sensor 712 may also read barcodes, alphanumeric designators, or the like.

The tool may also incorporate a two way communication link 714 to link the tool's functioning to a remote authority. Such communication link 714 may comprise cellular, satellite, radio, IR, or other types of communication means.

The tool 700 may also incorporate a user interface 716, preferably at a proximal end 718 of the tool 700 for ease of use. The user interface 716, as previously discussed, may incorporate a key pad, LCD screen, card reader, biometric sensors, and the like, in order to securely control use of the tool 700.

In addition to the features shown and discussed with reference to tool 700, the tool may also comprise additional features not specifically discussed. Each of these features has been previously discussed with respect to FIG. 10, and may be incorporated into the tool either internally or externally, and in various combinations.

In addition to providing locks and tools separately, aspects of the present invention comprise systems of locks and tools engineered and constructed to work in tandem. Such locks and tools may comprise various combinations of elements previously discussed, all of which are entirely interchangeable depending on the nature of use to which the lock and tool will be put to.

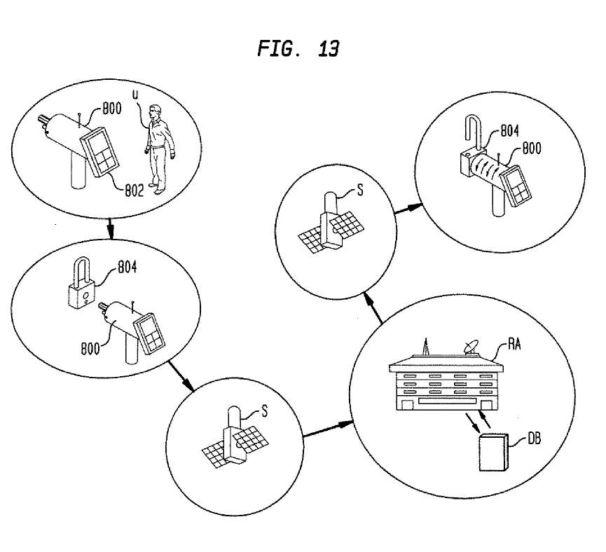

FIG. 13 depicts an overview of the typical operation of a tool in accordance with certain aspects of the present invention, particularly a “smart” tool incorporating exemplary features. As shown, a user U may obtain a tool 800 and validate the user's U identity via a validation process. The validation process may incorporate entry of a password into a user interface 802 forming a portion of the tool 800. The validation may also comprise use of biometrics or other validations means, as discussed.

The tool 800 may incorporate internal validation algorithms in its internal memory and process the algorithms through its processor, or the tool 800 may communicate with a remote station where the algorithms may be processed. In the most simplistic of locks, validation is based entirely on the input of user U. As such, if user U enters the correct validation information, the tool may be authorized for use. In other embodiments, validation may be based on input from the user U, as well as other factors, such as time of day, location of the tool, and identity of the combination lock.

In such case, the tool 800 may be mated with a combination lock 804 prior to validation. In this respect, the validation algorithm can determine if the particular user U is permitted to operate the lock in question 804. The mating of the tool 800 and the lock 804 permits a sensor (not shown) portion of the tool 800 to determine the characteristics of the lock in question 804, and to permit the tool itself to validate the information or to transmit the information to the remote authority RA. Such transmission may be through satellite communication S, as shown, or other communications means as previously discussed, for example landlines, cellular communications, IR communication, or the like. Once approval is received from the remote authority RA, the remote authority may store that information in a database DB. The remote authority may then communicate approval back to the tool through a satellite S or other means, and the tool may proceed with the angular positioning required to unlock the lock.

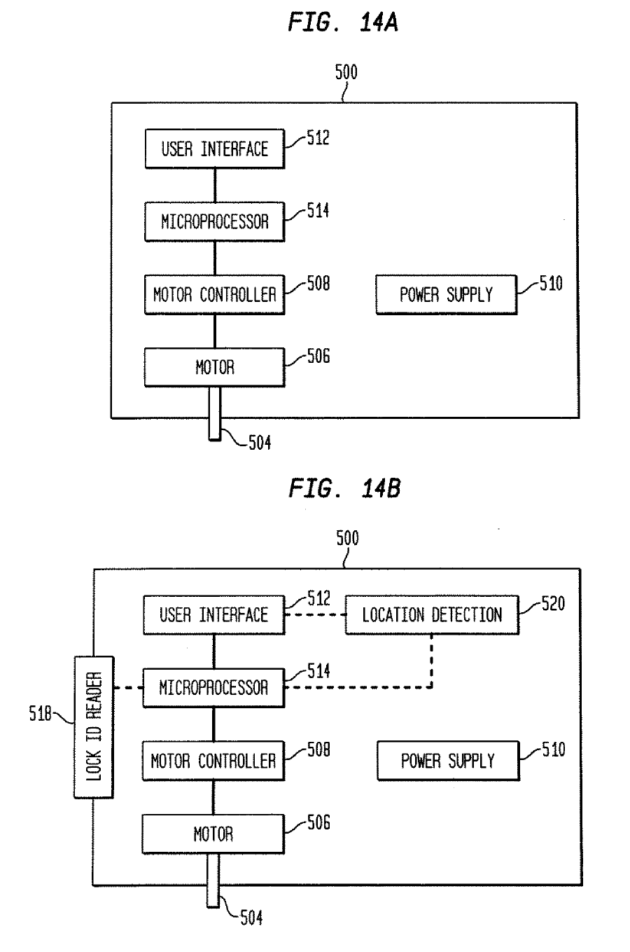

A logic diagram of a typical tool, such as tool 500 shown in FIG. 10, is shown in FIG. 14a. As shown, tool 500 may include a user interface 512. The user interface may comprise a simple on/off switch, where in the simplest of tools 500 the user may place the switch in an operative position to initiate action of the tool. This signal may be sent to a microprocessor 514, in communication with the user interface 512. Again in the most simplest of tools 500, the microprocessor may include logic to instruct a motor controller 508 through operative steps to control a motor 506 through a series of clockwise and counterclockwise rotations, to rotate a cylinder lock interface 504 to open a lock. It will be appreciated that the lock 500 may also include a power supply 510 to provide power for these operations. In addition, the lock 500 preferably includes a registration element 710 adapted to mate with portions of a lock to provide a reference point for the start of angular rotations of said cylinder lock interface 504.

FIG. 14b builds on the disclosure of FIG. 14a by including additional elements, which may be included in tools of greater complexity than those shown in FIG. 14a. For example, in FIG. 14b, the user interface 512 may be a keypad rather than a simple on/off switch. In this regard, a user may input a code into the user interface 512, where the code is associated with a lock. The microprocessor 514 in this case may include a look-up table to determine the required opening sequence for the lock in question. If the code is entered wrong, the lock will not operate.

As an example of the types of security components which may be built onto the tools of the present invention, shown in dotted lines on FIG. 14b is an alternative logic sequence, wherein the tool 500 further incorporates use of GPS authorization. As shown, the user interface 512 may not be directly connected to the microprocessor 514. Rather, the path of communication may go through a location detection device 520, such as a GPS component. In this regard, the location detection device 520 may limit communication between the user interface 512 and the microprocessor 514 unless the tool is in a predetermined location. Other types of location detection devices 520 include RFID or cellular devices.

Alternatively, rather than the location detection device 520 being in series between the user interface 512 and the microprocessor 514, the location detection device may communicate directly with the microprocessor 514, which may include an algorithm seeking a specific response from the location detection device.

In lieu of the location detection device, the lock 500 may include other components identified above. These other components may include biometric detection devices, for example. In such case, the user may have to satisfy a biometric criterion before the tool 500 may be enabled. Again, each of the components previously identified may be included interchangeably, cumulatively, or left absent, depending on the complexity and security levels desired for the particular application.

In still further levels of sophistication, a tool 500 may include additional features beyond those shown in FIG. 14b, such as those shown in FIG. 14c. In FIG. 14c, a tool 500 is shown to also include a lock identification reader 518. The lock identification reader 518 may identify characteristics about the lock being opened, and communicate those to the microprocessor 514. These characteristics may be identified from various sources, such as contact memory buttons, “motes,” bar codes, or the like, as described above. Once the identification of the lock is known by the tool 500, the microprocessor may correlate that identification with a look-up chart to determine the opening sequence for the lock in question. Once the sequence is known, a user input into the user interface may be required to initiate action of the tool 500. In other embodiments, the tool 500 may initiate automatically.

In still further embodiments, multiple look-up charts may be embedded into the logic of the microprocessor 514, for example the logic associated with a lock identification reader 518 and a location detection device 520. In this regard, the tool 500 may only operate to open a specific lock when the tool is in a specific location. Therefore, the tool 500 would identify the lock in question, then determine the locations in which the tool is authorized to open the lock. The microprocessor may obtain location information from the location detection device 520, to determine if the tool is in the proper location for that lock. Once the location detection criteria is met, the microprocessor 514 may proceed to look-up the combination for that particular lock, and transfer that information to the motor controller 508 to operate the tool.

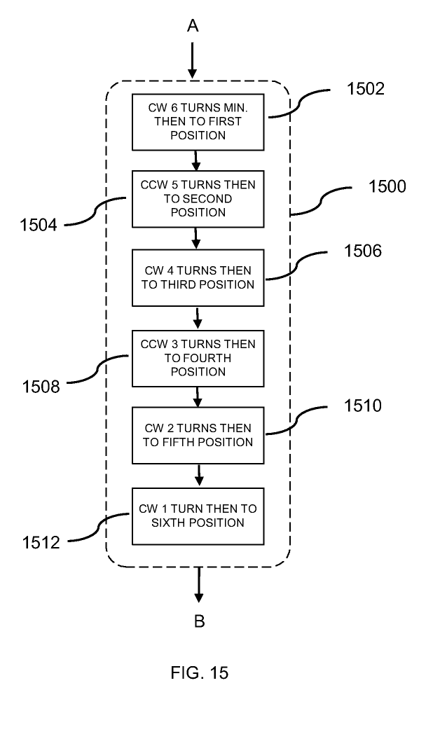

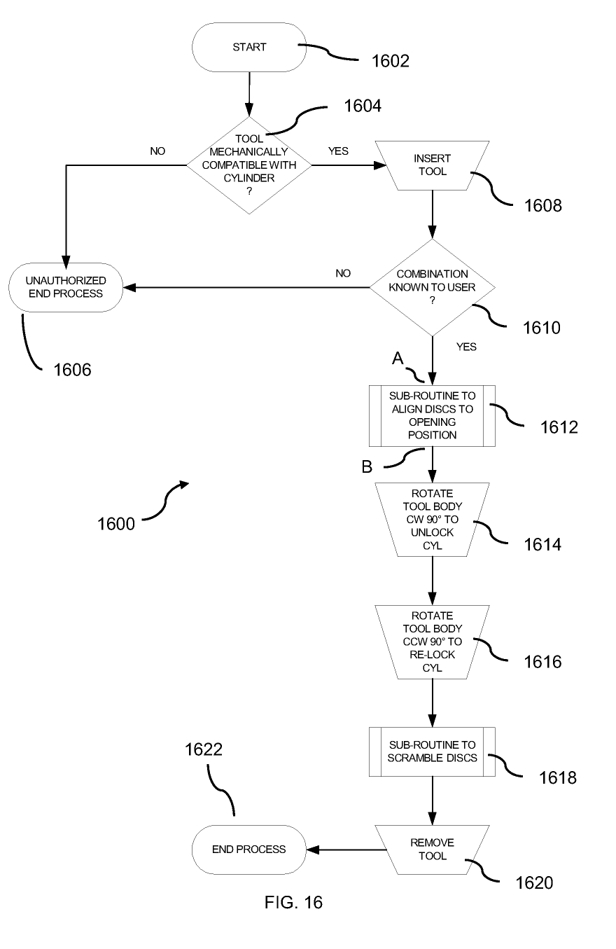

FIG. 15 depicts a diagrammatic flow chart of a subroutine utilized during the opening process of certain combination locks in accordance with particular aspects of the present invention. The subroutine shown in FIG. 15 is utilized in FIGS. 16 through 22 as the “SUB-ROUTINE TO ALIGN DISCS TO OPENING POSITION,” for example step 1612 of FIG. 16. In accordance with the subroutine 1500 shown in FIG. 15, and as previously discussed, a combination lock with six disks may be opened by rotating the drive shaft of the combination lock through a series of predetermined clockwise and counterclockwise rotations to align the disks.

Accordingly, the subroutine 1500 may begin at point A and proceed first to the step of rotating the drive shaft clockwise (“cw”) a minimum of six turns to a first position 1502 to align the first disk. As the combination locks in question typically include no markings associated with position, the tool and combination lock may also incorporate a zeroing step, or calibration step, to align the drive shaft of the combination lock into a known position where the tool may begin the subroutine. This step, although not shown in the subroutine 1500, would typically occur prior to the step of rotating the drive shaft clockwise a minimum of six turns to a first position 1502, or may be included within that step.

Step 1502 may be followed by the step of rotating the drive shaft counterclockwise (“ccw”) five turns to a second position 1504. This rotational movement serves to move all of the disks with the exception of the first disk previously aligned, and aligns the second disk into an opening position aligned with the first disk. Step 1504 may be followed by the step of rotating the drive shaft clockwise four turns to a third position 1506 to align the fourth disk. Step 1506 may then be followed by the step of rotating the drive shaft three turns in the counterclockwise direction to a fourth position 1508 to align the fourth disk. Step 1508 may be followed by the step of rotating the drive shaft two turns to a fifth position 1510 to align the fifth disk. Finally, in the sixth and last step of subroutine 1500, disk six may be aligned by following step 1510 with the step of rotating the drive shaft clockwise one turn to a sixth position 1512, thus ending the subroutine at point B with all disks aligned such that the sidebar of the combination lock may enter the disk gates when the combination lock core is rotated relative to the casing.

As previously discussed, the subroutine shown in FIG. 15 may be utilized during the processes shown in FIGS. 16 through 22 to unlock a combination lock having six disks. It will also be appreciated that other subroutines may be utilized, particularly if the number of disks is less than or greater than six.

FIG. 16 is a logic diagram depicting the operation of a dumb tool in accordance with one aspect of the present invention. Although there are different levels of dumb tools, it is believed that FIG. 16 depicts one of the simplest arrangements available under the present invention. In this arrangement, the operator of the tool would be charged with knowledge of the opening sequence (combination) of the combination lock, and would have to open the lock in a manual operation. In a very basic example, a finger manipulable dial with calibrated index may be associated with the lock for operation. However, because of the tight tolerances involved in the typical combination lock of the present invention, the tool preferably incorporates a step-down feature such that movement of an external dial on the tool will move the combination lock interface of the tool only a small portion of that movement. This gear reduction principle permits large obtuse movements of the human operator to be stepped down into much finer movements of the combination lock drive shaft, allowing the lock to be opened by human manipulation. Without the step down feature, only highly skilled artisans will likely be capable of the dexterity and concentration required.

Either with the step down feature or without, the tool may incorporate a revolution counting display, such that each revolution of the combination lock interface (or the finger manipulable wheel) is counted. This would eliminate the need for the user to count the revolutions manually, permitting the user to focus on the fine tuned rotation ending portions. Preferably, the display would reset back to zero following a change of direction.

The revolution counting feature is particularly suited to embodiments of the tool employing gear reduction, because the operator will not have to trouble himself/herself with knowledge of the gear reduction factor nor multiplication of the requisite number of turns of the finger manipulable wheel based on that reduction factor. For example, if the gear reduction was a factor of three, six turns of the combination lock interface of the tool would require 18 turns of the finger manipulable wheel. Five turns in the other direction would require 15 turns of the finger manipulable wheel. Once can readily see that a revolution counter associated with the tool would be welcomed by any user.

In accordance with the particular logic diagram 1600 shown in FIG. 16, a combination lock may be opened by a manual process starting with step 1602 followed by determining whether the tool is mechanically compatible with the combination lock at step 1604. In this regard, the mechanical compatibility may be determined by mating the drive shaft of the combination lock with the combination lock interface of the tool. If the combination lock interface is not compatible with the drive shaft, the tool is unauthorized to open the particular combination lock, and the process ends with step 1606. Additionally, if the tool is incapable of registration with the aperture of the front face of the combination lock, or registration tabs protruding therefrom, the tool is incapable of opening the combination lock and the process ends with step 1606.

If the tool's combination lock interface is compatible with the combination lock, then the tool may be inserted into the combination lock at step 1608. Once the combination lock interface is mated with the drive shaft in step 1608, the step of determining whether the combination is known to the user 1610 may be initiated. If the combination is not known to the user, then the tool is unauthorized for opening the lock, and the procedure ends with step 1606. If, however, the combination is known to the user, the user may mechanically rotate the combination lock interface through the requisite clockwise and counterclockwise turns in a sub-routine 1612 to align the disks of the combination lock into an opening position beginning with point A and ending with point B. The subroutine 1612 is shown as subroutine 1500 of FIG. 15. As discussed above, the tool may incorporate a gear reduction feature to allow for fine tuned manipulation, even by a human operator. The dial of the gear reduction feature of the tool preferably includes indexed markings associated with the combination of the combination lock, such that the user will have points of reference to begin and end the rotating sequences. The gear reduction mechanism may also include a revolution counter, as discussed above.

Once the disks inside of the combination lock are aligned, the tool body may be rotated, typically 900, in step 1614 to move the latch from a locked position to unlocked position to unlock the combination lock. To relock the combination lock, step 1614 may be followed by the step of rotating the tool body in the opposite direction as step 1614 through typically a 90 degree excursion path in step 1616. The tool operator may then rotate the combination lock interface through a sub-routine to randomly scramble the disks in step 1618.

In this regard, the subroutine to randomly scramble the disks may include a command to rotate the combination lock interface a random number of revolutions to place the disks in a random orientation. Preferably, the total number of revolutions is at least equal to the number of disks such that each disk is picked up and spun. Most preferably, the total number of revolutions is greater than the number of disks. It will be appreciated, however, that even a partial revolution is sufficient to unalign at least one disk. In addition, it will be appreciated that the direction of rotation is irrelevant. In an alternate arrangement, the disk scrambling sequence may rotate the combination lock interface through a series of random clockwise and counterclockwise motions to place the disks into a random orientation. In this case, it is preferred that the subroutine begin with at least a number of revolutions equal to the number of disks in the lock, such that each are picked up.

Once the disks are scrambled, the tool may be removed in step 1620 and the process ended in step 1622. In lieu of the subroutine to scramble the disks 1618, the lock may be configured with a scrambler spring to achieve the same result.

Although it is preferred for security purposes that a user not know the actual opening combination sequence of the lock, such as in the above example, there are times when such application has particular merit. For example, in a manual system such as described above, the system is completely immune to certain forms of attack, such as electromagnetic pulse energy attack. In addition, a manually operated tool may find utility in emergency situations where power, particularly to a remote authority, may be unavailable. This situation also may be useful for maintenance or service personnel associated with the lock manufacturer or owner.

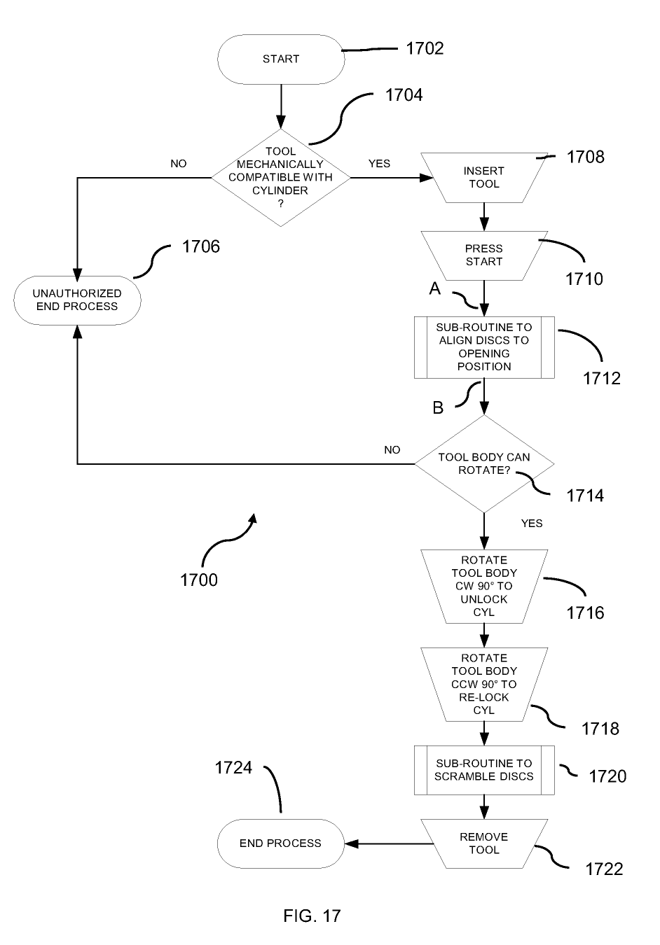

In a greater level of sophistication, a dumb tool may be designed to operate only a single lock having a particular combination, or a series of locks all sharing the same particular combination. An exemplary logic diagram depicting such a tool is shown in FIG. 17 as process 1700. Process 1700 may start with step 1702 by determining whether the tool is mechanically compatible with the combination lock in step 1704. If the tool is not mechanically compatible, the process ends with step 1706. If the tool is mechanically compatible, the combination lock interface of the tool may be inserted into the lock to mate with the drive shaft of the combination lock in step 1708. Once so inserted, the operator of the tool may initiate an opening routine by pressing, for example, a start button forming a portion of the tool in step 1710. Following step 1710, the tool may go through a sub-routine to align the disks to an opening position in step 1712 beginning at point A and ending at point B of the sub-routine shown in FIG. 15. It will be appreciated that in this application, the tool incorporates only one subroutine which is particularly suited for opening only one combination. In step 1714, the operator determines whether the tool body may rotate, indicating that the disks are properly aligned for opening of the lock. If the tool body cannot rotate, then the combination entered by the tool is incorrect for the particular lock, and the process ends with step 1706. If the tool can rotate, the process may continue to step 1716 where the operator may rotate the tool body in a particular direction to unlock the combination lock. To relock the combination lock, the operator may rotate the tool in the opposite direction in step 1718. The tool may then include a sub-routine to scramble the disks to a random orientation in step 1720. Once so scrambled, the tool may be removed in step 1722 and the process ended in step 1724.

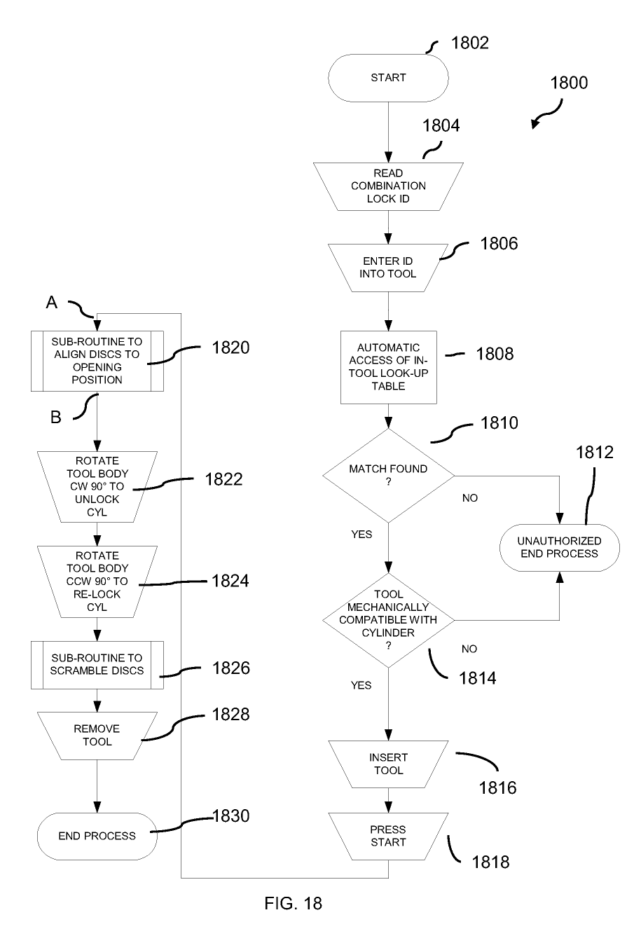

FIG. 18 depicts a logic diagram of the operation of a not-so-dumb tool in accordance with further aspects of the present invention. In accordance with the logic diagram 1800 of this exemplary not-so-dumb tool, the operator may start at step 1802. The operator may manually read an identification number off the combination lock in step 1804. In step 1806, the operator may enter the lock identification number into the tool, for example, by utilizing a keypad associated with the tool. The tool may then utilize the lock identification number in association with a look-up table embedded within the memory of the tool to determine the actual opening sequence for unlocking the lock. In step 1810, the tool determines whether a match is found. If no match is found, for example where the look-up table includes no combination for the lock identification entered, the tool is unauthorized for the particular lock, and the process ends with step 1812. If a match is found in step 1810, the process moves to step 1814 to determine whether the tool is mechanically compatible with the combination lock. If the tool is not compatible, the tool is unauthorized, and the process ends with step 1812. If the tool is compatible, the combination lock interface of the tool may be associated with the drive shaft of the lock in step 1816.

Once so associated, the operator of the tool may initiate an opening routine by pressing, for example, a start button forming a portion of the tool in step 1818. Following step 1818, the tool may go through a sub-routine to align the disks to an opening position in step 1820 beginning at point A and ending at point B of the sub-routine shown in FIG. 15. It will be appreciated that in this application, the tool utilizes the sub-routine combination found in the look-up table from step 1808. In step 1822, the operator rotates the tool to rotate the latch of the combination lock to an open position. To relock the combination lock, the operator may rotate the tool in the opposite direction in step 1824. The tool may then include a sub-routine to scramble the disks to a random orientation in step 1826. Once so scrambled, the tool may be removed in step 1828 and the process ended in step 1830.

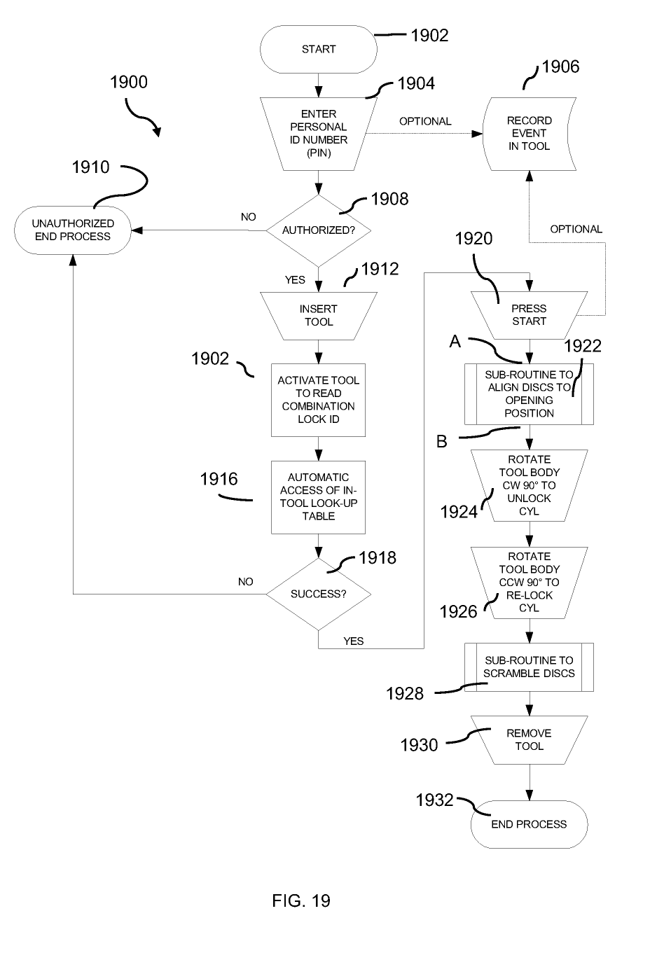

FIG. 19 depicts a logic diagram of the operation of a not-so-dumb tool in accordance with an additional aspect of the present invention. In accordance with FIG. 19, a logic diagram 1900 may start at step 1902. At step 1904, a user may enter a personal identification number associated with that user into a keypad forming a portion of the tool. The tool may optionally record the personal identification number into an internal memory in step 1906. In this step, the tool may also incorporate additional recorded features, such as a time stamp and location identification (for example by way of global positioning satellites). In step 1908, the tool determines whether the user is authorized to operate the particular tool by comparing the user's personal identification number with a look-up table. If the user is not authorized, the process ends with step 1910. If the user is authorized, the process continues to step 1912 where the combination lock interface of the tool may be associated with the drive shaft of the lock. In step 1914, the tool may be activated to read the lock identification. This may be achieved by RFID, a mote, a CMB, optical bar code, magnetic strip, or similar medium. In step 1916, the tool may utilize a look-up table stored within the tool's memory to associate the lock identification with a combination for that particular lock. Step 1918 determines whether a combination can be found. If no combination can be found, the process ends with step 1910. If a combination is found, the user may initiate opening of the lock by pressing a start button in step 1920. Optionally, this event may be recorded in the tool at step 1906.

Following step 1920, the tool may go through a sub-routine to align the disks to an opening position in step 1922 beginning at point A and ending at point B of the sub-routine shown in FIG. 15. It will be appreciated that in this application, the tool utilizes the sub-routine combination found in the look-up table from step 1916. In step 1924, the operator rotates the tool to rotate the latch of the combination lock to an open position. To relock the combination lock, the operator may rotate the tool in the opposite direction in step 1926. The tool may then include a sub-routine to scramble the disks to a random orientation in step 1928. Once so scrambled, the tool may be removed in step 1930 and the process ended in step 1932.

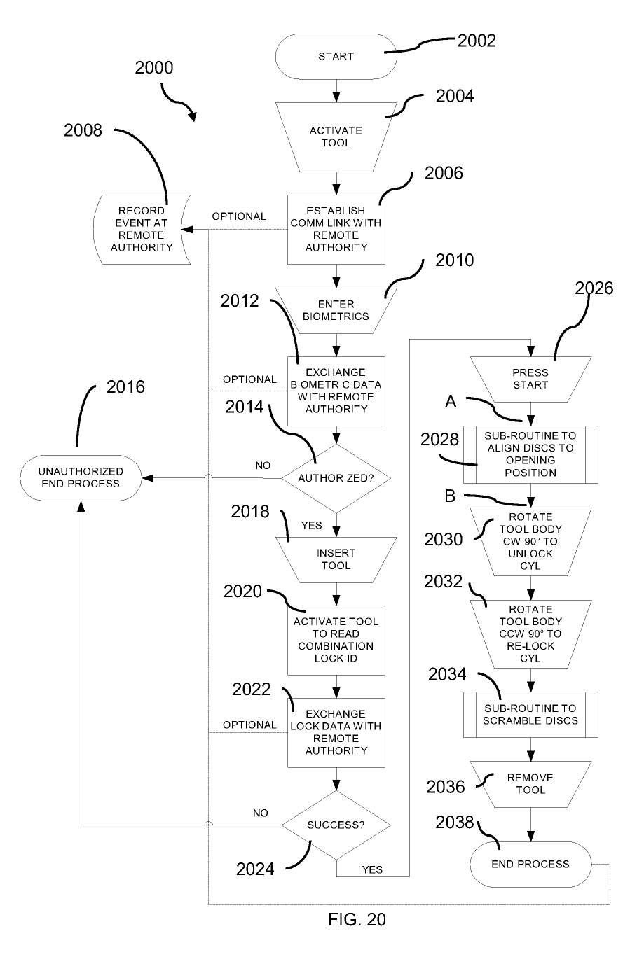

FIG. 20 depicts a logic diagram 2000 of a smart tool in accordance with certain aspects of the present invention. As previously discussed, the smart tool builds on the teachings of the not so smart tool and adds the ability to communicate with a remote authority. As shown in FIG. 20, the logic diagram may start at step 2002 and proceed to step 2004 where a user activates the tool. Alternately, the tool may be self-activated in a subsequent step, such as the subsequent step of inserting the tool into the lock 2018. In step 2006, the tool may establish a communication link with a remote authority. Optionally, this event may be recorded at the remote authority in step 2008. The remote authority may record certain data associated with the event, such as the time of the event and physical location of the tool, if the tool is provided with location identification means.

In step 2010, a user may enter biometric data into the tool for authorization. This biometric data may include fingerprints, retinal scanning, voice sampling, or the like. In step 2012, the biometric data may be exchanged with the remote authority. Optionally, this event may be recorded at the remote authority in step 2008. Authorization of the user is conducted in step 2014. If the user is not authorized by the remote authority, the process ends with step 2016 and the tool may be locked-out from further use until correct biometrics are entered. If the user is authorized, the tool may be associated with the lock in step 2018.

Part of the authorization process may include video information sent from the tool to the remote authority. Such video surveillance may be utilized to observe whether the tool operator, although providing the requisite biometric data, pass code, or other authorization, is under duress or force.

Once the tool is associated with the lock in step 2018, the tool may be activated to read the combination lock identification in step 2020. In step 2022, the lock combination identification read by the tool may be exchanged with the remote authority. In step 2024, the remote authority may determine whether a combination for that particular lock identification is known. If the lock opening combination is known, the remote authority may provide the proper opening sequence for the lock to the tool based on a look-up table available to the remote authority, also in step 2024. If the combination is not known, the process ends with step 2016.

Following step 2024, the user may begin the actual lock opening process by, for example, pressing a start button located on the tool in step 2026. The tool may then go through a sub-routine to align the disks to an opening position in step 2028 beginning at point A and ending at point B of the sub-routine shown in FIG. 15. It will be appreciated that in this application, the tool utilizes the sub-routine combination found in the look-up table from the remote authority. In step 2030, the operator rotates the tool to rotate the latch of the combination lock to an open position. To relock the combination lock, the operator may rotate the tool in the opposite direction in step 2032. The tool may then include a sub-routine to scramble the disks to a random orientation in step 2034. Once so scrambled, the tool may be removed in step 2036 and the process ended in step 2038. Optionally, this ending point may be recorded at the remote authority in step 2008.

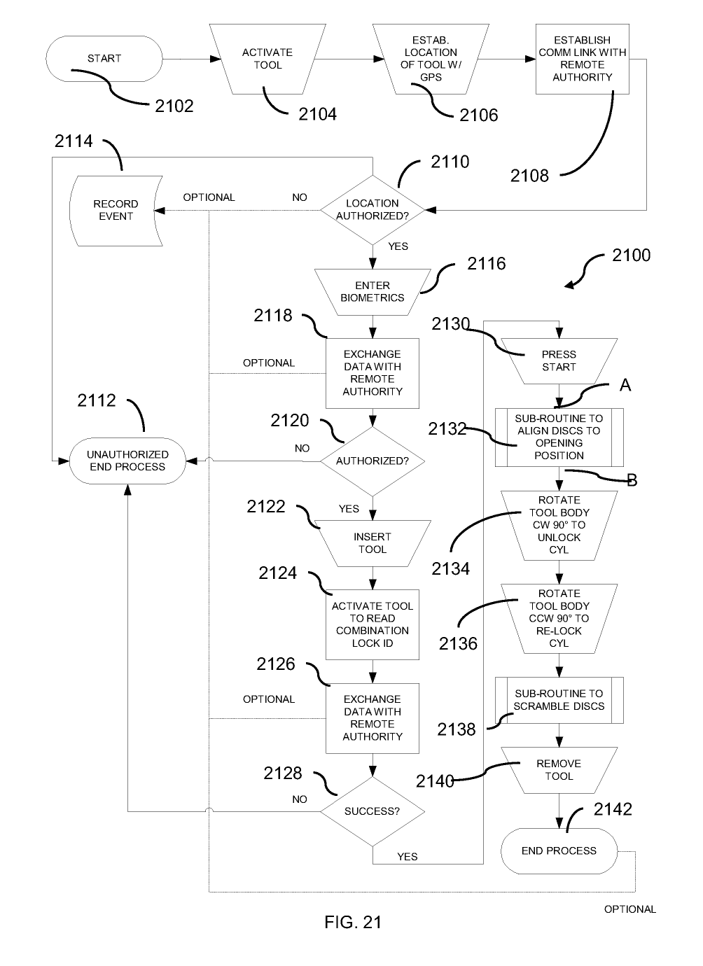

FIG. 21 depicts a logic diagram 2100 of a smart tool in accordance with certain aspects of the present invention. This particular smart tool operates in a manner similar to that of the tool identified in association with logic diagram of FIG. 20, but includes additional features.

As shown in FIG. 21, the logic diagram may start at step 2102 and proceed to step 2104 where a user activates the tool. In step 2106, the tool may establish a location by location detection means, such as GPS. Once the tool identifies its location, the tool may establish a link with a remote authority in step 2108. The remote authority may thereafter determine whether the tool is permitted to be activated in that particular location in step 2110. If the tool is not permitted by the remote authority to operate at its location, the process ends with step 2112. If the tool is permitted to operate, then the process may proceed to step 2116 where biometric data from the user is collected by the tool. Optionally, the authorization process of step 2110 may be recorded by the tool itself or preferably by the remote authority in step 2114.

In step 2116, a user may enter biometric data into the tool for authorization. This biometric data may include fingerprints, retinal scanning, voice sampling, or the like. In step 2118, the biometric data may be exchanged with the remote authority. Optionally, this event may be recorded at the remote authority in step 2114. Authorization of the user is conducted in step 2120. If the user is not authorized by the remote authority, the process ends with step 2112 and the tool may be locked-out from further use until correct biometrics are entered. If the user is authorized, the tool may be associated with the lock in step 2122. Once the tool is associated with the lock in step 2122, the tool may be activated to read the combination lock identification in step 2124.

In step 2126, the lock combination identification read by the tool may be exchanged with the remote authority. In step 2128, the remote authority may determine whether a combination for that particular lock identification is known. If the lock opening combination is known, the remote authority may provide the proper opening sequence for the lock to the tool based on a look-up table available to the remote authority, also in step 2128. If the combination is not known, the process ends with step 2112.

Following step 2128, the user may begin the actual lock opening process by, for example, pressing a start button located on the tool in step 2130. The tool may then go through a sub-routine to align the disks to an opening position in step 2132 beginning at point A and ending at point B of the sub-routine shown in FIG. 15. It will be appreciated that in this application, the tool utilizes the sub-routine combination found in the look-up table from the remote authority. In step 2134, the operator rotates the tool to rotate the latch of the combination lock to an open position. To relock the combination lock, the operator may rotate the tool in the opposite direction in step 2136. The tool may then include a sub-routine to scramble the disks to a random orientation in step 2138. Once so scrambled, the tool may be removed in step 2140 and the process ended in step 2142. Optionally, this ending point may be recorded at the remote authority in step 2114.

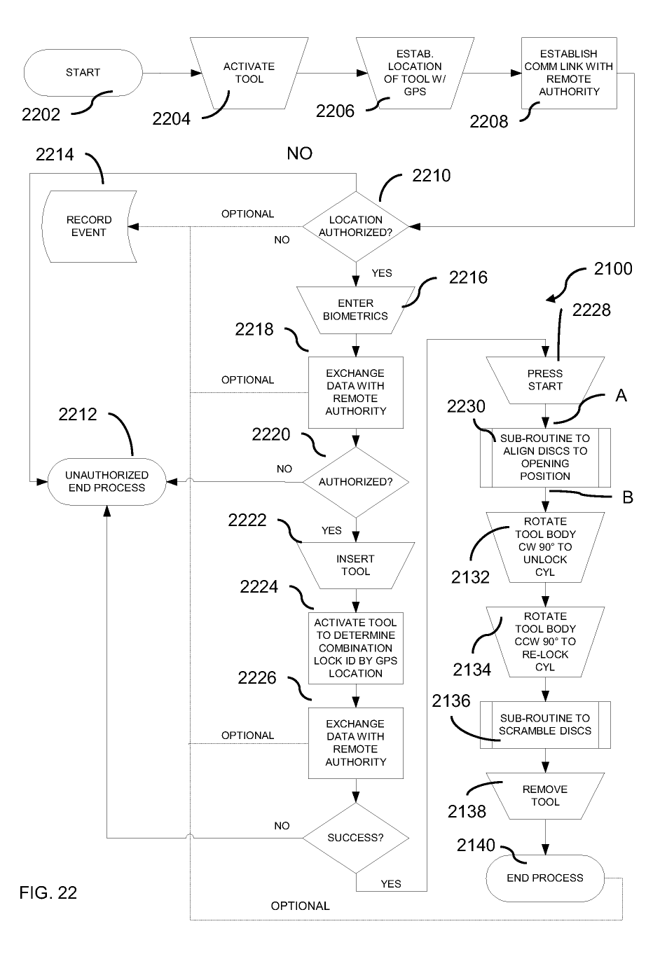

In a final example of a logic diagram which may be associated with a smart tool in accordance with aspects of the present invention, FIG. 22 depicts a logic diagram 2200 of a smart tool building on the teachings of the logic diagram shown in FIG. 21. In this regard, the logic diagram shown in FIG. 22 differs from that shown in FIG. 21 in that the location of the tool is utilized in FIG. 22 to determine the opening combination for the lock, rather than an identification number associated with the lock. This particular arrangement may find use in a variety of fields. For example, a parking authority may have three parking lots within its jurisdiction. Each parking spot may have a meter for patrons to pay into during times in which they park. Rather than having a single combination for each of the meters, the authority may arrange the meters such that the meters of any given lot have the same combination. In this regard, there will be three different combinations, each one associated with a single lot.

As will be discussed, in the logic diagram shown in FIG. 22, a single tool may be utilized to open each of the parking meters. The tool may obtain the correct combination for the meters of a given lot based on its geographic location of being within the particular lot.

Accordingly, the logic diagram for the smart tool shown in FIG. 22 may start at step 2202 and proceed to step 2204 where a user activates the tool. In step 2206, the tool may establish a location by location detection means, such as GPS. Once the tool identifies its location, the tool may establish a link with a remote authority in step 2208. The remote authority may thereafter determine whether the tool is permitted to be activated in that particular location in step 2210. If the tool is not permitted by the remote authority to operate at its location, the process ends with step 2212. If the tool is permitted to operate, then the process may proceed to step 2216 where biometric data from the user is collected by the tool. Optionally, the authorization process of step 2210 may be recorded by the tool itself or preferably by the remote authority in step 2214.

In step 2216, a user may enter biometric data into the tool for authorization. This biometric data may include fingerprints, retinal scanning, voice sampling, or the like. In step 2218, the biometric data may be exchanged with the remote authority. Optionally, this event may be recorded at the remote authority in step 2214. Authorization of the user is conducted in step 2220. If the user is not authorized by the remote authority, the process ends with step 2212 and the tool may be locked-out from further use until correct biometrics are entered. If the user is authorized, the tool may be associated with the lock in step 2222. Once the tool is associated with the lock in step 2222, the tool may be activated with step 2224 to collect the combination lock data from the remote authority in step 2226. Optionally, this event may be recorded by the remote authority in step 2214. It will be appreciated that, in an alternate configuration, the tool may have the particular combinations embedded in its memory, such that communication with the remote authority for the particular combination is not necessary.

Once the tool has uploaded the combination data from the remote authority in step 2226 (or has obtained the combination from its memory), the user may begin the actual lock opening process by, for example, pressing a start button located on the tool in step 2228. The tool may then go through a sub-routine to align the disks to an opening position in step 2230 beginning at point A and ending at point B of the sub-routine shown in FIG. 15. It will be appreciated that in this application, the tool utilizes the sub-routine combination found in the look-up table from the remote authority (or optionally from within the tool). In step 2232, the operator rotates the tool to rotate the latch of the combination lock to an open position. To relock the combination lock, the operator may rotate the tool in the opposite direction in step 2234. The tool may then include a sub-routine to scramble the disks to a random orientation in step 2236. Once so scrambled, the tool may be removed in step 2238 and the process ended in step 2240. Optionally, this ending point may be recorded at the remote authority in step 2214.

These examples of the types and operation of tools contemplated are not intended to be limiting. Rather, they are exemplary of the features of particular tools and systems of tools and locks contemplated by the inventors herein. Various combinations of the features shown and described may be incorporated into tools and systems flowing directly from the disclosure herein, as the features may be used interchangeably.

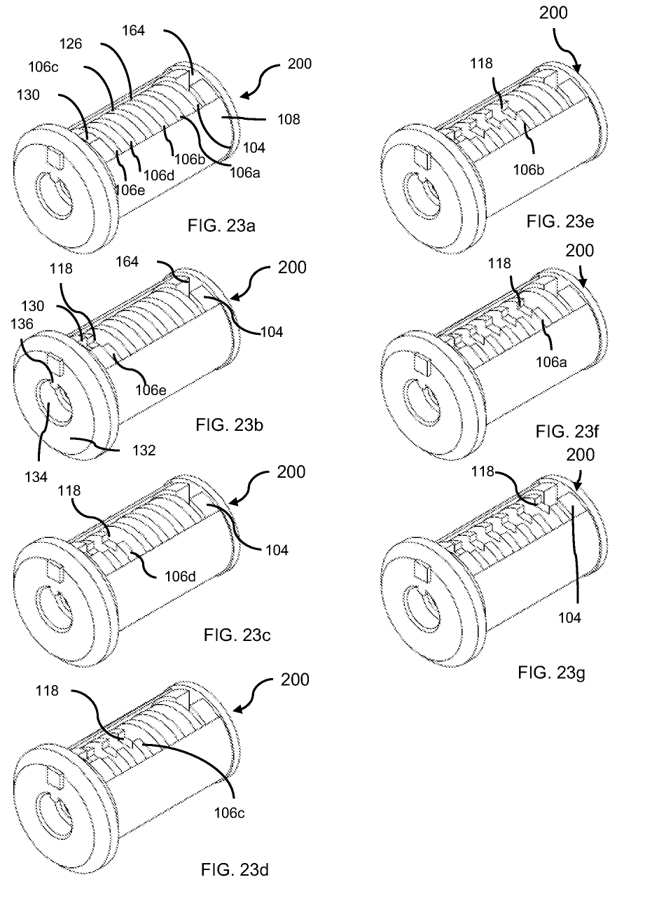

In accordance with further aspects of the invention, a combination lock disk core, such as disk core 200 shown in FIG. 6, may manufactured and fully assembled in a predetermined arrangement such that the opening combination of the disk core is known. In other manufacturing techniques, the disk core 200 may be assembled in a random arrangement without the opening combination of the disk core being known. FIGS. 23a through 23g illustrate one technique for determining the correct opening combination of a disk core 2300 assembled at random.

As shown in FIG. 23a, a disk core 200 may be assembled such that none of the gates 118 are visible through the open top area 126 of drive cylinder 108. Although not shown, it will be appreciated that some of the gates may be visible, depending on the random pattern in which they are installed. In any event, the front cap gate 130 and side bar gate 164 may be visible, and may be in alignment.

A video camera or position indication sensor may then record a series of movements of the disks 104, 106a through 106e, which places the gates 118 of each disk 104, 106a through 106e into alignment with front cap gate 130 and side bar gate 164. The video camera or position indication sensor may work off of known technology and may base their reading off, for example, gate edge recognition or a score line in the center of the gate. The alternating angular movements may then be saved as the opening combination for that particular lock.

In this regard, assuming that six disks are utilized such as in disk core 200, the drive disk 104 may be rotated in a predetermined direction, for example in a clockwise direction to a given reference point. This may be considered the opening value reference point, and can be measured against, for example, a tab 136 extending into the aperture-134 of the front face 132.

From this reference point, the drive disk 104 may be rotated at least six times in a particular direction, which for purposes of description may be the clockwise direction. Rotation may thereafter cease when the disks have all been “picked-up,” and the gate 118 of disk 106e is aligned with the front cap gate 130 and the side bar gate 164. The angle of rotation may then be recorded as the first reference in the combination for that particular lock. A disk core 200 with gate 118 of disk 106e properly aligned is shown in FIG. 23b.

The drive disk 104 may then be rotated in the opposite direction, here the counterclockwise direction, until the gate 118 of disk 106d is aligned with the gate 118 of disk 106e, as shown in FIG. 23c. The angle of rotation required for this to occur may then be recorded as the second reference in the combination for that particular lock.

This process may be repeated for disk 106c, as shown in FIG. 23d, disk 106b as shown in FIG. 23e, disk 106a as shown in FIG. 23f, and finally drive disk 104 as shown in FIG. 23g. Once all of the alternating rotations have been completed and recorded, the correct opening sequence (combination) for that particular disk core 200 will be known.

In accordance with other aspects of the present invention, additional security features against illicit operation may be incorporated. In accordance with one aspect, combination locks having multiple disks may include disks manufactured from different materials. One popular mode of illicitly opening a combination lock is by x-raying the lock to identify the location of the disk gates, and then manipulating the disks until they are aligned. However, certain materials are radio transparent and cannot be viewed with x-ray technology. A combination lock may therefore, include disks of such materials, either exclusively or in combination with disks of other materials. Examples of disks which are radio transparent are ceramic, glass, and plastic.

Other attack modes focus on the density of disk material. To counter these attack modes, disks of different densities may be utilized. For example, plastic disks are typically much less dense than metallic disks, such as brass, stainless steel, aluminum, titanium, iron, or the like.

Another common attack mode is drilling through the disks to open up a false gate. To prevent this form of attack, one or more disks may be made of material that will shatter when drilled. Such materials may include glass or ceramic.

As the disks rotate within the lock, malfeasants may utilize high tech listening devices to listen to the moving parts contacting each other to identify the opening sequence. By utilizing disks of different materials, the sounds may change making listening less effective

Perhaps the most common attack method is simply rotating the disk cylinder and feeling for the gate opening. Because of the sheer number of disks proposed in certain aspects of the invention, this is very difficult if not impossible. However, the attempt may be further frustrated by providing disks of different materials as the coefficient of friction for each material may be different, changing the feel from disk to disk

It will further be appreciated, that no matter the material utilized for each disk, another feature of certain aspects of the present invention is that the malfeasant will not know the number of disks that are in the lock. Thus, the malfeasant will not know how many gates are to be found. This further frustrates attempts to open the locks illicitly.

In another attack method, malfeasants may attempt to drill the face of a lock to drill through the side bar. Without the side bar in place, the lock may be easily opened. Traditional locks of the same type from one manufacture incorporate a side bar at a consistent position. Thus, if a malfeasant were to obtain one lock of a particular type from a manufacture, he may be able to identify the location of the side bar for all locks of the same type. In the present invention, the location of the side bar may be varied such that it may be located at any location around the 3600 face of the lock. For example, referring to FIG. 1 where the side bar 114 is located at the uppermost portion of the lock cylinder, it will be appreciated that the side bar may be moved to a side portion or bottom portion. In such case, the notch 120 of the casing 102 should be aligned with the side bar 114. It will be appreciated that random placement of the side bar may frustrate a would be attacker, by at least causing the illicit and destructive entry to be slowed.

In accordance with yet another security feature, a lock cylinder may be used only a single time in a particular application, or may be rotated through an application with different cylinders. For example, particularly with vaults or safes, a common method of attacking the container lock is to record the movement of the disks in the lock during an authorized entrance. Once the recording is made, a sophisticated malfeasant can analyze the recording to determine the opening combination. Even attempts to interfere with the recording, for instance by adding outside sound sources, can be filtered out.

However, if a particular cylinder is only used once with that vault or safe, it will not matter that the malfeasant is aware of that particular combination. Once the lock is opened, the cylinder can be removed and replaced with another having a different opening combination. The original cylinder can either be placed in a pool for reuse in a different vault or safe or destroyed, depending on the security level required by the application.

Many of the disclosures of the present invention, particularly features of the tools, although being described in association with tools and locks also disclosed herein, may be utilized in conjunction with existing locks and tools. For example, location detection and recording of a lock-opening event may be incorporated into existing locks, such as Mul-T-Lock®'s Interactive®. CLIQ® lock, Abloy's® SmartDisc lock, Medeco's® NEXGEN® locks, Videx's® CiberLock lock, or the like. Likewise, biometric authorization or time dependent use may also be incorporated. Although not specifically listed, it will be appreciated to one skilled in the art that many of the features disclosed herein may be utilized effectively in association with the teachings of these known devices.

The following describes the preferred embodiments of an improved combination lock in accordance with further aspects of the present invention. In describing the embodiments illustrated in the drawings, specific terminology will be used for the sake of clarity. However, the aspects of the invention are not intended to be limited to the specific terms so selected, and it is to be understood that each specific term includes all technical equivalents that operate in a similar manner to accomplish a similar purpose.

It will become evident to one skilled in the art that several objectives and advantages of this invention follow from the novel aspects of the present invention by which the security level of a combination lock is significantly increased, including the aspect of substantially increasing the number of opening combinations and substantially preventing a combination lock of being opened by only human manipulation of a dial or interface.

Throughout, the term wheel shall be construed broadly to include the element of a combination lock that is rotationally positioned to align with a side-bar or fence. The term fence is used primarily with traditional combination locks for safes and vaults, when the gates of the wheels are aligned the fence can drop in and the lock is in an un-locked state.

The term side-bar is used primarily with certain high security key cylinder mechanisms.

The present invention includes aspects and elements of traditional combination locks and high security key cylinders, certain terms for functionally similar elements are used interchangeably. For instance, the term cam or Cam may be covered herein by at least 3 definitions 1) A cam is part of a wheel that affects the motion of another part of the mechanism 2) A Cam is an eccentric or multiply curved wheel mounted on a rotating shaft, used to produce variable or reciprocating motion in another engaged or contacted part. 3) In a lock, a cam is rotating piece attached to the end of the cylinder plug to engage the locking mechanism.

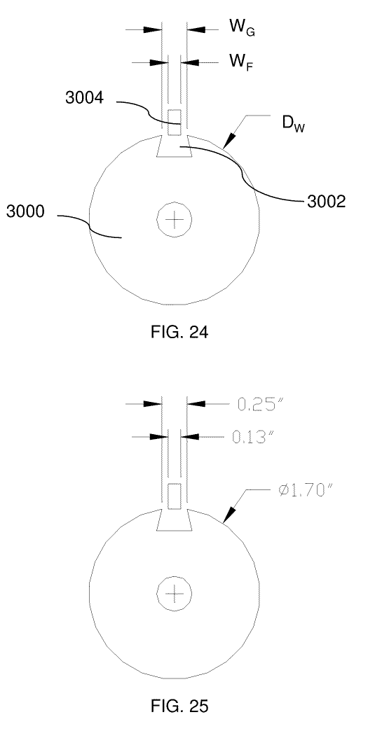

FIG. 24 depicts a front view of a wheel 3000 with a gate 3002 and a cross section of a fence 3004. The relative dimensions of these three elements; wheel diameter (D_{W}), gate width (W_{G}), and fence width (W_{F}) are an important factor in determining the manipulation resistance of a combination lock, the dimensional relationship also a factor in brute force attacks on the combination lock. A brute force attack is sequentially dialing all possible combinations. More clearance results in fewer combinations.

A GFD (Gate-Fence-Diameter) Factor can be defined as: GFD=((W_{G}−W_{F})D_{W})×100.

FIG. 25 depicts a dimensional relationship commonly found in high security (Group 1) combination locks for safes and vaults. The dimensions are:

WG=0.25″

WF=0.13″

DW=1.70″

The resulting GFD=((0.25−0.13)/1.70)×100=7.06

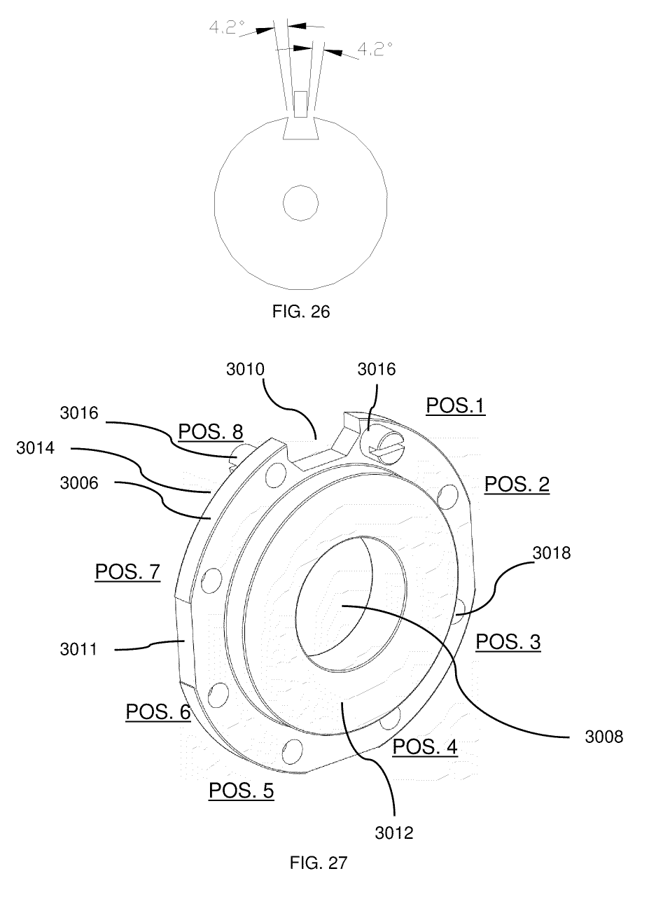

FIG. 26 depicts the resulting ± angular tolerance for the wheel in FIG. 2. The ± angular tolerance in degrees is calculated using the following equation: ((GFD/(100×pi))×360°)/2=±4°.

The following table shows the resulting GFD's and angular tolerances when W_{G}, W_{F} and D_{W} are varied. C_{W} is the circumference for the corresponding D_{W}.

TABLE 2

| | | | | | | +/− Tolerance | | | |
|---|---|---|---|---|---|---|---|---|---|
| | | | | | | for a dialed position | | | |
| | | | | | | | | | Grad- |
| | | | | | | | | | ua- |
| | | | | | | | | | tions |
| | | | | | | | | | 100 |
| | | | | | | | Ra- | | G |
| | W_{G} | W_{F} | D_{W} | C_{W} | GFD | °Deg | dians | Gradians | Dial |
| 1 | 0.25 | 0.13 | 1.7 | 5.34 | 7.06 | 4.0 | 0.071 | 4.49 | 1.1 |
| 2 | 0.12 | 0.06 | 0.5 | 1.57 | 12.00 | 6.9 | 0.120 | 7.64 | 1.9 |
| 3 | 0.12 | 0.09 | 0.5 | 1.57 | 6.00 | 3.4 | 0.060 | 3.82 | 1.0 |
| 4 | 0.12 | 0.06 | 1.7 | 5.34 | 3.53 | 2.0 | 0.035 | 2.25 | 0.6 |
| 5 | 0.12 | 0.09 | 1.7 | 5.34 | 1.76 | 1.0 | 0.018 | 1.12 | 0.3 |
| 6 | 0.12 | 0.09 | 6 | 18.85 | 0.50 | 0.3 | 0.005 | 0.32 | 0.1 |
| 7 | 0.05 | 0.04 | 0.25 | 0.79 | 4.00 | 2.3 | 0.040 | 2.55 | 0.6 |

Row 1 in the above table represents the current art. Rows 2 and 3 represent a wheel size that could work in a key cylinder form factor. Row 6 shows that for a given gate and fence dimensions the positioning requirements become more stringent as the WD is increased. The smaller the GFD is, the less tolerance there is for misalignment. Row 7 represents a miniature combination lock mechanism. It is contemplated that with the application of nano-technology the mechanism may be implemented in micro or nano scale.

Combination locks with a GFD of less than 7 may be more resistant to manipulation and sequential dialing attack but they have without an automated key diminished commercial benefit because they are not human friendly. The best commercially available combination locks for safes and vaults limit the dialing tolerance to ±4°, GFD of 7, so that they are convenient and human friendly. Convenient in this context means the user does not have to employ a mechanical or optical device for assistance and the lock can be dialed in a reasonable amount of time, for instance about 10 seconds.

FIG. 27 shows a wheel of similar dimensions to the example in TABLE 2, row 3. Wheels found in combination locks comprise a wheel body 3006, sometimes referred to as a disc, an aperture 3008 to allow rotation upon a spindle 3065 (which will be discussed later), a gate 3010, and a push cam 3016, also known as a push pin or driving cam on Side B 3014 and/or a following cam 3016 also referred to as a fly or driven cam on Side A 3012. From here on the terminology will be simplified to cam(s) on Side A 3012 and cam (s) on Side B 3014.

Side A 3012 is the driven side of the wheel 3006 and side B 3014 is the driving side of the wheel 3006. The first wheel to be positioned does not have a cam 3016 on side B 3014 because it does not drive an adjacent wheel. The drive wheel only has a driving cam 3016 on side B 3014 because it is not driven or moved by another wheel. The wheel in FIG. 4 also depicts false gates 3011 which are intended to frustrate certain picking procedures. The wheel 3006 in FIG. 27 has 8 tapped holes 3018, equally spaced. It is anticipated that there could be more or fewer holes, it is also anticipated that the holes could be irregularly or randomly spaced. The holes are identified by labeling them Position 1 through 8 in a clockwise manner when viewing side A 3012. Position1 is 22.5° clockwise from the center line of the gate 3010. The multiple tapped holes 3018 facilitate relocating the cams 3016. The number of tapped holes 3018 is limited by the size of the wheel 3008 and machinablility considerations. The wheel 3006 depicted in FIG. 27 is contemplated to be of a size to work within the envelope of a key cylinder.

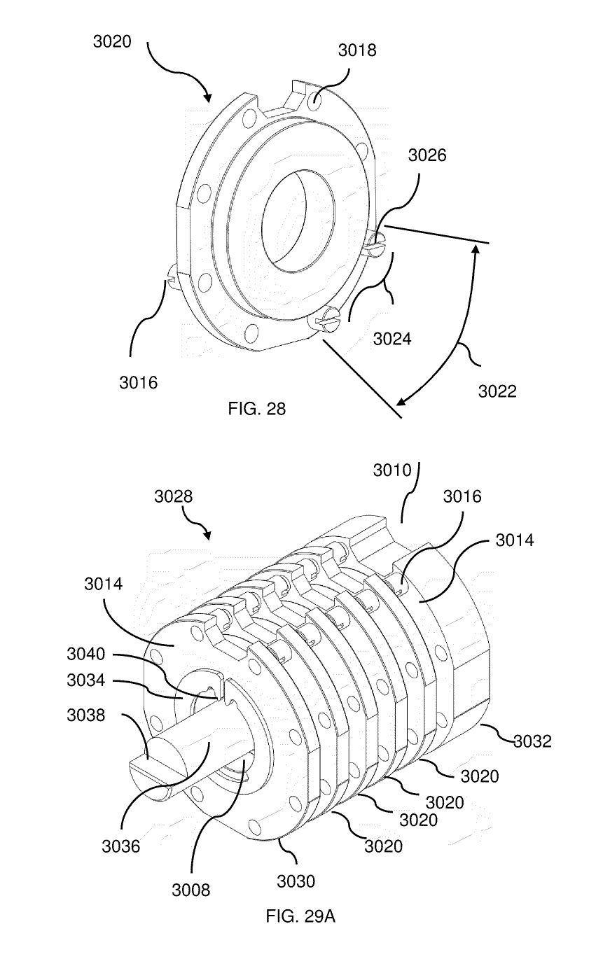

An aspect of the present invention is shown in FIG. 28. This aspect greatly expands the number of permutations by using a simple wheel assembly 3020 variably configurable by changing the arc width 3022 of the cam 3016 by adding a second cam 3016 to form a double cam arrangement 3024. Using cams with varying diameters could also be used to create variability, the cams shown in FIG. 28 are threaded and fastened into the tapped holes 3018. A screw driver slot 3026 is provided to engage a screwdriver for assembly and disassembly of the cams. The cams could have something other than a screwdriver slot to engage an assembly tool. In addition to varying the angular position of the cam relative to the gate the cam width 3022 is also variable.

This added variable may also change the normal dialing procedure; the rotation of the drive wheel may be less than the full turn described earlier. This adds another variable and increases the level of complexity for the human operator.

The locations of the cams 3016 may also have irregular spacing. For example the 8 tapped holes 3018 in FIG. 28 are shown with the holes uniformly spaced at 45 degrees but they could also be spaced at 20°, 60°, 40°, 45°, 53°, 32°, 47° and 63° or some other configuration totaling 360°. This would render well known manual manipulation algorithms for surreptitious opening unsuitable.

A systematic nomenclature could be used to describe the configuration. One example to describe the wheel assembly 3020 in FIG. 28 is: [3-4]:{0-6}, where the square brackets indicate side A 3012 and curved brackets indicate Side B 3014. The numbers inside the bracket are the cam positions. The wheel assembly 3020 in FIG. 28 has two cam screws 3016 on side A 3012; one at position 3 and one at position 4 and one cam on side B at position 7. Using the same nomenclature system the wheel assembly in FIG. 27 may be described as [1-0]:{0-8}.

FIG. 29A shows a wheel pack 3028 comprised of a first wheel assembly 3030, four wheel assemblies 3020 and a drive wheel 3032. The first wheel 3030 is configured as [1-0]:{NA}, NA indicates that there is no cam on its side B 3014, the driving surface, because the wheel does not drive another wheel. The four middle wheels are configured as shown in FIG. 28, [1-0]:{0-8}. The Drive wheel 3032 has one cam 3016 on side B 3014, the driving surface, located at position 8. This configuration of the drive wheel is designated [NA]:{0-8}, where NA indicates no cam 3016 on side A 3012, the driven surface. There is no cam on side A 3012 because it is not driven by another wheel. Using consistent nomenclature the wheel pack 3028 in FIG. 29A is described as: [1-0]:{NA}, [1-0]:{0-8}, [1-0]:{0-8}, [1-0]:{0-8}, [1-0]:{0-8}, [NA]:{0-8}.

The wheel pack 3028 depicts the gates 3010 of all six wheels in alignment. The drive wheel assembly includes a drive shaft 3036 which includes a D step 3038 to engage a driving shaft which is not shown but assumed in FIG. 29A. The drive wheel drive shaft 3036 is concentric with the drive wheel diameter. The aperture 3008 of each wheel is concentric with the drive shaft 3036 via the spindle. Also not shown in FIG. 29A but assumed is a spindle that the wheel apertures 3008 revolve upon. These items will be discussed later.

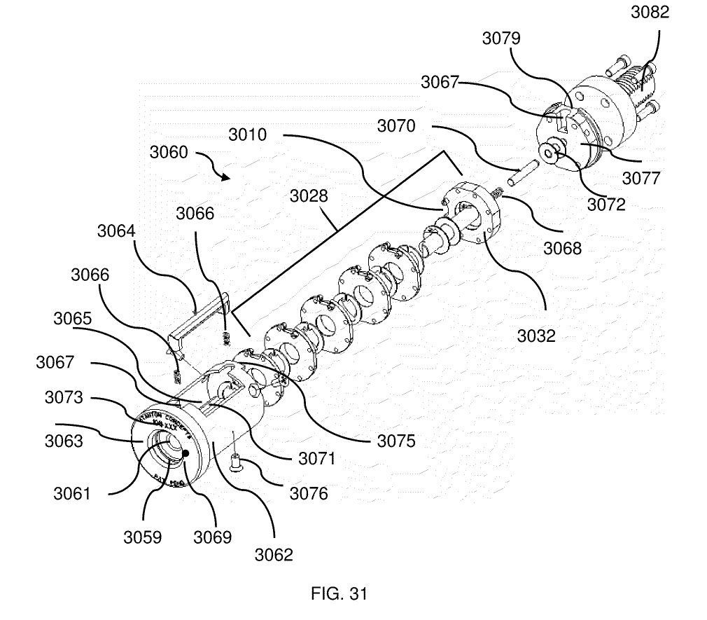

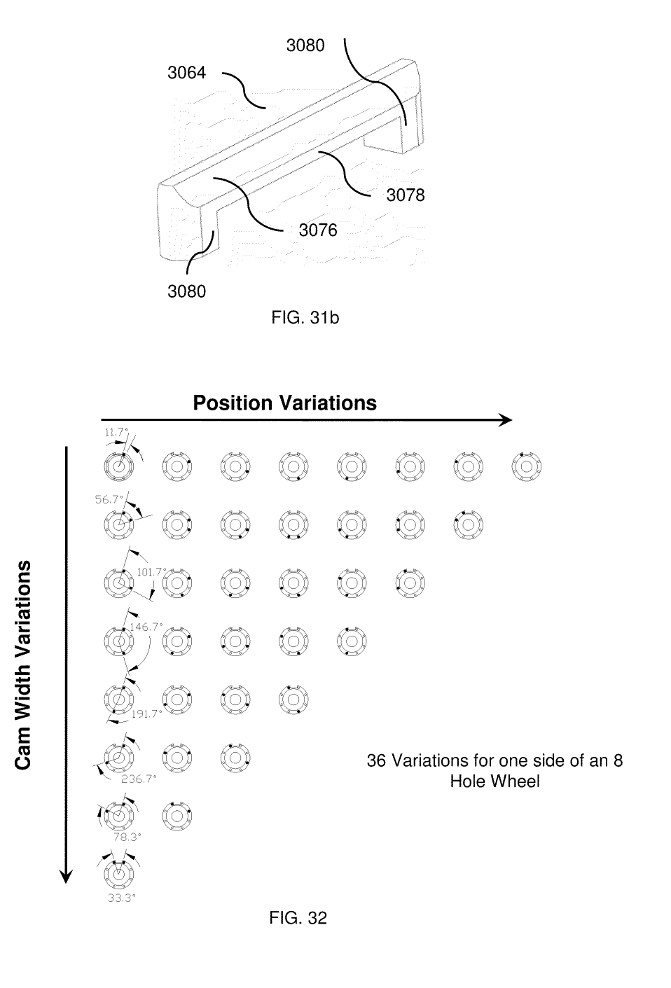

The wheel pack 3028 may be part of an assembled lock. Such an assembled lock has additional components that enable the assembled lock to be operated for locking and unlocking. An exploded view of an assembled lock is shown in FIG. 31. The wheel pack 3028 may be concentric with a cylinder body 3062, a lock body 3062 may be concentric with the shell 3124. The wheel pack 3028 is able to turn freely and independent of the cylinder body 3062. When the side-bar 3064 is not engaged in the aligned gates 3010 the cylinder body 3062 cannot rotate freely and independently of the shell 3124 because the side-bar is a blocking element. When the gates 3010 are aligned, the cylinder body 3062 and wheel pack are rotated concurrently the side-bar 3064 cams off the cam groove 3126 in the shell 3124 and moves inward entering the gates 3010. The side-bar 3064 is able to move inward a sufficient distance to clear the cam groove 3126 on the shell 3124. The cylinder body 3062, side-bar 3064, and wheel pack 3028 move as a single body relative to the shell 3124. The lock is in an unlocked and unlatched state. The cylinder body 3062 is unlocked when the side-bar 3064 enters the aligned gates 3010, the cylinder body 3062 is rotated concurrently with the wheel pack 3028 and sidebar, and the lock is moved into an unlatched position or state.

To prevent inadvertent rotational coupling between the wheels there is an anti-rotation shim 3034 between each wheel assembly, as is shown in for instance FIG. 29A. The anti-rotation shim 3034 has a tab 3040 that engages a groove on the spindle 3065 (not shown but assumed in FIG. 29A and shown in FIG. 31) to prevent rotation of the shim 3034 which prevents unintended wheel to wheel rotational coupling. The anti-rotational shim 3034 can be a material with a low coefficient of friction and good wear resistance properties such as phosphor bronze to act as a thrust bearing.

The wheel pack assembly 3028 may be free turning relative to the cylinder body when to side-bar 3074 is not engaged in the wheel gates.

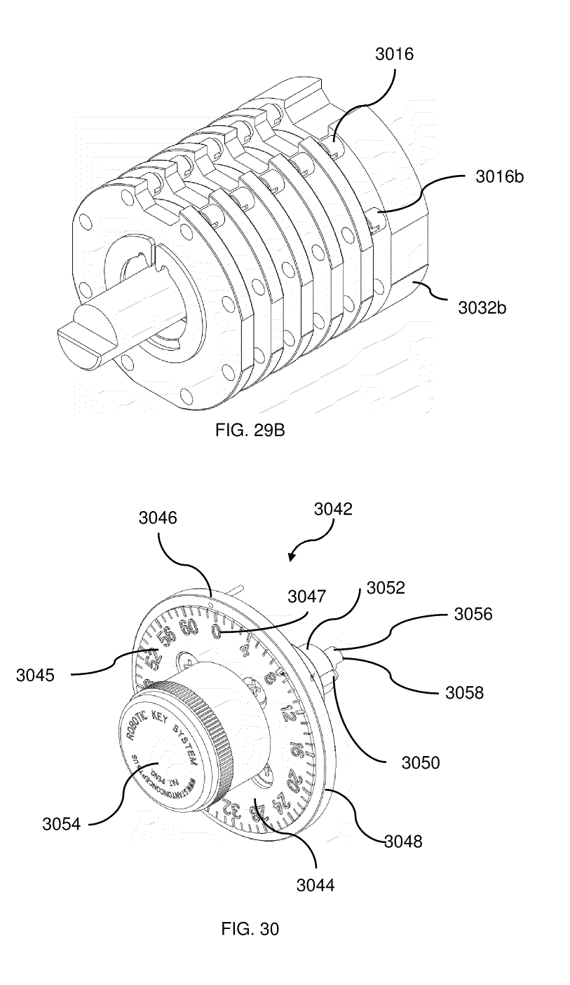

The wheel pack as shown in FIG. 29A and the lock as shown in FIG. 31 are part of what may be called a Robotic Key System (RKS). All or part of the lock of FIG. 31 may be called an RKS cylinder. FIG. 30 depicts a manual dialer 3042, designed to engage a RKS cylinder and manipulate the wheel pack 3028 manually. The manual dialer 3042 has a body 3048 with a “zero” mark 3046 at 12 o'clock on the body, an index 3044 with index markings 3045 including a “zero” marking 3047 on the index 3044, a finger knob 3054, and a drive shaft 3056. The manual dialer 3042 can be used to dial and observe and record the opening combination for a lock.

The index 3044 shown in FIG. 30 has a graduation of 64 integers, it is anticipated that the index 3044 could be graduated with 100, 50 or some other number of graduations. A vernier scale could also be used to facilitate a more precise reading.

Depending on the GFD of the lock in FIG. 29A a graduation of 64 integers my not provide the necessary resolution. If a greater resolution is required real numbers could be recorded while observing the alignment. For example if an alignment falls between 32 and 33 on the dial 32.5 could be recorded.

To operate the manual dialer 3042; the registration pin 3050 on the manual dialer shank 3052 is aligned with the registration groove 3069 on the socket 3059 on the face 3063 of the lock cylinder body 3062. When the shank 3052 and registration pin 3050 on the manual dialer 3042 and the registration groove 3069 and socket 3059 on the cylinder are engaged and seated the two assemblies are uniquely registered. The manual dialer body 3048 and the lock cylinder body 3062 are rotationally coupled together. After the manual dialer shank 3052 is fully seated with the lock cylinder body 3062 the user turns the drive shaft 3056 by turning the knob 3054 which is fixed to the index 3044 and the drive shaft 3056. The index subassembly is free turning relative to the manual dialer body 3048. The drive shaft 3056 is concentric with the shank diameter. The driveshaft has a D step 3058 configured to uniquely engage with a D step 3038 on the drive shaft 3036 of the drive wheel assembly 3032, see for instance FIG. 29A.

Using the manual dialer 3042 while observing the alignment of all the gates in the wheel pack in FIG. 29A yields an opening combination of: >>>>>>49, <<<<<25, >>>28, <<<12, >8, <0. Herein “>” indicates passing the zero index mark 3047 the zero reference mark 3046 on the manual dialer body 3048 in the clockwise direction, “<” indicates passing the zero index mark 3047 the zero reference mark 3046 in the counter clockwise direction. “<0” indicates stopping at the zero position. The combination can be stored electronically to be used by a robotic or motorized dialer.

The zero mark 3046 on the manual dialer body 3048 may be demarcated by a feature such as a hole or countersink, silk screened or painted. It may also be a fluorescent light pipe similar to those commonly used gun and crossbow sites.

FIG. 29B shows the wheel pack of FIG. 29A with added a second cam 3016b to the drive wheel 3032b at position 7 changes the combination to: >>>>>>58, <<<<25, >>>37, <<<12, >16, <0 for this wheel pack 3028b configuration. It is important to note that to align the second wheel; the index passes the zero reference 3046 four times versus five times for the wheel pack 3028 configuration in FIG. 6. This changes the alignment procedure discussed earlier. It creates added complexity for the user manually dialing the combination. Not only does the user need to keep track of the stop points he also needs to keep track of the number of times the index passes zero between stopping points.

It is anticipated that the alignment could be learned by observation with a video system or by using angular position sensors (inclinometers, accelerometers) common in hand held computing devices such as Apple® 's iPhone™ and iTouch™. The iPhone™ could be affixed to the knob 3054, when dialing the angular positions are monitored and recorded by the iPhone™ or like device.

The combination could also be derived mathematically if the cam dimensions and positions and number of wheels are known.

Shown in FIG. 31 is the exploded view of a RKS cylinder core 3060. The RKS cylinder core 3060 is comprised of a wheel pack 3028, core body 3062, a side-bar 3064, two side-bar springs 3066, a pressure spring 3068, bearing pin 3070, thrust washers 3072, end cap 3074 and screws 3083 to fasten the end cap 3074 to the core body 3062.

The core body 3062 is circular, has a face 3063 a socket 3059, a registration notch 3069, a bore 3061 which is concentric to the body, a spindle 3065 which is concentric to the bore 3061, a spindle groove 3071, a radial side bar channel 3073 and an alignment tab 3075.

FIG. 31b is an isometric view of the side-bar 3064. The side-bar has a beveled surface 3076, a fence section 3078, and two slider sections 3080 one on each end.

The end cap 3074 has a radial side bar channel 3067, a thrust surface 3077 and a notch 3079 to receive alignment tab 3075 to assure the side-bar channels 3067 for the core body 3062 and the end cap 3074 are in angular alignment. In the embodiment of the RKS cylinder core shown in FIG. 31 the end cap 3074 is secured to the body 3062 with screws 3076, it is anticipated the body 3062 and the end cap 3074 could be press fit, soldered, or fixed with adhesive. The assembly could be designed to be easily disassembled or designed to be not easily disassembled, or designed to leave evidence that it has been disassembled.

The wheel pack 3028 shown in FIG. 31 is in a non-aligned state. The gate 3010 on drive wheel 3032 is 90° counter clockwise out of alignment with the side-bar 3064. The cylinder core embodiment in FIG. 31 depicts the angular relationship of the registration notch 3039 and the side-bar 3064 to be 90° deg. The side-bar 3064 is at 12 o'clock and the registration notch is at a 3 o'clock position. It is anticipated that this angular relationship could variable or randomized during the manufacturing process. For example the registration notch could remain at a 3 o'clock position, the side-bar channel 3067 could be at any angle. In this embodiment the side-bar channel 3067 on the end cap 3077 would have to correspond. Having a variable side-bar position adds additional variability to the lock mechanism. A common forced attack on a key cylinder with side-bar is to drill out the side-bar. Key cylinder locks have the side bar in a fixed position relative to the key way. However, a fixed position is not required for a RKS cylinder. Someone attempting to drill out the side-bar in a RKS cylinder would first need to know where the side-bar is. Positioning a side-bar in a RKS lock in a different position for each lock in accordance with an aspect of the present invention, makes the drill-out attack less effective. In a further embodiment, one may create a side-bar that is not fixed parallel to the spindle. In a further embodiment one may apply a side-bar that engages non-aligned gates, and thus an unlocking state of the lock is wherein gates are specifically not aligned.

The tail piece 3082 shown in FIG. 31 is removable to allow the attachment of other tail embodiments to the cylinder core 3060. The threaded stud depicted is commonly used for “Cam Cylinders”. A Cam Cylinder is a term commonly used in the lock trade to describe a lock that has an attached cam that serves as the locks bolt. Cam locks are commonly used for cabinets, filing cabinets, and drawers. The RKS cylinder can be used wherever keyed cylinders are used; padlocks, builder's hardware, switch locks etc. The RKS cylinder can also be used where ever combination locks are used; including but not limited to safes, vaults, padlocks etc.

FIG. 32 shows an array with possible cam configurations for one side of a wheel with 8 tapped holes 3018. The cam 3016 depicted in FIG. 32 has a head diameter of 0.042″ and is located on a 0.40″ diameter bolt circle. The arc width of a single cam at a radial distance 0.2″ from the center of the wheel is 11.7°. The array in FIG. 32 illustrates how a simple wheel with 8 tapped holes has 8 variations on one side for a single cam with a fixed diameter. The number of variation for a single side grows to 36 for a side by adding a second cam screw to vary the cam width and the cam location.

The number of variations (V) for a wheel with N holes is determined by the following series: V=1+2+3 . . . +N. The following TABLE 3 below shows the results for wheels with different number of holes.

TABLE 3

| # Tapped Holes | Variations |
|---|---|
| 8 | 36 |
| 16 | 136 |
| 20 | 210 |
| 24 | 300 |
| 32 | 528 |

TABLE 4 shows the total number of combinations for locks with 3 and 4 wheels incorporating with increasing numbers of variations:

TABLE 4

| # Variations | # Wheels | # Combinations (nominal)* |
|---|---|---|
| 67 | 3 | 300 × 10³ |
| 67 | 4 | 20 × 10⁶ |
| 136 | 3 | 2.5 × 10⁶ |
| 136 | 4 | 340 × 10⁶ |
| 210 | 3 | 9 × 10⁶ |
| 210 | 4 | 2 × 10⁹ |
| 300 | 3 | 27 × 10⁶ |
| 300 | 4 | 8 × 10⁹ |

High end combination locks with 67 distinct positions and 4 wheels have nominally 20×10⁶ combinations.

UL® (Underwriters Laboratories) “Group 1” combination locks for safes and vaults with 67 variations and 4 wheels are believed currently to be the best available and priced on the order of $1000 per unit. A RKS cylinder as disclosed herein with 6 wheels (8 tapped holes ea.) currently may cost on the order of $100 in a one-off manufactured process. However, this price of the RKS cylinder could easily drop to on the order of $10 due the simplicity of the design. The RKS cylinder as disclosed herein and that is manufactured has 100× the number of combinations at 1/10 the price of the best conventional combinations locks on the market.

FIG. 32 shows an array with possible cam configurations for one side of a wheel with 8 tapped holes 3018. The cam 3016 depicted in FIG. 32 has a head diameter of 0.042″ and is located on a 0.40″ diameter bolt circle. The arc width of a single cam at a radial distance 0.2″ from the center of the wheel is 11.7°. The array in FIG. 32 illustrates how a simple wheel with 8 tapped holes has 8 variations on one side for a single cam with a fixed diameter. The number of variation for a single side grows to 36 for a side by adding a second cam screw to vary the cam width and the cam location.

TABLE 5 shows the total number of combinations for locks with 3 and 4 wheels incorporating with increasing numbers of variations:

TABLE 5

| # Variations | # Wheels | # Combinations (nominal)* |
|---|---|---|
| 67 | 3 | 300 × 10³ |
| 67 | 4 | 20 × 10⁶ |
| 136 | 3 | 2.5 × 10⁶ |
| 136 | 4 | 340 × 10⁶ |
| 210 | 3 | 9 × 10⁶ |
| 210 | 4 | 2 × 10⁹ |
| 300 | 3 | 27 × 10⁶ |
| 300 | 4 | 8 × 10⁹ |

High end combination locks with 67 distinct positions and 4 wheels have nominally 20×10⁶ combinations.

TABLE 6 shows the total number of combinations for locks with 6 wheels, such as the RKS cylinder:

TABLE 6

| | | | # Combinations |
|---|---|---|---|
| # Tapped Holes | # Variations | # Wheels | (nominal)* |
| 8 | 36 | 6 | 2 × 10⁹ |
| 12 | 78 | 6 | 225 × 10⁹ |
| 16 | 136 | 6 | 6 × 10¹² |
| 20 | 210 | 6 | 85 × 10¹² |
| 24 | 300 | 6 | 730 × 10¹² |
| 32 | 538 | 6 | 24 × 10¹⁵ |

A RKS cylinder with six wheels and eight tapped holes has about one order of magnitude increase of combinations over the prior art. When the number of holes is increased to 32 the RKS cylinder has about 10⁹ times more combinations than the prior art, 20×10⁶ versus 24×10¹⁵ for the RKS. This very large number clearly renders a brute force attack no longer viable.

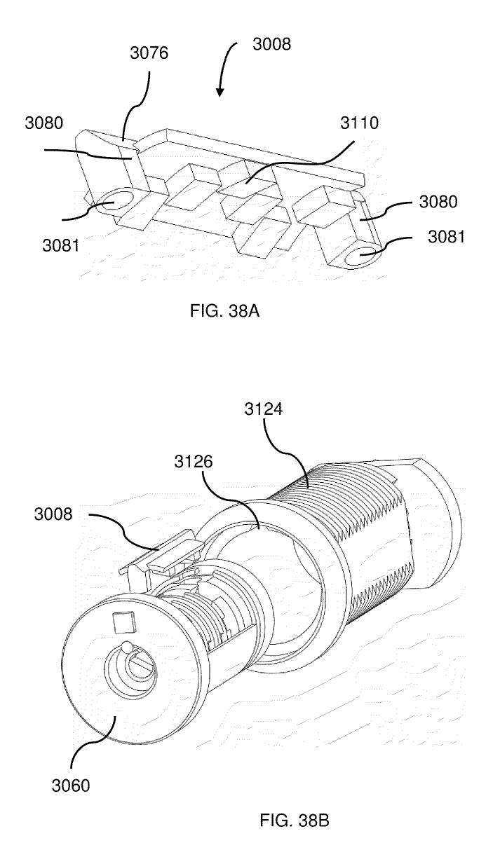

In TABLE 6, the number of Combinations are presented as rounded numbers. Cams on facing sides of adjacent wheels cannot be (usually are not) located in the same position. For example if the first wheel had a cam at position 1 on side A 3012, [1-0] the adjacent wheel, the second wheel, cannot be configured {1-0}. However, this configuration would be possible with a non-linear side bar (see for instance FIG. 38A). Having the cams 3016 at the same location would prevent the gates from full alignment. For instance, the wheel 3006 depicted in FIG. 27 is not thick enough to have a cam 3016 in the same position one side A 3012 and side B 3014 of the same wheel. In a further embodiment of the present invention the wheel is made of a thickness that accommodates an arrangement for two cams being located in the same position at opposite sides of a wheel. In yet a further embodiment of the present invention the cam screws 3016 are made smaller to accommodate an arrangement for two cams being located in the same position at opposite sides of a wheel.

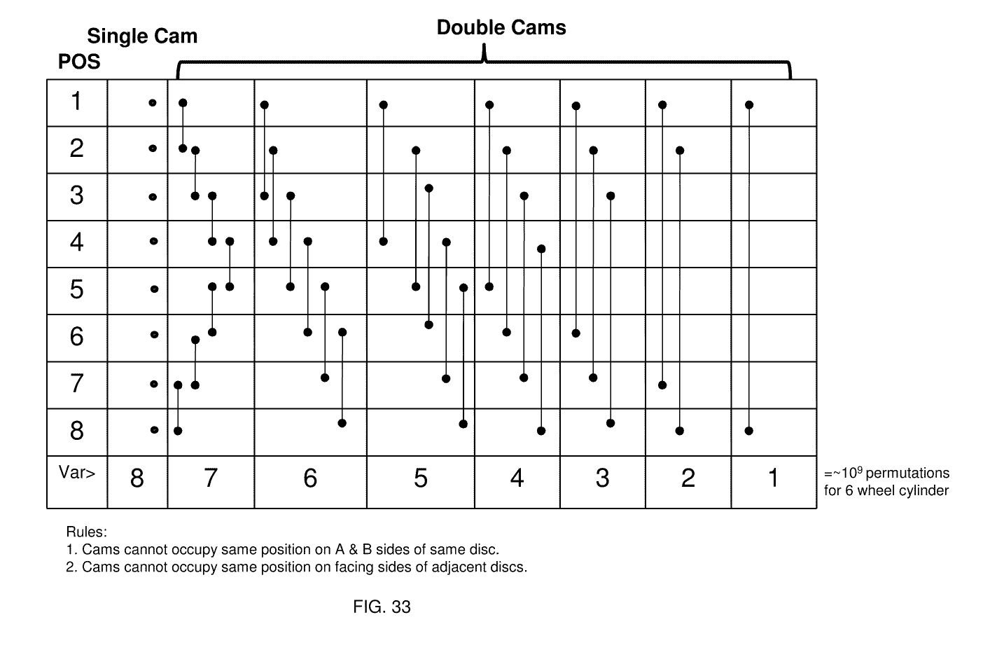

FIG. 33 is another graphical representation illustrating the number of possible cam variation on a single side of a wheel.

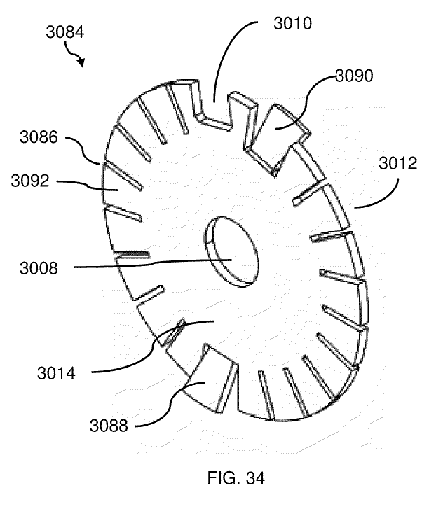

FIG. 34 shows another embodiment of the invention. FIG. 34 shows a wheel 3084 with twenty radial slits 3086 along the circumference of the wheel 3084. The space between two slits is occupied by tabs 3092. In a further embodiment wheel 3084 is fabricated from a suitably ductile material to allow bending a tab in a slight angle. In yet a further embodiment the tabs can be bent back for re-configuration. The wheel has a gate 3010, an aperture 3008, a driving side B 3014 and a driven side A 3012. With this embodiment the driving cam 3088 and the driven cam 3090 are formed by bending the tabs. FIG. 34 shows single cams on each side of the wheel 3084 but in a further embodiment double cams can be formed. It is also contemplated that there can be a greater or fewer number of tabs than the quantity depicted in FIG. 34. One advantage of this embodiment is that the lock cylinder could be re-combinated without disassembling the cylinder core and wheel pack.

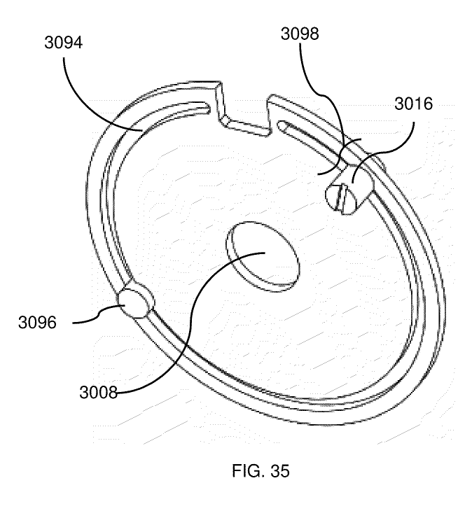

FIG. 35 shows yet another embodiment of the invention where instead of the cams being in fixed distinct locations, the position and width are continuously variable along the curved slot 3094. The curved slot 3094 on the wheel 3093 in this embodiment does not go a full 360° around the aperture, because doing so would cause the wheel to separate into to piece. In a further embodiment the curved slot can be a full 360°, and the cam assemblies 3098 is designed to keep the two parts of the wheel together. One cam 3016 is shown on each side of the wheel but it is anticipated that double cams can be used on one or both sides. The cam 3016 in FIG. 35 is comprised of a cam screw 3016 and a cam screw nut 3096 on the opposite side. When the cam screw and the cam screw nut 3096 are fastened securely together the cam assembly 3098 is secured in position. The cam 3016 in FIG. 35 can be moved by loosening the cam screw and sliding the cam assembly 3098 angularly along the curved slot 3094. FIG. 35 depicts a cam screw 3016 with a fixed head diameter of 0.045″, it is contemplated that cam screws may have variety of head diameters for an additional order of variability. One advantage of this embodiment is that the lock cylinder can be re-combinated without disassembling the cylinder core and wheel pack.

In certain applications one time use of a lock is preferable from a security point of view. One time use seals are commonly used for transporting goods including use on the barn doors of intermodal containers. One time use seals have a unique serial number which is recorded when the seal is attached to the container door. If an authority such as a customs agent needs to inspect the container the seal number is recorded and the seal is cut. After inspecting the container the agent closes the doors and attaches another one time use seal with a unique serial number. When the container arrives at its final destination, the receiver can review the audit trail and reconcile any discrepancies with the serial numbers. The seals are only intended to provide evidence of tampering or destruction, both legitimate and illegitimate. The seals are not intended to provide a barrier to entry like a hardened padlock might provide. Although some seals with metal components are referred to as “barrier seals”, they are designed to be cut off with bolt cutters or a similar tool. Keyed locks are rarely used for transporting cargo including intermodal transportation because of three primary issues; key control, cost and lack of audit trail.

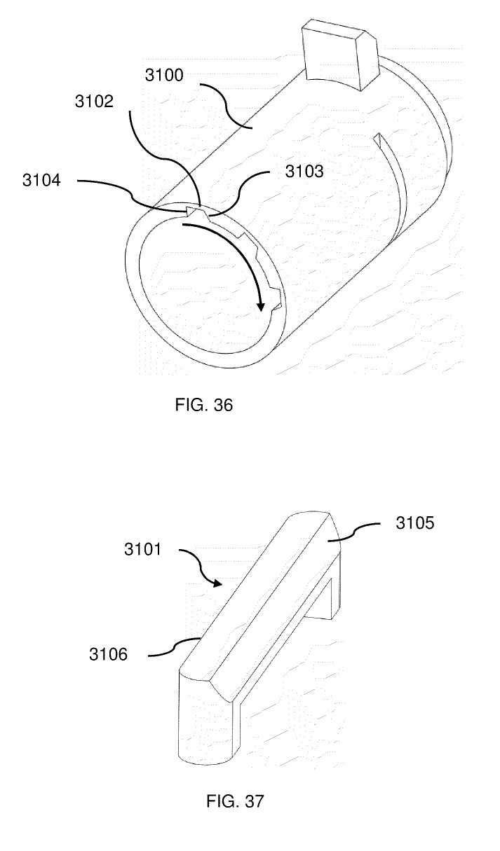

FIG. 36 depicts a shell 3100 designed for one time use lock cylinder. The lock is used once and then removed from the system. The lock could be destroyed or sent back to the factory for re-cycling. FIG. 36 depicts a shell 3100 where the side-bar channels 3102 have a bevel on one side and a straight wall 3104 on the other. FIG. 37 depicts a corresponding side-bar 3101 with a beveled surface 3105 on one side and a straight wall 3106. When both the shell 3100 and the side-bar 3101 are used in a cylinder assembly a ratcheting action in created, allowing the cylinder core to only move in the clockwise direction. A stop could be provided to prevent the cylinder core from rotating a full 360°. It is also anticipated that the ratchet action could be in the counter-clockwise direction.

It is anticipated that frangible elements in the lock cylinder could be used. The frangible elements could break during the un-latching operation to provide evidence and to prevent re-latching and re-use of the cylinder.

Further advantages will be explained with the introduction of the Robotic Dialer later herein.

To re-combinate the wheel pack 3028 depicted in FIG. 31 the cylinder would need to be disassembled. The extent of disassembly depends on how many and which wheels are to be changed. An important aspect of this invention provides another, simpler method to re-combinate the lock and to further increase the number of permutations. Fences used in existing combination locks are linear. When the gates of the wheel pack are aligned in a straight line the fence is able to drop into the space created and the latch, bolt or other mechanism is free to move to an un-locked state. There are key cylinders that employ a side-bar mechanism, Medeco® and Abloy® for example. These side-bar key mechanisms are similar to the combination lock fence mechanism described in that the side-bar is linear. Certain components in the key cylinder must be in alignment for the side-bar to drop in or be able to be pushed in. The invention described here includes side-bar with non-linear fence segments.

FIG. 38A shows the inward side of a side bar 3108 with non-linear side-bar segments. The segments 3110 have a linear pitch to coincide with the linear position of each wheel of a wheel pack. The segments are angularly spaced at −15°, 0° and 15°, in this example but could spaced at a different angles or be non-regularly spaced. A side-bar 3108 with three possible angular positions and six linear positions yields 3⁶, 729, variations. The example in the first row of TABLE 6 would expand its number of nominal combinations from 2×10⁹ to (2×10⁹)×729, (1.5×10¹²).with the use of the side-bar with 729 possible variations. The angular width 3114 is determined by the desired GFD.

The side-bar 3108 in FIG. 38A could be metallic, non-metallic, polymer, glass or ceramic. It could be machined, cast, or molded. At sufficient volumes the cost of the side-bar 3108 could be low; however the cost and inconvenience of fabricating and inventorying 729 different variations might be undesirable.

The side-bar could be replaced when the cylinder core is removed from the shell.

FIG. 38B shows an exploded view of a cylinder core assembly 3060, a shell 3124 with a beveled side-bar channel 3126 and a side bar with non-linear fence segments 3108.

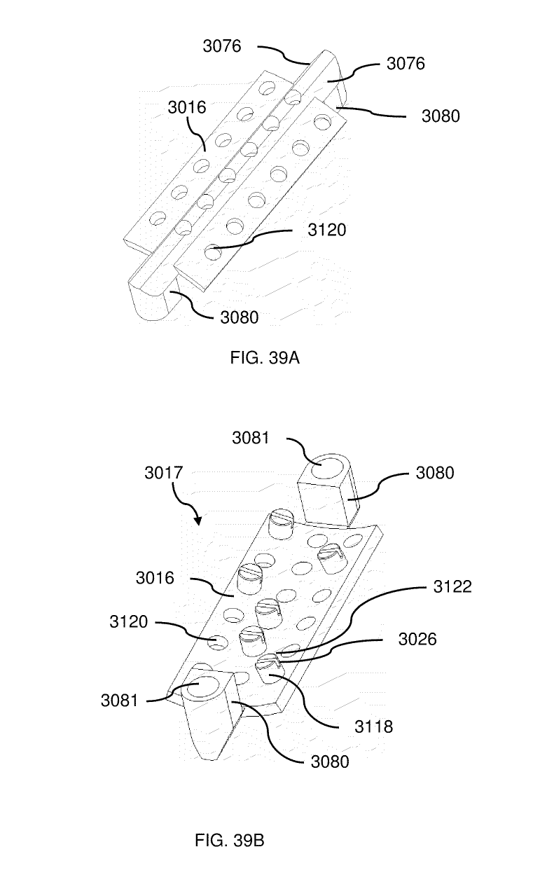

FIG. 39A shows a re-configurable side-bar 3116; it has a bevel 3076 on each side, a slider sections 3080 and spring cavities 3081 on each end. These features enable it to behave and interact with the cylinder core and shell in the same way described earlier. The side-bar 3116 has an angular pattern of 3 holes at −15°, 0° and 15°. There are six angular patterns linearly positioned to coincide with a “six wheel” wheel pack. Each hole 3120 is tapped with a suitable thread to mate with a threaded fence post 3118. Like the cam screw 3016 in the wheel assembly 3020 in FIG. 27, the fence post is removable and reconfigurable.

The fence post has a head 3122 with screw driver slot 3026 and a threaded portion, not shown but assumed, to mate and thread in the tapped holes 3120. The fence posts may be soldered, press-fit, welded, glued or may be similarly attached to the side bar.

The hole pattern in FIG. 39A is regular, but the holes could be irregularly spaced. The pattern in FIG. 39A yields 3⁶, or 729, variations. A five angle by six row pattern would yield 5⁶, or 15625, variations. The example in the first row of TABLE 6 would expand its number of nominal combinations from 2×10⁹ to (2×10⁹)×56, (31×10¹²) with the use of the side-bar with 15625 possible variations. The head diameter is equivalent to a fence width which is determined by the desired GFD. FIG. 39B is an inclined bottom view of a variable side-bar with fence segments installed.

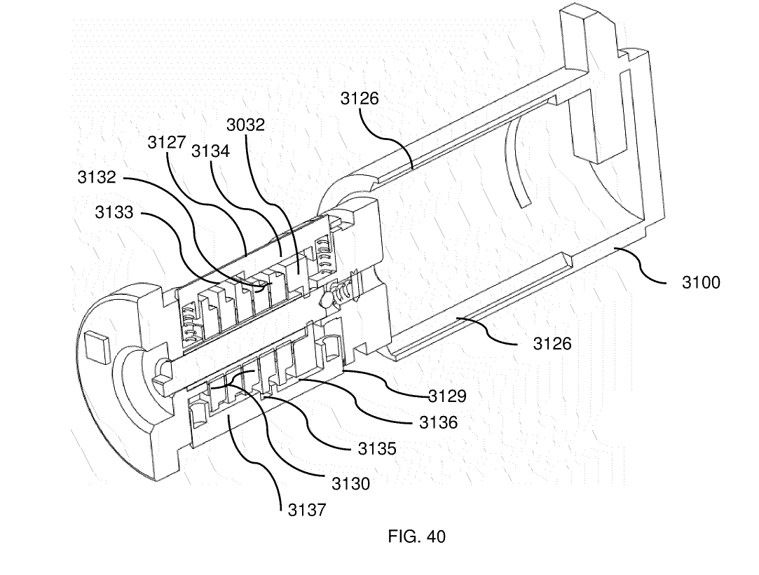

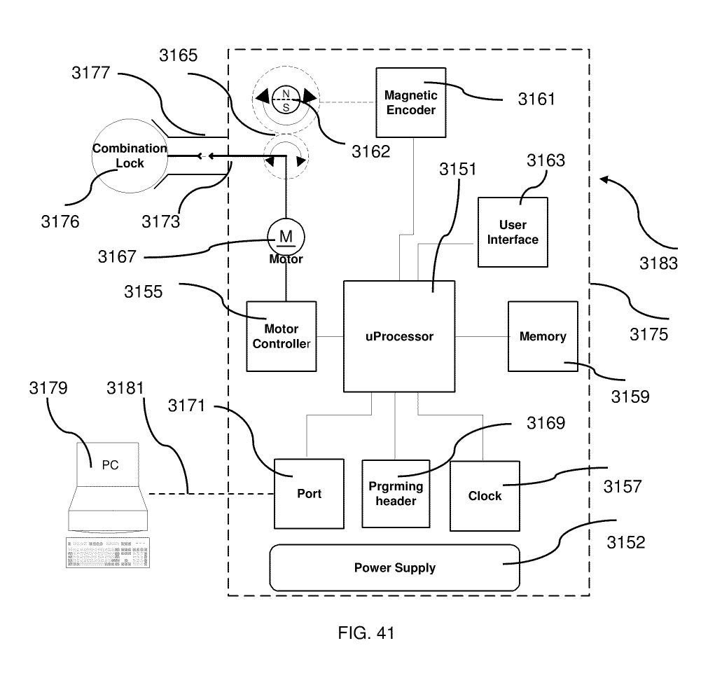

FIG. 40 shows another aspect of the invention. It is a partially exploded half section of a cylinder core 3128 and shell 3100. In this embodiment there are 2 side-bars, an upper side-bar 3127 and a lower side-bar 3129, that are “keyed” differently. The embodiment shows that shows that wheels 1, 2 and 3 all indicated by 3130 are aligned with their gates at the 6 o'clock position. Wheels 4 and 5 indicated as 3132 and the drive wheel 3032 are aligned with their gates at the 12 o'clock position. The cylinder core 3128 is shown with the side-bar springs compressed, the side-bar is pushed into the gates; the cylinder is in an unlocked state. This state is shown for illustrative purposes, for the side-bars to be pushed into the gates the cylinder core 3128 would need to be rotated relative to the shell 3100 for the upper side-bar 3127 and lower side-bar 3129 to cam off the corresponding side-bar channels 3126 on the shell 3100. The springs for the lower side-bar 3129 are not shown for clarity.

The upper side-bar 3127 has a clearance notch 3133 to clear wheels 1, 2 and 3 indicated as 3130 regardless of their gate alignment. The upper-side bar 3127 has a fence section 3134 than is only ready to enter the gates when the gates of wheels 4 and 5 3132 and the drive wheel 3032 are in alignment with each other and the upper side-bar 3127.

In this embodiment, for the lock to be in a fully unlocked state; the upper side-bar 3127 and the gates of wheels 4, and 5 indicated as 3132 and the drive wheel 3032 need to be in alignment, the 12 o'clock position in this embodiment AND (Boolean operator) the lower side-bar 3129 and the gates of wheels 1, 2, and 3 indicated as 3129 need to be in alignment, the 6 o'clock position in this embodiment.

The lower side-bar 3129 has clearance notch 3135 for wheel 4 and a clearance notch 3136 for wheel 5 and the drive wheel 3032. The lower side-bar 3129 has a fence section 3137 that is only ready to enter the gates when the gates of wheels 1, 2, and 3 indicated as 3130 are in alignment with each other and the fence section 3137 of the lower side-bar 3129, the o'clock position in this embodiment.

In one embodiment the side bars may have different fence segment patterns to change the combination. In a further embodiment the side bars may be reconfigurable in an arrangement similar to 3017. The embodiment in FIG. 40 shows two side bars; one at 12 o'clock and one a 6 o'clock but in a further embodiment that they may be angularly spaced at something other than 180 degrees. In yet a further embodiment there may be more than 2 side bars with different keying.

The side-bars may be removed and replaced when the cylinder core is removed from the shell.

The different embodiments described above hugely increase the number of possible combinations over the prior art. The huge increase has advantages for sequential dialing attacks.

A combination lock with a GFD of 7 represents the best of what is available for high security combination locks. GFDs of less than 7 become increasingly demanding and inconvenient for the human operator. Convenience versus security has traditionally been a tradeoff with security products. An important aspect of this invention greatly increases security without negatively affecting convenience. The lock mechanisms described above are specifically intended to be non-human friendly and inconvenient for the manual operator. The lock mechanisms described above are intended to be dialed by an electromechanical key or Robotic Dialer. However, if the intent and the design of the lock is to be opened by an electromechanical device and specifically not human friendly at least the following advantages can be realized:

a. The operator is unburdened by not having to know the combination;

b. The operator is unburdened by not having to see the dial;

c. The operator is unburdened by not having to manually manipulate the dial;

d. The combination code does not need to be user friendly of even possible for humans to read (i.e., alpha, alphanumeric, hexadecimal, real numbers, angles (degrees, gradients, radians) etc.);

e. Human dexterity is no longer a factor;

f. Orders of magnitude increase of the keyspace, which may be defined as the number of possible key combinations, is possible;

g. The number of wheels in a wheel pack is not limited to accommodate human manipulation;

h. Increased security because the operator does not know the combination;

i. No dial on the lock is required;

j. A record of activity can be stored in electronic memory; modern electronic; and

k. Biometric access control functions may be employed to authorize the electro-mechanical device.

The above list is not intended to be limiting as additional advantages are possible and are contemplated.

An electromechanical dialer may enable and take advantage of the very large number of combinations described by this invention. FIG. 41 is a functional block diagram of one embodiment of a robotic dialer system. It shows a μProcessor 3151, such as Microchip part number PIC16F9117TQFP, a power supply 3152, a motor controller 3155 such as Toshiba part numberTB6552FNG, a real time clock 3157 such as Dallas Semiconductor part number DS3231S, a memory device 3159 such as Microchip part number 24AA512-I/SM, a magnetic rotary position encoder 3161 such as Austria Micro Systems part number AS5030, a bi-polar disc magnet 3162, a rotary translation mechanism 3165, a motor, 3167, a programming header 3169, a bi-directional port 3171, a drive shaft 3173, a registration element 3175, a user interface 3163, a RKS combination lock 3177, a PC 3179, a bi-directional communication link 3181 and a functional boundary box 3175.

In addition to knowing the combination for a given lock the robotic dialer needs a means to know the angular position of the drive shaft relative to lock's drive disc, the RKS cylinder body and the dialer body. A simple and economic way to achieve this is to incorporate a rotary encoder in the dialer. One such encoder may use Hall elements incorporated into a chip to track the angular position of a magnet. An example of such a device is Austria Micro Systems model AS5030, which is a contactless magnetic rotary encoder for accurate angular measurement over a full turn of 360°. It is a system-on-chip, combining integrated Hall elements, analog front end and digital signal processing in a single device the absolute angle measurement provides instant indication of the magnet's angular position with a resolution of 8 bit =256 positions per revolution.

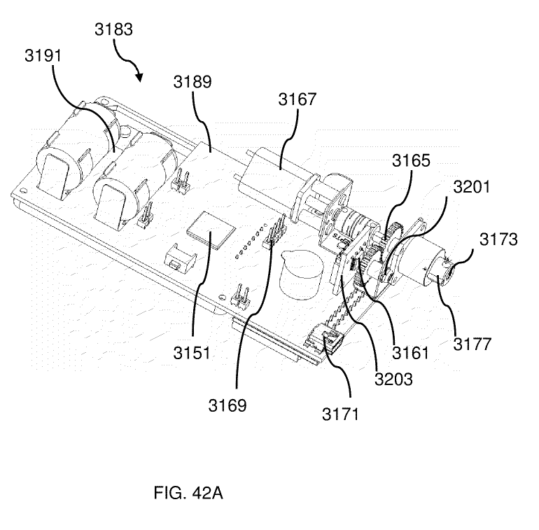

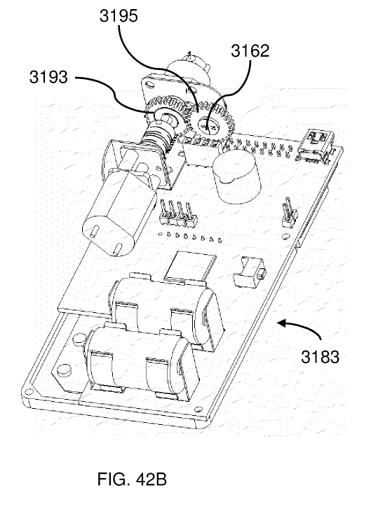

The AS5030 is well suited to enable one or more aspects of the invention provided herein. One embodiment of how the encoder is coupled to the dialer's drive shaft is shown in FIG. 42A. This configuration uses 2 spur gears with a ratio of 1:1, yielding a resolution of 256 positions per revolution. 256/360°=1.4°, the actual resolution may be slightly reduced by the backlash inherent in this type of gear arrangement. It is contemplated that other gear arrangements could be employed such as worm or miter gears. Anti backlash gears may also be employed. Belt drive arrangements may also be employed. In yet a further embodiment, a double shafted motor may be employed to the backshaft of the motor, eliminating the need for a separate translation mechanism. Higher resolutions may also be achieved by reducing the gear ratio. For example a 1:2 ratio would yield 0.7 degree resolution, 1:7 ratio would yield 0.2 degree of resolution.

The items inside the boundary box 3175 in FIG. 41 represent some of the primary components required for one embodiment of a standalone portable electromechanical combination lock dialer.

The lock 3176, the PC 3179 and the bi-directional communication link, 3181 are external items.

The programming header 3169 facilitates down loading firmware code to the μProcessor 3151. The memory device 3159 may be used to store dialer events. The clock 3157 provides date and time data for the dialer activities. The memory device 3159 may also be used to store lock combinations and user data. The user interface 3163 may include an LCD, switches, keypad, speaker, LEDs, biometrics and other similar devices. The motor controller 3155 controls the motor 3167. The motor control algorithm may be included in the downloaded firmware. The rotary translation mechanism 3165 couples the rotational output of the motor 3167 to the bi-polar disc magnet 3162. The rotary position magnetic encoder 3161 senses the angular position of the motor drive shaft to provide a position control loop with the μProcessor. The output drive shaft 3173 is uniquely coupled to the locks 3176 drive wheel, 3032 in FIG. 29A for example. The registration element 3177 uniquely engages with the cylinder core, 3060 in FIG. 31 for example.

When the dialer 3183 is coupled to the combination lock 3176 and after successfully dialing the correct combination via the drive shaft 3173 coupled to the drive wheel 3032 the wheel gates are aligned with a fence or side-bar. The lock can then be un-latched by rotating the dialer body, as the dialer body induces rotation to the cylinder core the side-bars are pushed, cammed, in to the gates and the lock can un-latch.

A record of the event may be recorded and stored in the memory device 3159. A PC, MAC, PDA or similar computing device can be connected to the communication port 3171 of the dialer to retrieve the activity data. It is anticipated that the communication link 3181 could a wired, wireless or infrared connection. Management software could be installed on the PC or like device to download passwords, access control and lock combinations to the dialer.

In a further embodiment appropriate devices and/or electronics are included to “machine” read the ID of the lock cylinder. This may be via RFID, Optical Character Recognition (OCR), memory button, microdots, motes, infra-red, or identifying the lock by knowing where it is located using GPS, cellular triangulation or other location determining means. Once the lock is identified the Dialer could lookup up the opening combination for that cylinder.

FIGS. 42A and 42B depict two views of a physical embodiment of a robotic dialer 3185. A cover to protect the circuits may be assumed but is removed for clarity. FIG. 42A is looking toward the front end of the dialer. It shows a mother board 3189, a μProcessor 3151, programming header 3169, a motor 3167, a rotary translation mechanism 3165, a rotary position encoder 3161, a drive shaft 3173, a registration element 3177, a communication port 3171 and batteries 3191.

FIG. 42B is a view of the dialer 3183 looking from the rear. The rotary encoder 3161 is removed for clarity. FIG. 42B shows a bi-polar disc magnet 3162. In this embodiment the rotary translation mechanism is comprised of a two gear spur gears. One gear, the drive shaft gear 3193 is fixed to the drive shaft 3173. The second gear, the encoder gear 3195 is engaged with the drive shaft gear 3193 and spins upon an encoder gear post 3161. The disc magnet 3162 is fixed to the encoder gear 3195.

The embodiment in FIG. 42A depicts the drive shaft gear 3193 and the encoder gear 3195 having a gear ration of 1:1. The encoder gear 3195 rotates at the same rate as the drive shaft gear 3193 but in the opposite direction. In a further embodiment gears may be used to increase or decrease the ratio, depending on the desired position resolution of the encoder 3161. The two gears 3193 and 3195 used for the rotary translation mechanism 3165 in this embodiment are spur gears, it is anticipated that the mechanism could employ, miter gears, worm gears or the like. It is also anticipated that the spur gears could be anti-backlash gears.

The encoder 3161 and the encoder gear 3195 are parallel and co-axial. The encoder is shown as a connectorized daughter board 3203 in this embodiment. They are also normal to the mother board 3189 in this embodiment. Other gear arrangements may be used and are contemplated so the encoder is parallel to the mother board. The encoder 3161 may be mounted directly to the mother board 3189.

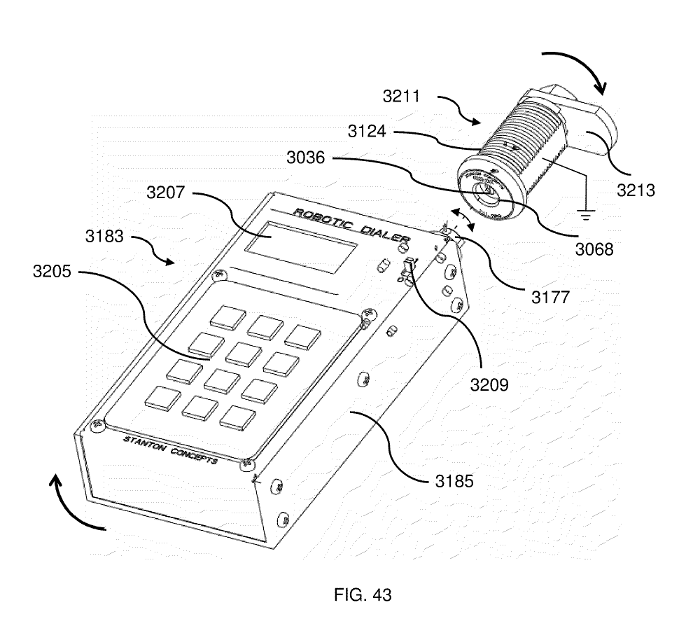

FIG. 43 depicts a robotic dialer 3183 and an RKS cylinder assembly 3211. The RKS cylinder assembly 3211 is decoupled from the dialer 3183 for clarity. The dialer 3183 has a cover 3187, a keypad 3205, a LCD display 3207 and an on/off switch 3209.

The RKS cylinder assembly has a shell 3204 and a cylinder core assembly 3060, an identifier 3073 and a cam latch 3213.

The keypad 3205 may be used to enter PIN (Personal ID Numbers), lock information, activation requests and other data. The LCD display 3207 may be used to display data and other textual or graphical data. The on/off switch 3209 turns the power off and on.

In one illustrative embodiment, to un-lock a specific lock the following process may be used:

The user enters a PIN number into the keypad, if the PIN is accepted the user is prompted for a lock ID, the user enters the lock ID into the keypad, if the ID is valid and the user is authorized to open that specific lock the μProcessor looks up the corresponding combination code for that lock and displays a message when ready; the user couples the registration element 3177 of the dialer 3183 with the socket 3059 on the face 3063 of the cylinder core assembly 3060, the drive shaft of the dialer 3173 is couple to the drive shaft 3036 of the drive wheel in the core assembly 3060; the user activates the dialer 3183, the μProcessor provides dialing instructions to the motor controller which controls the motor, the feedback loop enabled by the encoder lets the μProcessor continuously know the drive shaft position; the drive shafts rotates in the correct clockwise/counter clockwise sequence and is coupled to the drive wheel; the drive shafts rotate independently of the dialer body, the cylinder body and the cylinder shell; at the completion of a successful dialing the gates of the wheel pack with the cylinder assembly are aligned with the side-bar; to un-latch the cylinder assembly the tool body is rotated manually; the tool body and the cylinder core are rotationally fixed to each other; the lock shell is fixed to an outside reference such as a padlock body or door frame; as the tool body is rotated the cylinder core rotates coaxially with the shell, the shell is stationary; as the core rotates the side-bar(s) are pushed, cammed inward and enter the aligned gates; the cylinder core and the cam latch are fixed rotationally; as the core assembly rotates in unison with the wheel pack, the side-bar(s) and the cam latch; the cam latch is rotated to an un-latched state.

A record of the event may be recorded to memory on the dialer. In a further embodiment an accelerometer or other inclination sensor on the mother board may monitor and record the tool body rotation during un-latching and re-latching. The dialer may also be programmed to automatically scramble the wheel pack after re-latching. It may also be programmed to prompt the user to scramble the wheel pack.

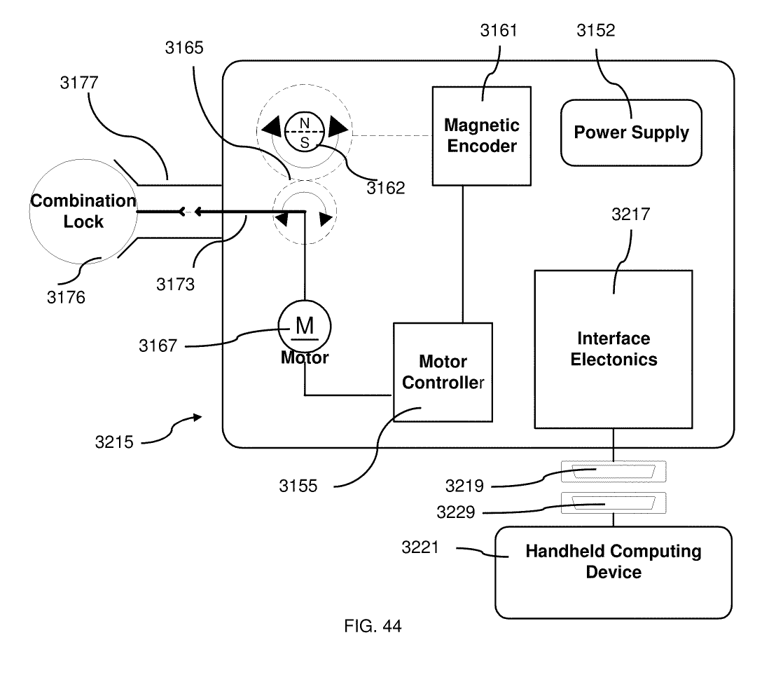

FIG. 44 provides a functional block diagram of an embodiment where the electro-mechanical functions are separate from the intelligence and management functions. The primary electromechanical functions include the registration element 3177 the motor 3167, the motor controller, 3155, a power supply 3152 interface electronics 3217 and a connector 3219.

The electromechanical functions may be housed in a package that includes a cradle to connect to a hand held computing device 3221 such as a mobile phone such as an Apple iPhone™.

The brains or controlling device of the dialer may be a commercially available hand held computing device i.e. iPhone™, that takes advantage of processing, human interface (touch screen and graphics) and possible input devices such optical, RFID, biometric, electronic, radio receiver, GPS, positional or any other input device that may receive a signal that can be processed in relation to opening a lock or efforts to open a lock.

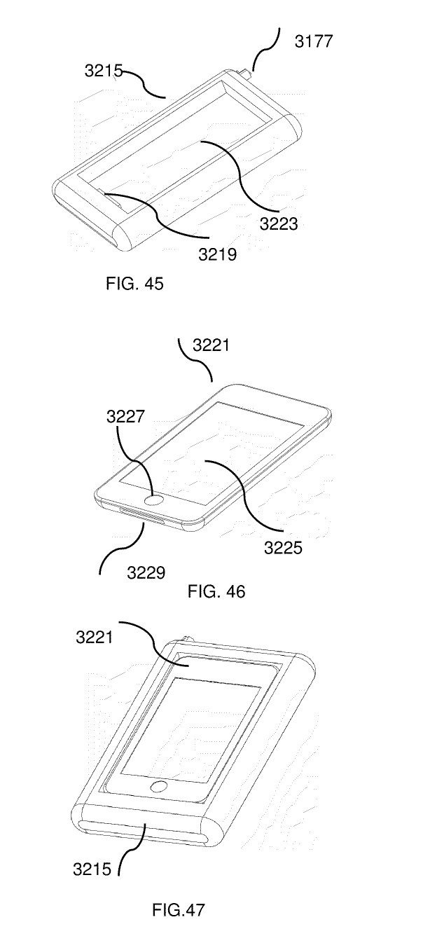

FIG. 45 shows a robotic dialer 3215 with a cradle 3223 to dock a hand held computing device. The cradle 3223 includes a connector 3219 to electrically connect the dialer and the hand held computing device. The dialer 3215 in FIG. 45 includes the mechanical apparatus 3177 to physically engage the lock cylinder.

FIG. 46 depicts a hand held computing device 3221. The hand held computing device includes a connector 3152, display 3225, and a tactile user interface 3227. The display 3225 may be a touch screen.

FIG. 47 depicts a hand held computing device 3221 docked into a robotic dialer 3215. Most people in the world have two items in their pocket (or purse); a cell phone and a set of keys. In one embodiment the two functions of cell phone and key, the key being a dialer for a combination lock are merged into a single device.

In a further embodiment the cradle 3223 may be replaced by an adapter that holds a dialer for opening a combination lock. The adapter connects to the mobile computing device. Such a connection may be a hard physical connection. It may also be a wireless connection. An adapter may for instance include just a part of the cradle 3223, such as the upper part that connects to the top of the mobile computing device.

The mobile computing device 3221 may be a personal digital assistant (PDA) or a mobile phone. However, it may also be a mobile camera or a mobile sound or video player or any portable computing device that is enabled to control a dialer.

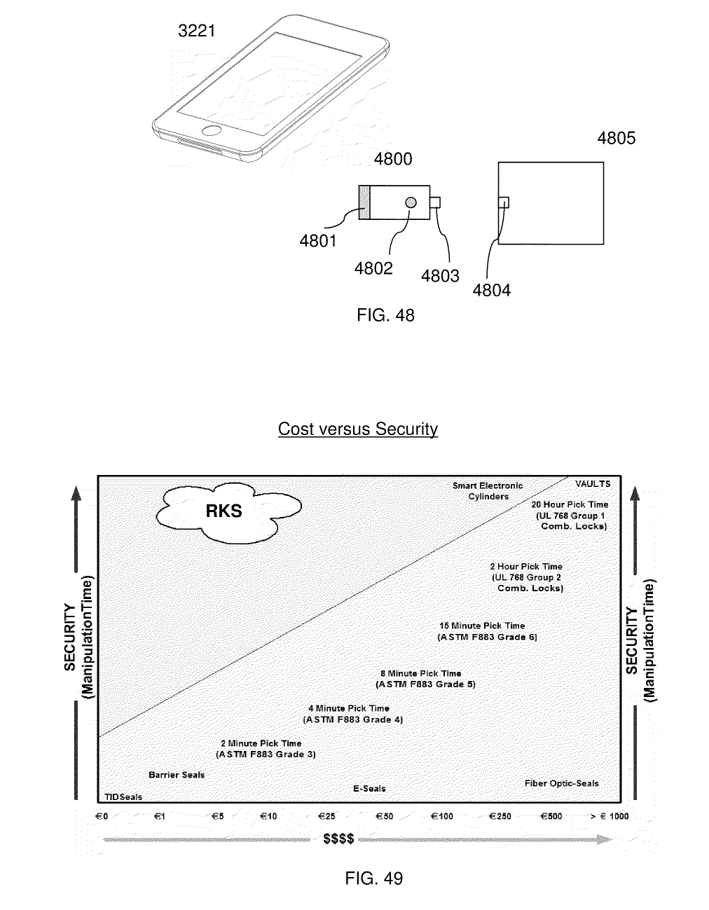

In a further embodiment, as illustrated in FIG. 48 a mobile device 3221 may collaborate or control one or more aspects of a dialer 4800, without integrating the actual dialer mechanism into the mobile device. A dialer 4800 may communicate wirelessly with a mobile device, for instance by using known and available Bluetooth circuits and protocols. Other wireless connections such as wireless USB are also contemplated. Both the mobile device 3221 and dialer 4800 in such an embodiment have the related circuitry that enables wireless communication. The dialer has a mechanical driving interface 4803 that can mate with a mechanical interface 4804 for driving a rotating combination lock mechanism as for instance disclosed herein in a lock 4805. Mechanical interfaces 4803 and 4804 may be constructed in such a way that they are not finger manipulable. They may also contain registration, coupling and security elements.

The dialer 4800 may be a dialer that can operate autonomously, for instance by activating a switch 4802. In such a case a pre-programmed rotation sequence of clockwise and counterclockwise rotations may be initiated to open lock 4805. In a further embodiment, a user may manually instruct the dialer to dial, by activating a command in the device 3221, to open a lock. In that case a command provided by a user may activate the device 3221 to generate through a wireless interface one or more signals for the dialer 4800 to be received and processed in a wireless receiver 4801. These processed signals may then be further processed by the dialer in accordance with one or more aspects of the present invention and as disclosed herein to open the lock 4805.

In a further embodiment of the present invention, the device 3221 may generate a signal to open a lock based on a location. For instance, the device 3221 may have Global Position System (GPS) capabilities. A certain geographical position may be associated with an opening code or opening sequence of a combination lock. Activating the GPS capability on the device 3221 may result in generating a wireless signal for dialer 4800 to generate a dialing sequence to open lock 4805. Such a signal may contain the dialing sequence itself. It may also contain a code that will select a certain dialing sequence inside the dialer 4805.

In a further embodiment one may generate revenue by downloading combination codes. For example a customs agent who needs to open a RKS lock on the back of an intermodal container, once authorized could down load a combination for a specific lock. A fee may be charged to US customs. An inspection fee may also be charged to an owner of the container. In a further embodiment a user may download a combination, for a fee, for public storage lockers, public bike locks, rental equipment, storage space etc.

FIG. 49 is a graph illustrating the commercial benefit of the RKS cylinder. The x axis has a logarithmic scale and represents a cost scale ranging from about $1 to $1000 or an approximate equivalent in Euros. The y axis represents security, security in this graph is defined by time required for non-destructive entry (NDE) also known as pick resistance. In the lower left portion of the graph are in-expensive tamper indicative seals and locks. The American Society for Testing and Materials (ASTM) in standard ASTM F-883 defines a grade 3 lock as a lock that is able to withstand 2 minutes of expert manipulation, ASTM grade 3 locks can be purchased for about $10. Grade 6 is the highest grade defined by the ASTM and ASTM grade 6 locks are required to withstand 15 minutes of expert manipulation. ASTM grade 6 locks represent the best commercially available lock and may cost $100 or more. The best available combination locks are in the upper right portion of the graph. These bank vault quality locks are defined by Underwriters Laboratory as UL 768 Group 1 Combination Locks and must withstand 20 hours of expert manipulation. Group 1 locks cost on the order of $1000 and are generally used to secure valuable items or classified material. The RKS cylinder is different than the prior art in that it stands alone in the upper left portion of the graph. The RKS cylinder may provide a very high level of security, >20 hours of expert manipulation, but be inexpensive to manufacture. The low cost is enabled by simplicity of design, relative low part count and simplicity of parts.

In a further embodiment of the present invention a combination lock is provided, the lock having a driveshaft driving at least one wheel having a gate, the wheel having a diameter of about 0.5 inch, wherein a drive shaft has to be positioned within an angular tolerance of between about 0.1 and 0.5 degree in an angular position. In a further embodiment the wheel has a diameter smaller than about 0.5 inch. In yet a further embodiment, the tolerance of an angular position of a drive shaft is smaller than about 4 degrees. In yet a further embodiment, the tolerance of an angular position of a drive shaft is smaller than about 4 degrees but greater than about 2 degrees. In yet a further embodiment, the tolerance of an angular position of a drive shaft is smaller than about 2 degrees but greater than about 1 degree. In yet a further embodiment, the tolerance of an angular position of a drive shaft is smaller than about 1 degree but greater than about 0.5 degree. In yet a further embodiment, the tolerance of an angular position of a drive shaft is smaller than about 0.5 degree but greater than about 0.1 degree. In yet a further embodiment, the tolerance of an angular position of a drive shaft is smaller than about 0.1 degree. One may achieve these angular tolerances by the dimensions of a gate in a wheel on the rim of the wheel. Even with very small tolerances of 0.5 degree a wheel of diameter of 2 cm will require a gate tolerance of about 0.1 mm, which may easily be achieved with known machining methods, including laser machining. In yet a further embodiment a dialer is provided with a driving rotating interface to open the lock. The dialer is provided with a stepping motor such as ARSAPE part number 2224-V12-75-11 by applying a gear reduction 100:1 that allows a repeatable angular positioning with a tolerance that is smaller than about 0.5 degrees. Furthermore, the stepping motor can step through a 360 degrees rotation within about or less than 0.5 seconds. The lock may be a cylinder lock that has a size that fits in a typical door lock. The dialer may have a size that fits inside a box that has a length smaller than about 1 inch and a cross section that has a smaller cross section are than 0.025 square inches. In a further embodiment a dialer may fit in a cylinder with a length of about 2 inches. In yet a further embodiment a dialer may fit in a cylinder with a length of about 1 inch. In yet a further embodiment a dialer may fit in a cylinder with a cross section with a diameter of about 0.5 inch or less. In yet a further embodiment the envelope of the lock cylinder complies with the envelope of a generic lock. Such a generic lock cylinder may be a Euro Profile Cylinder. Such a generic lock cylinder may also be a Best® interchangeable core cylinder. Such a generic lock cylinder may also be a Medeco Biaxial® core cylinder.

In a further embodiment a combination lock has at least one wheel with a gate to receive a sidebar for enabling the combination lock to be opened. The wheel may have a diameter of about 0.5 inch. The wheel may also have a larger or a smaller diameter. In a further embodiment the gate of the wheel and the sidebar have dimension tolerances such that the wheel gate has to be positioned within at least 1 degree angular accuracy to receive the sidebar. In a further embodiment the gate of the wheel and the sidebar have dimension tolerances such that the wheel gate has to be positioned within at least 0.5 degree angular accuracy to receive the sidebar. In yet a further embodiment, the gate of the wheel and the sidebar have dimension tolerances such that the wheel gate has to be positioned within at least 0.1 degree angular accuracy to receive the sidebar. These requirements of positioning a wheel gate make it is unlikely if not impossible for a human being to manually manipulate directly a drive shaft of a wheel with sufficient accuracy. Considering the number of rotations and the possible settings that have to be tried for a brute force attack, it is virtually impossible for a human to open a lock as disclosed herein by a manual brute force sequential dialing attack of trying all possible combinations.

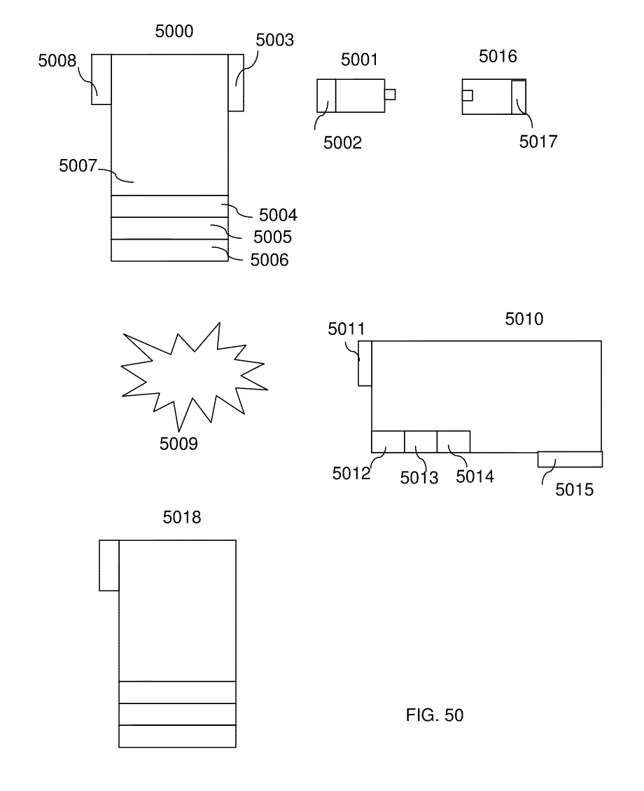

In a further embodiment the dialer or the lock or both the dialer and the lock may be part of a security system. An illustrative example is provided in diagram in FIG. 50. Such a system may contain a dialer 5001 and/or a lock 5016. A dialer 5001 and a lock may have a processor or controller and a memory to control the opening of a lock. A dialer 5001 may further have a communication device 5003, which may be a wireless communication device to communicate for instance electronically with the outside world. The combination lock 5016 may have a communication device 5017 to also communicate with the outside world. Such a communication device may be a mote. The combination lock 5016 may also not have a communication device 5017. A communication device 5017 may be applied to communicate information related to the status of the dialer 5001. For instance, the lock 5016 may request or receive through device 5017 authorization to be opened. In one embodiment one may include at least one means in a combination lock to frustrate or disable an opening combination of the lock. Such a means may contain an engagement clutch that engages the driving shaft of the wheels of the lock to a driving interface that connects with the dialer. If the lock is not provided with the appropriate authorization, the clutch may not be engaged.

A miniature solenoid with the lock cylinder may also be used to block or to prevent rotation of the drive wheel of the combination lock. U.S. Pat. No. 6,474,122 “Electronic Lock Systems” issued Nov. 5, 2002, which is incorporated herein by reference, describes the use of such a solenoid. The lock system in U.S. Pat. No. 6,474,122 comprises an electronic key that contains a micro-processor, power supply and electrical contacts to physically make an electrical connection with the electronic lock cylinder. The cylinder has a processor, solenoid and electrical contacts and derives its power from the key. When the electronic and key and cylinder are engaged, electronic data is exchanged and if the key and cylinder pass one or more authorization steps the solenoid in the cylinder moves a part driven by the solenoid to an un-locked position. Such a mechanism or the earlier provided micro-clutch mechanism may be applied to allow a driving wheel in a combination lock to drive a driving shaft of a combination lock. It should be appreciated that the combination lock with the engagement authorization provides an additional layer of security over a purely electronic key/lock system and over an electronic key with a standard cylinder key.

The devices 5002 and/or 5017 may be wireless devices, for instance they may be Bluetooth devices or they may apply any other wireless technology, including but not limited to USB Wireless. Preferably, a security system as provided herein as an aspect of the present invention, has a computing device 5000, which is preferably a mobile computing device that is enabled to communicate wirelessly to the outside world.

The computing device has at least a processor 5004, a memory 5005 enabled to store and retrieve data, including instructions that can be executed or processed by the processor 5004. The device 5000 also has an input device 5006 for providing data or commands to the processor. Such an input device may be a keyboard or a pointing device, including a touch display. The input device may also be a camera, for instance for a biometric input from a user. The computing device also has preferably an output device 5007 for display of video and/or audio data. Furthermore, the device 5000 has means 5008 to communicate electronically with a network 5009. For instance, the device 5000 may be a cell phone which communicates with a cell phone network. The network 5009 may include the Internet.

In a further embodiment the devices 5002, 5017 and 5008 all are enabled to communicate with a network 5009. In yet a further embodiment, the devices 5001, 5016 and 5000 are connected through a dedicated network such as a known Bluetooth connection. In that case the computing device 5000 may have a dedicated communication device 5003 to communicate with 5002 and/or 5017.

Also part of a security system may be a server 5010 which is connected to the network 5009 through a device 5011. The connection of the server 5010 with the network 5009 may be a wired connection; it may also be a wireless connection. The server 5010 has at least a processor 5012 to execute instruction and process data, a memory 5013 for storing and retrieving data, which may include instructions to be executed by the processor and data to be processed by the processor, and a database 5014 which may be stored on a storage medium and can be accessed by the processor. Part of the server may be peripheral equipment 5014 for instance for entering data and or displaying data, which may include a keyboard, a pointing device and/or a video display.

In a further embodiment, the system of FIG. 50 may contain at least a second mobile computing device 5018 which may be similar or almost similar to device 5000 and is able to communicate with 5000 over network 5009.

The following provides several methods in accordance with one or more aspects of the present invention for applying the system as provided above in opening a combination lock.

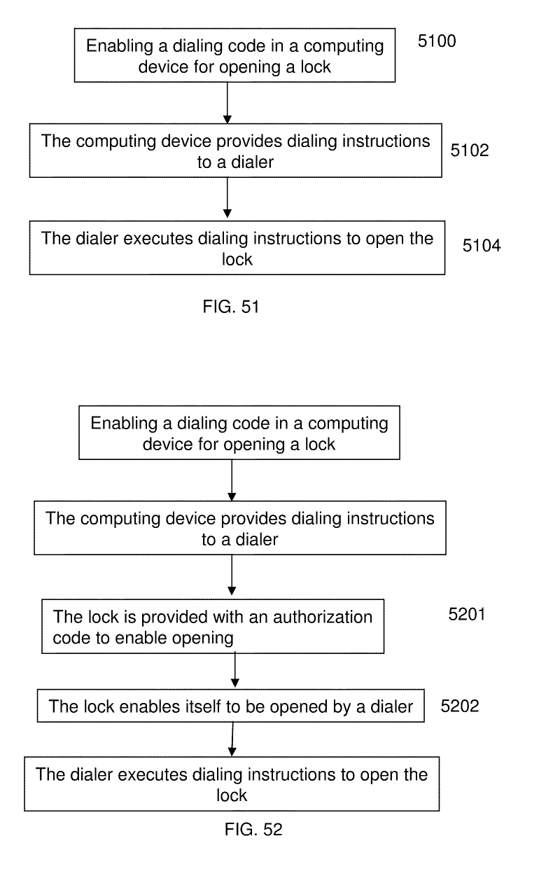

In one embodiment a user provides a command or an instruction on a device 5000 to open the lock. This may include entering a command and/or a code consisting of one or more symbols and instructing the device 5000 to execute the command, as step 5100 in FIG. 51. The device 5000 may then communicate with the dialer 5001 to execute a certain dialing sequence as step 5102 as shown in FIG. 52. The dialer may then execute the dialing sequence and opens the lock, as shown as step 5104 in FIG. 52. One may provide the instruction for opening once the dialer 5001 is mated with lock 5016. One may also temporarily store the instruction for dialing in the dialer, to be executed once the dialer has been mated with the lock. One may provide a timer that automatically drops or negates the dialing instruction in the dialer after a certain time.

In a further embodiment the lock may require an authorization code before it enables itself, for instance by enabling a driving clutch, for receiving the dialing sequence from a dialer. Such an authorization code may be provided either by the computing device 5000 or by the dialer 5001. In step 5201 of FIG. 52 the lock receives an authorization code, and in step 5202 the lock enables itself to be opened, for instance by engaging a clutch.

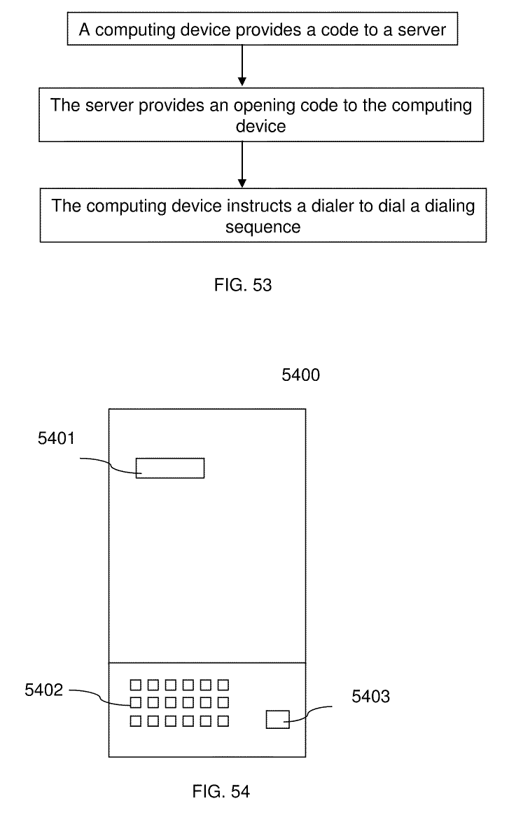

In a further embodiment a computing device may initially not have a code that will enable a dialer to dial a dialing sequence to open a lock. A user may provide the code assigned to the lock, read a code from a lock or receive from a lock a code that identifies the lock. The computing device may also generate data related to the geographical location of the lock, for instance GPS data, or a code related to GPS data. Such a code may be sent to the server 5010, for instance together with data identifying the computing device. The server 5010 may look in a database to authorize the computing device 5000 or its user for opening the lock. The received code may be used to identify the opening code in the database 5014 that will enable the dialer to generate a sequence that will open the lock. The opening code may be transferred to the computing device 5000, which transfers it to the dialer. The process is illustrated in FIG. 53.

In a further embodiment the lock may be for instance on a vending machine or a locker, and the user will be charged for opening the lock. In that case the computing device 5000 may send a request for opening the device such as vending machine by submitting a code to a server. The request may include a permission to charge an account for opening the lock. In that case the server 5010 may consult its database 5014 for authorization of the user. It may also send a message to for instance a bank to check if the account can be charged and receives authorization of the bank. The server may then send an opening code to the computing device 5000, which may be used by the dialer to open the lock. In this scenario, wherein different users may open the lock and where an opening sequence was applied the use of the opening authorization by the lock is very useful. While it is unlikely that one will be able to catch or “steal” the opening dial sequence, the need for an authorization to enable the lock to be opened further protects the integrity of the lock.

In a further embodiment, a first user may provide a second user a code to open a lock for a single or limited times. For instance, the device 5018 may provide the device 5000 a code that enables the dialer 5001 to open lock 5016.

In all the embodiments an opening code may be a single code related to a single dialing sequence. In a preferred embodiment a single dialing sequence may be coded as a plurality of codes, which may be used only once. After being used once, the dialer may completely ignore a repeat use of the code, and will not dial again the opening sequence as a result of the specific code. One may program device 5000 and a dialer controller in such a way that opening codes are dialed only once and will not be repeated.

The same approach of uniqueness of codes may also apply to the authorization codes between the dialer and the lock.

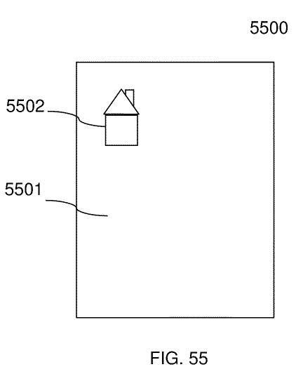

FIG. 54 shows in diagram an illustrative example 5400 of the computing device 5000. The device 5400 has a keyboard 5402 via which an opening code is entered which shows on a display as 5401. By enabling a key 5403 an opening code may be transferred to the dialer to initiate the opening sequence of the lock. In a further embodiment, the computing device may have a touch screen 5501 as shown in FIG. 55. A picture 5502 of a house may indicate an opening code for a house door lock. Tapping the image may initiate the transfer of an opening code to the dialer to open the lock.

In a further embodiment a combination lock may provide an opening code to a dialer or to a mobile computing device. For instance a door or a gate must remain closed and locked for safety reasons. It may be assumed that only authorized users have access to the locks. In that case it may be much easier to have a lock communicate its opening code to a dialer or a computing device.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1-3. (canceled)

4. A combination lock, comprising:
a wheel pack having a plurality of wheels, each of the plurality of wheels having a first side;
each wheel having a gate along a circumference of the wheel and at least one of the plurality of wheels having a plurality of cams on the first side of the wheel;
a bar having a first position that allows each of the plurality of wheels in the wheel pack to be rotated and a second position wherein the bar is received by the gate in each of the plurality of wheels when each of the plurality of wheels is in a predetermined position.

5. The combination lock as claimed in claim 4, wherein a second of the plurality of wheels in the wheel pack has a plurality of cams on the first side of the wheel.

6. The combination lock as claimed in claim 4, wherein all of the plurality of wheels in the wheel pack have a plurality of cams on the first side of the wheel.

7. The combination lock as claimed in claim 4, wherein at least one cam on at least one wheel can be located in a variable position.

8. The combination lock as claimed in claim 4, wherein at least one of the wheels has a plurality of holes in which the cams can be secured.

9. The combination lock as claimed in claim 8, wherein the plurality of holes is irregularly spaced.

10. The combination lock as claimed in claim 4, wherein one of the cams has a first size and another of the cams has a second size that is different from the first size.

11. The combination lock as claimed in claim 4, wherein the cams are created by bending a piece of material at an edge of the wheel in an angle away from a plane of the wheel.

12. The combination lock as claimed in claim 4, wherein at least one cam is positioned in a continuously movable position on at least one of the plurality of wheels.

13. The combination lock as claimed in claim 4, wherein the gate of at least one wheel has to be positioned with an angular accuracy of better than about two degrees in relation to the bar in order to unlock the combination lock.

14. The combination lock as claimed in claim 4, wherein the gate of at least one wheel has to be positioned with an angular accuracy of better than about one degree in relation to the bar in order to unlock the combination lock.

15. The combination lock as claimed in claim 4, wherein the gate of at least one wheel has to be positioned with an angular accuracy of better than about one-tenth of a degree in relation to the bar in order to unlock the combination lock.

16. The combination lock as claimed in claim 4, wherein the combination lock is unlocked when gates of the plurality of wheels in the combination lock are aligned in a straight line.

17. The combination lock as claimed in claim 4, wherein the bar contains non-linear fence segments.

18. The combination lock as claimed in claim 4, further comprising a cylinder that complies with the envelope of a generic key cylinder and that houses the wheel pack.

19. The combination lock as claimed in claim 4, wherein the combination lock has at least six gated wheels.

20. The combination lock as claimed in claim 4, wherein the combination lock has a one time use lock cylinder.

21. The combination lock as claimed in claim 4, further comprising a frangible element that is modified when the combination lock is unlocked.

22. The combination lock as claimed in claim 4, wherein the combination lock has a lock interface to mate in a known position relative to a body of the combination lock with an opening tool enabled to rotate the interface in a full clockwise and a full counterclockwise rotation.

23. The combination lock as claimed in claim 20, wherein the opening tool is a manually operated tool.

24. The combination lock as claimed in claim 20, wherein the opening tool is a electronic dialer.
